(19) United States
(12) Patent Application Publication
(10) Pub. No.: US 2006/0057625 A1
(43) Pub. Date: Mar. 16, 2006

(54) Scaffold-based artificial receptors and methods

(76) Inventor: Robert E. Carlson, Minnetonka, MN (US)

Correspondence Address: MERCHANT & GOULD PC, P.O. BOX 2903, MINNEAPOLIS, MN, 55402-0903, US

(21) Appl. No.: 11/217,384

(22) Filed: Sep. 1, 2005

Related U.S. Application Data
(63) Continuation-in-part of application No. 10/244,727, filed on Sep. 16, 2002.
(63) Continuation-in-part of application No. 10/813,568, filed on Mar. 29, 2004.
Application No. 10/813,568 is a continuation-in-part of application No. PCT/US03/05328, filed on Feb. 19, 2003.
(60) Provisional application No. 60/609,160, filed on Sep. 11, 2004.
(60) Provisional application No. 60/612,666, filed on Sep. 23, 2004.
(60) Provisional application No. 60/626,770, filed on Nov. 10, 2004.
(60) Provisional application No. 60/645,582, filed on Jan. 19, 2005.
(60) Provisional application No. 60/649,729, filed on Feb. 3, 2005.
(60) Provisional application No. 60/607,438, filed on Sep. 3, 2004.
(60) Provisional application No. 60/607,458, filed on Sep. 3, 2004.
(60) Provisional application No. 60/608,557, filed on Sep. 10, 2004.
(60) Provisional application No. 60/607,457, filed on Sep. 3, 2004.
(60) Provisional application No. 60/608,654, filed on Sep. 10, 2004.

(51) Int. Cl. C40B 40/08; C40B 40/10

(52) U.S. Cl. 435/6; 435/7.1

(57) ABSTRACT

The present invention relates to scaffold artificial receptors, methods of and compositions for making them, and methods of using them. Each artificial receptor includes a plurality of building blocks. The plurality of the building blocks are coupled to a scaffold.

### CROSS REFERENCE TO RELATED APPLICATIONS

The present application claims priority as a continuation-in-part to U.S. application Ser. Nos. 10/244,727, filed Sep. 16, 2002, Ser. No. 10/813,568, filed Mar. 29, 2004, and Application No. PCT/US03/05328, filed Feb. 19, 2003, each entitled “ARTIFICIAL RECEPTORS, BUILDING BLOCKS, AND METHODS”; U.S. patent application Ser. Nos. 10/812,850 and 10/813,612, and application No. PCT/US2004/009649, each filed Mar. 29, 2004 and each entitled “ARTIFICIAL RECEPTORS INCLUDING REVERSIBLY IMMOBILIZED BUILDING BLOCKS, THE BUILDING BLOCKS, AND METHODS”; and U.S. patent application Ser. No. 10/934,977, filed Sep. 3, 2004, entitled “METHODS EMPLOYING COMBINATORIAL ARTIFICIAL RECEPTORS”, Ser. No. 10/934,879, filed Sep. 3, 2004, entitled “NANODEVICES EMPLOYING COMBINATORIAL ARTIFICIAL RECEPTORS”, Ser. No. 11/004,593, filed Dec. 2, 2004, entitled “ARTIFICIAL RECEPTORS INCLUDING GRADIENTS”, and Ser. No. 10/934,193, filed Sep. 3, 2004, entitled “SENSORS EMPLOYING COMBINATORIAL ARTIFICIAL RECEPTORS”.

This application also claims priority to U.S. Provisional Patent Application Nos. 60/609,160, filed Sep. 11, 2004, entitled “ARTIFICIAL RECEPTORS, BUILDING BLOCKS, AND METHODS”, 60/612,666, filed Sep. 23, 2004, entitled “ARTIFICIAL RECEPTORS, BUILDING BLOCKS, AND METHODS”, 60/626,770, filed Nov. 10, 2004, entitled “ARTIFICIAL RECEPTORS, BUILDING BLOCKS, AND METHODS”, 60/645,582, filed Jan. 19, 2005, entitled “ARTIFICIAL RECEPTORS, BUILDING BLOCKS, AND METHODS”, 60/649,729, filed Feb. 3, 2005, entitled “ARTIFICIAL RECEPTORS, BUILDING BLOCKS, AND METHODS”, 60/607,438, filed Sep. 3, 2004, entitled “COMBINATORIAL ARTIFICIAL RECEPTORS INCLUDING TETHER BUILDING BLOCKS ON SCAFFOLDS”, 60/607,458, filed Sep. 3, 2004, entitled “COMBINATORIAL ARTIFICIAL RECEPTORS INCLUDING TETHER BUILDING BLOCKS ON SCAFFOLDS”, 60/608,557, filed Sep. 10, 2004, entitled “COMBINATORIAL ARTIFICIAL RECEPTORS INCLUDING TETHER BUILDING BLOCKS ON SCAFFOLDS”, 60/607,457, filed Sep. 3, 2004, entitled “SCAFFOLD-BASED ARTIFICIAL RECEPTORS AND METHODS”, and 60/608,654, filed Sep. 10, 2004, entitled “SCAFFOLD-BASED ARTIFICIAL RECEPTORS AND METHODS”.

Each of the listed applications is incorporated herein by reference.

### FIELD OF THE INVENTION

The present invention relates to scaffold artificial receptors, methods of and compositions for making them, and methods of using them. Each artificial receptor includes a plurality of building blocks. The plurality of the building blocks are coupled to a scaffold.

### BACKGROUND OF THE INVENTION

The preparation of artificial receptors that bind ligands like proteins, peptides, carbohydrates, microbes, pollutants, pharmaceuticals, and the like with high sensitivity and specificity is an active area of research. None of the conventional approaches has been particularly successful; achieving only modest sensitivity and specificity mainly due to low binding affinity.

Antibodies, enzymes, and natural receptors generally have binding constants in the 10⁸-10¹² range, which results in both nanomolar sensitivity and targeted specificity. By contrast, conventional artificial receptors typically have binding constants of about 10³ to 10⁵, with the predictable result of millimolar sensitivity and limited specificity.

Several conventional approaches are being pursued in attempts to achieve highly sensitive and specific artificial receptors. These approaches include, for example, affinity isolation, molecular imprinting, and rational and/or combinatorial design and synthesis of synthetic or semi-synthetic receptors.

Such rational or combinatorial approaches have been limited by the relatively small number of receptors which are evaluated and/or by their reliance on a design strategy which focuses on only one building block, the homogeneous design strategy. Common combinatorial approaches form microarrays that include 10,000 or 100,000 distinct spots on a standard microscope slide. However, such conventional methods for combinatorial synthesis provide a single molecule per spot. Employing a single building block in each spot provides only a single possible receptor per spot. Synthesis of thousands of building blocks would be required to make thousands of possible receptors.

Further, these conventional approaches are hampered by the currently limited understanding of the principles which lead to efficient binding and the large number of possible structures for receptors, which makes such an approach problematic.

There remains a need for methods that can develop scaffold based artificial receptors and for the artificial receptors themselves.

### SUMMARY OF THE INVENTION

The present invention relates to scaffold artificial receptors, methods of and compositions for making them, and methods of using them. Each artificial receptor includes a plurality of building blocks. The plurality of the building blocks are coupled to a scaffold.

The present invention includes a method of making a scaffold artificial receptor including building blocks coupled to scaffolds. This method includes forming a plurality of reaction sites on a scaffold and coupling a building block to each reaction site. The invention includes artificial receptors and compositions. The compositions include a scaffold and a plurality of building blocks.

The present invention includes a method of using a scaffold artificial receptor in an array. This method includes associating a scaffold artificial receptor with each of a plurality of locations and detecting binding of a ligand in one or more locations.

### BRIEF DESCRIPTION OF THE DRAWINGS

FIG. 1 schematically illustrates two and three dimensional representations of an embodiment of a molecular configuration of 4 building blocks, each building block including a recognition element, a framework, and a linker coupled to a support (immobilization/anchor).

FIG. 2 schematically illustrates identification of a lead artificial receptor from among candidate artificial receptors.

FIG. 3 schematically illustrates a false color fluorescence image of a labeled microarray according to an embodiment of the present invention.

FIG. 4 schematically illustrates a two dimensional plot of data obtained for candidate artificial receptors contacted with and/or binding phycoerythrin.

FIG. 5 schematically illustrates a three dimensional plot of data obtained for candidate artificial receptors contacted with and/or binding phycoerythrin.

FIG. 6 schematically illustrates a two dimensional plot of data obtained for candidate artificial receptors contacted with and/or binding a fluorescent derivative of ovalbumin.

FIG. 7 schematically illustrates a three dimensional plot of data obtained for candidate artificial receptors contacted with and/or binding a fluorescent derivative of ovalbumin.

FIG. 8 schematically illustrates a two dimensional plot of data obtained for candidate artificial receptors contacted with and/or binding a fluorescent derivative of bovine serum albumin.

FIG. 9 schematically illustrates a three dimensional plot of data obtained for candidate artificial receptors contacted with and/or binding a fluorescent derivative of bovine serum albumin.

FIG. 10 schematically illustrates a two dimensional plot of data obtained for candidate artificial receptors contacted with and/or binding an acetylated horseradish peroxidase.

FIG. 11 schematically illustrates a three dimensional plot of data obtained for candidate artificial receptors contacted with and/or binding an acetylated horseradish peroxidase.

FIG. 12 schematically illustrates a two dimensional plot of data obtained for candidate artificial receptors contacted with and/or binding a TCDD derivative of horseradish peroxidase.

FIG. 13 schematically illustrates a three dimensional plot of data obtained for candidate artificial receptors contacted with and/or binding a TCDD derivative of horseradish peroxidase.

FIG. 14 schematically illustrates a subset of the data illustrated in FIG. 5.

FIG. 15 schematically illustrates a subset of the data illustrated in FIG. 5.

FIG. 16 schematically illustrates a subset of the data illustrated in FIG. 5.

FIG. 17 schematically illustrates a correlation of binding data for phycoerythrin against logP for the building blocks making up the artificial receptor.

FIG. 18 schematically illustrates a correlation of binding data for phycoerythrin against logP for the building blocks making up the artificial receptor.

FIG. 19 schematically illustrates a two dimensional plot comparing data obtained for candidate artificial receptors contacted with and/or binding phycoerythrin to data obtained for candidate artificial receptors contacted with and/or binding a fluorescent derivative of bovine serum albumin.

FIGS. 20, 21, and 22 schematically illustrate subsets of data from FIGS. 5, 9, and 7, respectively, and demonstrate that the array of artificial receptors according to the present invention yields receptors distinguished between three analytes, phycoerythrin, bovine serum albumin, and ovalbumin.

FIG. 23 schematically illustrates a gray scale image of the fluorescence signal from a scan of a control plate which was prepared by washing off the building blocks with organic solvent before incubation with the test ligand.

FIG. 24 schematically illustrates a gray scale image of the fluorescence signal from a scan of an experimental plate which was incubated with 1.0 μg/ml Cholera Toxin B at 23° C.

FIG. 25 schematically illustrates a gray scale image of the fluorescence signal from a scan of an experimental plate which was incubated with 1.0 μg/ml Cholera Toxin B at 3° C.

FIG. 26 schematically illustrates a gray scale image of the fluorescence signal from a scan of an experimental plate which was incubated with 1.0 μg/ml Cholera Toxin B at 43° C.

FIGS. 27-29 schematically illustrate plots of the fluorescence signals obtained from the candidate artificial receptors illustrated in FIGS. 24-26.

FIG. 30 schematically illustrate plots of the fluorescence signals obtained from the combinations of building blocks employed in the present studies, when those building blocks are covalently linked to the support. Binding was conducted at 23° C.

FIG. 31 schematically illustrates the changes in fluorescence signal from individual combinations of covalently immobilized building blocks at 4° C., 23° C., or 44° C.

FIG. 32 schematically illustrates a graph of the changes in fluorescence signal from individual combinations of building blocks at 4° C., 23° C., or 44° C.

FIG. 33 schematically illustrates the data presented in FIG. 31 (lines marked A) and the data presented in FIG. 32 (lines marked B).

FIG. 34 schematically illustrates a graph of the fluorescence signal at 44° C. divided by the signal at 23° C. against the fluorescence signal obtained from binding at 23° C. for the artificial receptors with reversibly immobilized receptors.

FIG. 35 illustrates fluorescence signals produced by binding of cholera toxin to a microarray of the present candidate artificial receptors followed by washing with buffer in an experiment reported in Example 4.

FIG. 36 illustrates the fluorescence signals due to cholera toxin binding that were detected upon competition with GM1 OS (0.34 μM) in an experiment reported in Example 4.

FIG. 37 illustrates the ratio of the amount bound in the absence of GM1 OS to the amount bound in competition with GM1 OS(0.34 μM) in an experiment reported in Example 4.

FIG. 38 illustrates fluorescence signals produced by binding of cholera toxin to a microarray of the present candidate artificial receptors followed by washing with buffer in an experiment reported in Example 4 and for comparison with competition experiments using 5.1 μM GM1 OS.

FIG. 39 illustrates the fluorescence signals due to cholera toxin binding that were detected upon competition with GM 1 OS (5.1 μM) in an experiment reported in Example 4.

FIG. 40 illustrates the ratio of the amount bound in the absence of GM1 OS to the amount bound in competition with GM1 OS(5.1 μM) in an experiment reported in Example 4.

FIG. 41 illustrates the fluorescence signals produced by binding of cholera toxin to the microarray of candidate artificial receptors alone and in competition with each of the three concentrations of GM1 in the experiment reported in Example 5.

FIG. 42 illustrates the ratio of the amount bound in the absence of GM1 OS to the amount bound upon competition with GM1 for the low concentration of GM1 employed in Example 5.

FIG. 43 illustrates the fluorescence signals produced by binding of cholera toxin to the microarray of candidate artificial receptors without pretreatment with GM1 in the experiment reported in Example 6.

FIGS. 44-46 illustrate the fluorescence signals produced by binding of cholera toxin to the microarray of candidate artificial receptors with pretreatment with GM1 (100 μg/ml, 10 μg/ml, and 1 μg/ml GM1, respectively) in the experiment reported in Example 6.

FIG. 47 illustrates the ratio of the amount bound in the presence of 1 μg/ml GM1 to the amount bound in the absence of GM1 in the experiment reported in Example 6.

### DETAILED DESCRIPTION

Definitions

As used herein, the term “peptide” refers to a compound including two or more amino acid residues joined by amide bond(s).

As used herein, the terms “polypeptide” and “protein” refer to a peptide including more than about 20 amino acid residues connected by peptide linkages.

As used herein, the term “proteome” refers to the expression profile of the proteins of an organism, tissue, organ, or cell. The proteome can be specific to a particular status (e.g., development, health, etc.) of the organism, tissue, organ, or cell.

As used herein, the term “support” refers to a solid support that is, typically, macroscopic.

As used herein, the term “scaffold” refers to a microscale, or nanoscale, or molecular scale structure, having a plurality of reactive sites for coupling a plurality of building blocks.

As used herein, the term “soluble” refers to the ability to dissolve in solution. A soluble scaffold or soluble scaffold artificial receptor blends uniformly in liquid. The soluble scaffold or soluble scaffold artificial receptor may be either liquid or solid.

Reversibly immobilizing building blocks on a support couples the building blocks to the support through a mechanism that allows the building blocks to be uncoupled from the support without destroying or unacceptably degrading the building block or the support. That is, immobilization can be reversed without destroying or unacceptably degrading the building block or the support. In an embodiment, immobilization can be reversed with only negligible or ineffective levels of degradation of the building block or the support. Reversible immobilization can employ readily reversible covalent bonding or noncovalent interactions. Suitable noncovalent interactions include interactions between ions, hydrogen bonding, van der Waals interactions, and the like. Readily reversible covalent bonding refers to covalent bonds that can be formed and broken under conditions that do not destroy or unacceptably degrade the building block or the support.

A combination of building blocks immobilized on, for example, a support can be a candidate artificial receptor, a lead artificial receptor, or a working artificial receptor. A candidate artificial receptor can become a lead artificial receptor, which can become a working artificial receptor.

As used herein the phrase “candidate artificial receptor” refers to an immobilized combination of building blocks that can be tested to determine whether or not a particular test ligand binds to that combination. In an embodiment, the combination includes one or more reversibly immobilized building blocks. In an embodiment, the candidate artificial receptor can be a heterogeneous building block spot on a slide or a plurality of building blocks coated on a tube or well.

As used herein the phrase “lead artificial receptor” refers to an immobilized combination of building blocks that binds a test ligand at a predetermined concentration of test ligand, for example at 10, 1, 0.1, or 0.01 μg/ml, or at 1, 0.1, or 0.01 ng/ml. In an embodiment, the combination includes one or more reversibly immobilized building blocks. In an embodiment, the lead artificial receptor can be a heterogeneous building block spot on a slide or a plurality of building blocks coated on a tube or well.

As used herein the phrase “working artificial receptor” refers to a combination of building blocks that binds a test ligand with a selectivity and/or sensitivity effective for categorizing or identifying the test ligand. That is, binding to that combination of building blocks describes the test ligand as belonging to a category of test ligands or as being a particular test ligand. A working artificial receptor can, for example, bind the ligand at a concentration of, for example, 100, 10, 1, 0.1, 0.01, or 0.001 ng/ml. In an embodiment, the combination includes one or more reversibly immobilized building blocks. In an embodiment, the working artificial receptor can be a heterogeneous building block spot on a slide or a plurality of building blocks coated on a tube, well, slide, or other support or on a scaffold.

As used herein the phrase “working artificial receptor complex” refers to a plurality of artificial receptors, each a combination of building blocks, that binds a test ligand with a pattern of selectivity and/or sensitivity effective for categorizing or identifying the test ligand. That is, binding to the several receptors of the complex describes the test ligand as belonging to a category of test ligands or as being a particular test ligand. The individual receptors in the complex can each bind the ligand at different concentrations or with different affinities. For example, the individual receptors in the complex each bind the ligand at concentrations of 100, 10, 1, 0.1, 0.01 or 0.001 ng/ml. In an embodiment, the combination includes one or more reversibly immobilized building blocks.

As used herein, the phrase “significant number of candidate artificial receptors” refers to sufficient candidate artificial receptors to provide an opportunity to find a working artificial receptor, working artificial receptor complex, or lead artificial receptor. As few as about 100 to about 200 candidate artificial receptors can be a significant number for finding working artificial receptor complexes suitable for distinguishing two proteins (e.g., cholera toxin and phycoerythrin). In other embodiments, a significant number of candidate artificial receptors can include about 1,000 candidate artificial receptors, about 10,000 candidate artificial receptors, about 100,000 candidate artificial receptors, or more.

Although not limiting to the present invention, it is believed that the significant number of candidate artificial receptors required to provide an opportunity to find a working artificial receptor may be larger than the significant number required to find a working artificial receptor complex. Although not limiting to the present invention, it is believed that the significant number of candidate artificial receptors required to provide an opportunity to find a lead artificial receptor may be larger than the significant number required to find a working artificial receptor. Although not limiting to the present invention, it is believed that the significant number of candidate artificial receptors required to provide an opportunity to find a working artificial receptor for a test ligand with few features may be more than for a test ligand with many features.

As used herein, the term “building block” refers to a molecular component of an artificial receptor including portions that can be envisioned as or that include one or more linkers, one or more frameworks, and one or more recognition elements. In an embodiment, the building block includes a linker, a framework, and one or more recognition elements. In an embodiment, the linker includes a moiety suitable for reversibly immobilizing the building block, for example, on a support, surface or lawn. The building block interacts with the ligand.

As used herein, the term “linker” refers to a portion of or functional group on a building block that can be employed to or that does (e.g., reversibly) couple the building block to a support, for example, through covalent link, ionic interaction, electrostatic interaction, or hydrophobic interaction.

As used herein, the term “framework” refers to a portion of a building block including the linker or to which the linker is coupled and to which one or more recognition elements are coupled.

As used herein, the term “recognition element” refers to a portion of a building block coupled to the framework but not covalently coupled to the support. Although not limiting to the present invention, the recognition element can provide or form one or more groups, surfaces, or spaces for interacting with the ligand.

As used herein, the phrase “plurality of building blocks” refers to two or more building blocks of different structure in a mixture, in a kit, or on a support or scaffold. Each building block has a particular structure, and use of building blocks in the plural, or of a plurality of building blocks, refers to more than one of these particular structures. Building blocks or plurality of building blocks does not refer to a plurality of molecules each having the same structure.

As used herein, the phrase “combination of building blocks” refers to a plurality of building blocks that together are in a spot, region, or a candidate, lead, or working artificial receptor. A combination of building blocks can be a subset of a set of building blocks. For example, a combination of building blocks can be one of the possible combinations of 2, 3, 4, 5, or 6 building blocks from a set of N (e.g., N=10-200) building blocks.

As used herein, the phrases “homogenous immobilized building block” and “homogenous immobilized building blocks” refer to a support having immobilized on or within it a single building block.

As used herein, the phrase “activated building block” refers to a building block activated to make it ready to form a covalent bond to a functional group, for example, on a support. A building block including a carboxyl group can be converted to a building block including an activated ester group, which is an activated building block. An activated building block including an activated ester group can react, for example, with an amine to form a covalent bond.

As used herein, the term “naïve” used with respect to one or more building blocks refers to a building block that has not previously been determined or known to bind to a test ligand of interest. For example, the recognition element(s) on a naïve building block has not previously been determined or known to bind to a test ligand of interest. A building block that is or includes a known ligand (e.g., GM1) for a particular protein (test ligand) of interest (e.g., cholera toxin) is not naïve with respect to that protein (test ligand).

As used herein, the term “immobilized” used with respect to building blocks coupled to a support refers to building blocks being stably oriented on the support so that they do not migrate on the support or release from the support. Building blocks can be immobilized by covalent coupling, by ionic interactions, by electrostatic interactions, such as ion pairing, or by hydrophobic interactions, such as van der Waals interactions.

As used herein a “region” of a support, tube, well, or surface refers to a contiguous portion of the support, tube, well, or surface. Building blocks coupled to a region can refer to building blocks in proximity to one another in that region.

As used herein, a “bulky” group on a molecule is larger than a moiety including 7 or 8 carbon atoms.

As used herein, a “small” group on a molecule is hydrogen, methyl, or another group smaller than a moiety including 4 carbon atoms.

As used herein, the term “lawn” refers to a layer, spot, or region of functional groups on a support, for example, at a density sufficient to place coupled building blocks in proximity to one another. The functional groups can include groups capable of forming covalent, ionic, electrostatic, or hydrophobic interactions with building blocks.

As used herein, the term “alkyl” refers to saturated aliphatic groups, including straight-chain alkyl groups, branched-chain alkyl groups, cycloalkyl (alicyclic) groups, alkyl substituted cycloalkyl groups, and cycloalkyl substituted alkyl groups. In certain embodiments, a straight chain or branched chain alkyl has 30 or fewer carbon atoms in its backbone (e.g., C₁-C₁₂ for straight chain, C₁-C₆ for branched chain). Likewise, cycloalkyls can have from 3-10 carbon atoms in their ring structure, for example, 5, 6 or 7 carbons in the ring structure.

The term “alkyl” as used herein refers to both “unsubstituted alkyls” and “substituted alkyls”, the latter of which refers to alkyl moieties having substituents replacing a hydrogen on one or more carbons of the hydrocarbon backbone. Such substituents can include, for example, a halogen, a hydroxyl, a carbonyl (such as a carboxyl, an ester, a formyl, or a ketone), a thiocarbonyl (such as a thioester, a thioacetate, or a thioformate), an alkoxyl, a phosphoryl, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aryl alkyl, or an aromatic or heteroaromatic moiety. The moieties substituted on the hydrocarbon chain can themselves be substituted, if appropriate. For example, the substituents of a substituted alkyl can include substituted and unsubstituted forms of the groups listed above.

The phrase “aryl alkyl”, as used herein, refers to an alkyl group substituted with an aryl group (e.g., an aromatic or heteroaromatic group).

As used herein, the terms “alkenyl” and “alkynyl” refer to unsaturated aliphatic groups analogous in length and optional substitution to the alkyls groups described above, but that contain at least one double or triple bond respectively.

The term “aryl” as used herein includes 5-, 6- and 7-membered single-ring aromatic groups that may include from zero to four heteroatoms, for example, benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics”. The aromatic ring can be substituted at one or more ring positions with such substituents such as those described above for alkyl groups. The term “aryl” also includes polycyclic ring systems having two or more cyclic rings in which two or more carbons are common to two adjoining rings (the rings are “fused rings”) wherein at least one of the rings is aromatic, e.g., the other cyclic ring(s) can be cycloalkyls, cycloalkenyls, cycloalkynyls, aryls and/or heterocyclyls.

As used herein, the terms “heterocycle” or “heterocyclic group” refer to 3- to 12-membered ring structures, e.g., 3- to 7-membered rings, whose ring structures include one to four heteroatoms. Heterocyclyl groups include, for example, thiophene, thianthrene, furan, pyran, isobenzofuran, chromene, xanthene, phenoxathiin, pyrrole, imidazole, pyrazole, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, phenanthridine, acridine, pyrimidine, phenanthroline, phenazine, phenarsazine, phenothiazine, furazan, phenoxazine, pyrrolidine, oxolane, thiolane, oxazole, piperidine, piperazine, morpholine, lactones, lactams such as azetidinones and pyrrolidinones, sultams, sultones, and the like. The heterocyclic ring can be substituted at one or more positions with such substituents such as those described for alkyl groups.

As used herein, the term “heteroatom” as used herein means an atom of any element other than carbon or hydrogen, such as nitrogen, oxygen, sulfur and phosphorous.

Overview of Artificial Receptors

The present invention relates to artificial receptors including building blocks coupled to a scaffold, such as a soluble organic molecule. The present receptors include heterogeneous combinations of building block molecules. In certain embodiments, the present artificial receptors include combinations of 2, 3, 4, or 5 distinct building block molecules immobilized in proximity to one another on a scaffold. The present artificial receptors can be employed to detect the receptor's ligand.

An artificial receptor can include a combination of building blocks immobilized on a scaffold. An individual artificial receptor can be a heterogeneous plurality of building blocks on a scaffold. The building blocks can be immobilized through any of a variety of interactions, such as covalent, electrostatic, or hydrophobic interactions. For example, the building block and scaffold can each include one or more functional groups or moieties that can form covalent, electrostatic, hydrogen bonding, van der Waals, or like interactions.

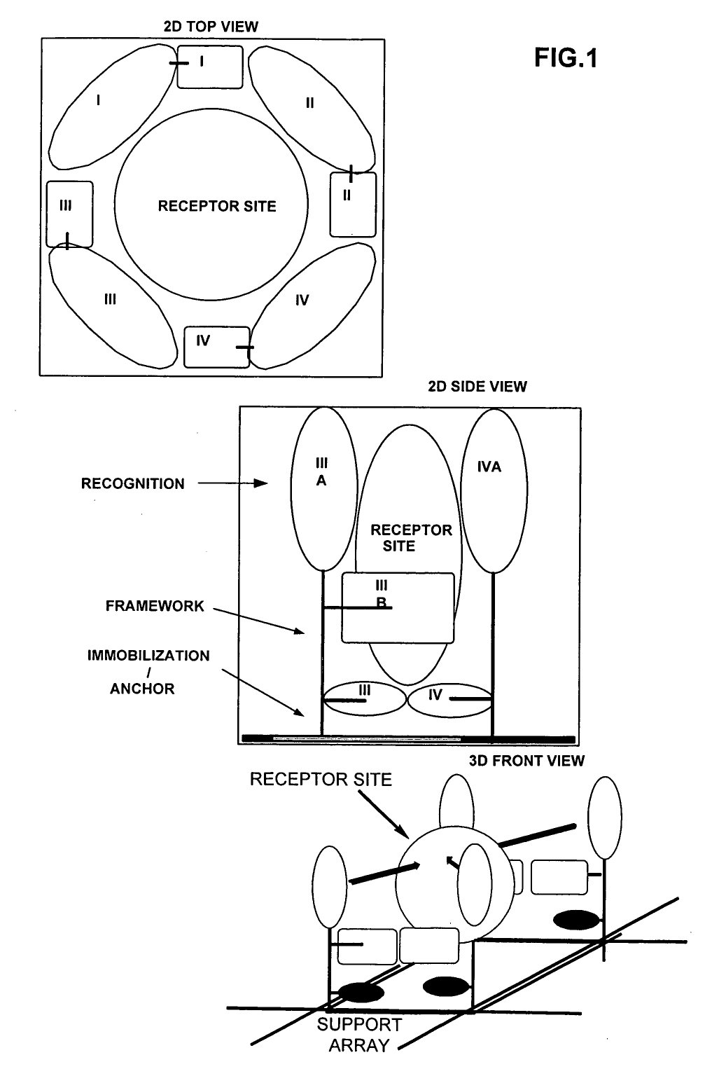

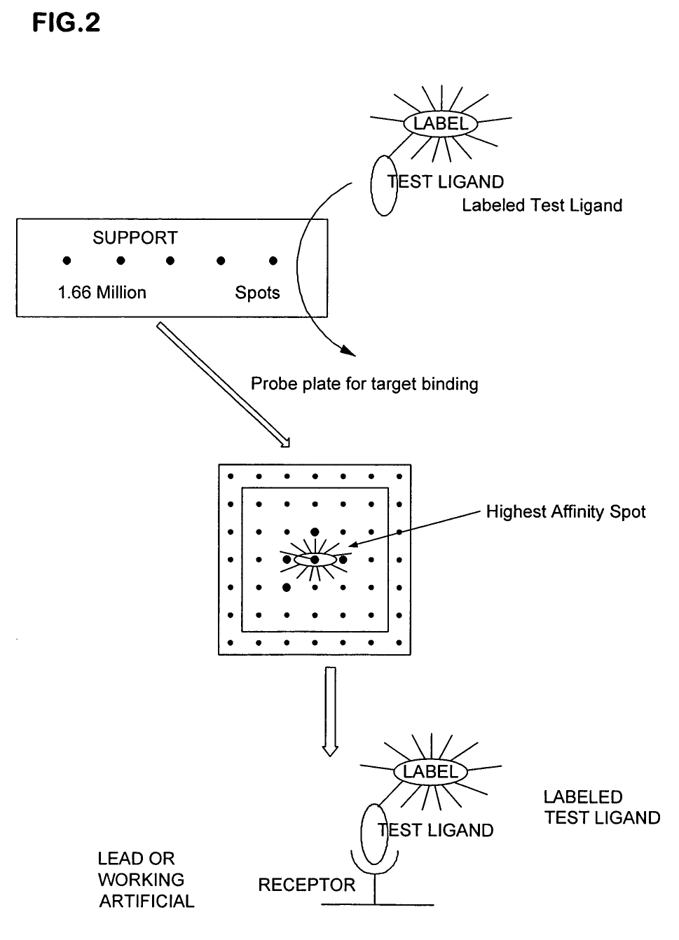

In an embodiment, the artificial receptor of the invention includes a plurality of building blocks coupled to a scaffold. Each immobilized building block molecule can provide one or more “arms” extending from a “framework” and each can include groups that interact with a ligand or with portions of another immobilized building block. FIG. 1 illustrates that combinations of four building blocks, each including a framework with two arms (called “recognition elements”), provides a molecular configuration of building blocks that form a site for binding a ligand. Such a site formed by building blocks such as those exemplified below can bind a small molecule, such as a drug, metabolite, pollutant, or the like, and/or can bind a larger ligand such as a macromolecule or microbe.

In an embodiment, the plurality of building blocks can include or be building blocks of Formula 2 (shown below). An abbreviation for the building block including a linker, a tyrosine framework, and recognition elements AxBy is TyrAxBy. In an embodiment, a candidate artificial receptor can include combinations of building blocks of formula TyrA1B1, TyrA2B2, TyrA2B4, TyrA2B6, TyrA2B8, TyrA3B3, TyrA4B2, TyrA4B4, TyrA4B6, TyrA4B8, TyrA5B5, TyrA6B2, TyrA6B4, TyrA6B6, TyrA6B8, TyrA7B7, TyrA8B2, TyrA8B4, TyrA8B6, or TyrA8B8.

The present artificial receptors utilize scaffolds as support for building blocks. In an embodiment, the artificial receptors are free molecules not coupled with a macroscopic solid support, referred to as scaffold artificial receptors. In an embodiment, the present artificial receptors can include building blocks reversibly immobilized on a scaffold. Reversing immobilization of the building blocks can allow movement of building blocks to a different location on the scaffold, or exchange of building blocks onto and off of the scaffold. For example, the combinations of building blocks can bind a ligand when reversibly coupled to or immobilized on the scaffold. Reversing the coupling or immobilization of the building blocks provides opportunity for rearranging the building blocks, which can improve binding of the ligand. Further, the present invention can allow for adding additional or different building blocks, which can further improve binding of a ligand. In an embodiment, one or more building blocks can include a tether. A tether can provide mobility of the building block without reversible binding.

The combinations of building blocks with a scaffold is represented by the formula: S-BBₙ, wherein S is a scaffold and BBₙ is a number (n) of building blocks. In an embodiment, n can be, for example, 2, 3, 4, 5, 6, or 7.

In an embodiment, the scaffold can be an organic molecule, organometallic molecule, or inorganic molecule. In an embodiment, the scaffold is an organic molecule, organometallic molecule, or inorganic molecule further described by an embodiment below.

In an embodiment, the scaffold is a molecule less than or equal to approximately 1 nanometer in diameter, and the building block includes one or more frameworks, one or more linkers, and/or one or more recognition elements. In an embodiment, the scaffold is an molecule less than or equal to approximately 1 nanometer in diameter, and the building block includes a framework, a linker, and a recognition element. In an embodiment, the scaffold is an molecule less than or equal to approximately 1 nanometer in diameter, and the building block includes a framework, a linker, and two recognition elements.

In an embodiment, the scaffold is a molecule less than or equal to approximately 1 nanometer in diameter, and includes one or more: alkyl, substituted alkyl, cycloalkyl, heterocyclic, substituted heterocyclic, aryl alkyl, aryl, heteroaryl, heteroaryl alkyl, and like moieties; and the building block includes one or more frameworks, one or more linkers, and/or one or more recognition elements. In an embodiment, the scaffold is a molecule less than or equal to approximately 1 nanometer in diameter, and includes one or more: alkyl, substituted alkyl, cycloalkyl, heterocyclic, substituted heterocyclic, aryl alkyl, aryl, heteroaryl, heteroaryl alkyl, and like moieties; and the building block includes a framework, a linker, and a recognition element. In an embodiment, the scaffold is a molecule less than or equal to approximately 1 nanometer in diameter, and includes one or more: alkyl, substituted alkyl, cycloalkyl, heterocyclic, substituted heterocyclic, aryl alkyl, aryl, heteroaryl, heteroaryl alkyl, and like moieties; and the building block includes a framework, a linker, and two recognition elements.

In an embodiment, the scaffold is a molecule between approximately 1 nanometer and 100 nanometers in diameter, and the building block includes one or more frameworks, one or more linkers, and/or one or more recognition elements. In an embodiment, the scaffold is a molecule is between approximately 1 nanometer and 100 nanometers in diameter, and the building block includes a framework, a linker, and a recognition element. In an embodiment, the scaffold is a molecule is between approximately 1 nanometer and 100 nanometers in diameter, and the building block includes a framework, a linker, and two recognition elements.

In an embodiment, the scaffold is a molecule is between approximately 1 nanometer and 100 nanometers in diameter, and includes one or more: alkyl, substituted alkyl, cycloalkyl, heterocyclic, substituted heterocyclic, aryl alkyl, aryl, heteroaryl, heteroaryl alkyl, and like moieties; and the building block includes one or more frameworks, one or more linkers, and/or one or more recognition elements. In an embodiment, the scaffold is a molecule between approximately 1 nanometer and 100 nanometers in diameter, and includes one or more: alkyl, substituted alkyl, cycloalkyl, heterocyclic, substituted heterocyclic, aryl alkyl, aryl, heteroaryl, heteroaryl alkyl, and like moieties; and the building block includes a framework, a linker, and a recognition element. In an embodiment, the scaffold is a molecule between approximately 1 nanometer and 100 nanometers in diameter, and includes one or more: alkyl, substituted alkyl, cycloalkyl, heterocyclic, substituted heterocyclic, aryl alkyl, aryl, heteroaryl, heteroaryl alkyl, and like moieties; and the building block includes a framework, a linker, and two recognition elements.

The present invention also relates to a method of making an artificial receptor or a candidate artificial receptor. In an embodiment, this method includes preparing reactive sites on a scaffold, coupling a plurality of building blocks to the reactive sites, thereby immobilizing the building blocks on the scaffold.

The method can include mixing a plurality of building blocks and employing the mixture in coupling at the reactive sites. Coupling building blocks to the scaffolds can employ covalent bonding or noncovalent interactions as described above. In an embodiment, the scaffold can be functionalized with moieties that can engage in covalent bonding or noncovalent interactions. Coupling building blocks to the scaffold results in heterogeneous combinations of building blocks on each scaffold, each of which can be a candidate artificial receptor. The method can apply to immobilizing building blocks onto a scaffold in combinations of 2, 3, 4, 5, 6, 7, or more building blocks.

Building Blocks

The present invention relates to building blocks for making or forming candidate artificial receptors. Building blocks can be designed, made, and selected to provide a variety of structural characteristics among a small number of compounds. A building block can provide one or more structural characteristics such as positive charge, negative charge, acid, base, electron acceptor, electron donor, hydrogen bond donor, hydrogen bond acceptor, free electron pair, π electrons, charge polarization, hydrophilicity, hydrophobicity, and the like. A building block can be bulky or it can be small.

A building block can be visualized as including several components, such as one or more frameworks, one or more linkers, and/or one or more recognition elements. The framework can be covalently coupled to each of the other building block components. The linker can be covalently coupled to the framework. The linker can be coupled to a scaffold through one or more of covalent, electrostatic, hydrogen bonding, van der Waals, or like interactions. The recognition element can be covalently coupled to the framework. In an embodiment, a building block includes a framework, a linker, and a recognition element. In an embodiment, a building block includes a framework, a linker, and two recognition elements.

The building block can include one or more functional groups, structural features, or moieties that form the recognition moiety. For example, the building block can include one or more carboxyl, amine, hydroxyl, phenol, carbonyl, and thiol groups, which can be a recognition moiety. For example, the building block can include one or more moieties with positive charge, negative charge, acid, base, electron acceptor, electron donor, hydrogen bond donor, hydrogen bond acceptor, free electron pair, π electrons, charge polarization, hydrophilicity, hydrophobicity, and the like. The building block can include two, three, or four such functional groups, structural features, or moieties.

The building block can include one or more functional groups, structural features, or moieties that form all or part of the linking moiety. For example, the building block can include one or more carboxyl, amine, hydroxyl, phenol, carbonyl, and thiol groups, which can be a linking moiety. For example, the building block can include one or more moieties with positive charge, negative charge, acid, base, electron acceptor, electron donor, hydrogen bond donor, hydrogen bond acceptor, free electron pair, π electrons, charge polarization, hydrophilicity, hydrophobicity, and the like. The linking moiety is configured for coupling (e.g., reversibly) to the support.

A building block can be or can include any of a variety of compounds or substructures. For example, a building block can be or include an amino acid (natural or synthetic), a dipeptide, a monosaccharide, a disaccharide, another carbohydrate, a mixture or combination thereof, or the like; a catalytic moiety such as a coenzyme, a metal, a metal complex, or the like; a polymer of up to 2000 carbon atoms (e.g., up to 48 carbon atoms), e.g., a polyether, polyethyleneimine, a polyacrylamide, or like polymer; an α-hydroxy acid, a thioic acid; an enzyme inhibitor (e.g., a protease inhibitor (such as pepstatin), a statin, or the like), a receptor antagonist (e.g., a benzodiazepine), a receptor agonist, a pharmaceutical, a peptide hormone; a natural product, a starting material, intermediate, or end product of a metabolic pathway (e.g., glycolysis, the citric acid cycle, photosynthesis, glucogenesis, mitochondrial electron transport, oxidative phosphorylation, biosynthetic pathways, catabolic pathways, or the like); a mixture or combination thereof, or the like. A building block can be a naturally occurring or synthetic compound; can be racemic, optically active, or achiral; can include positional isomers of any specifically described structure; or can include conformationally restricted functional groups.

In an embodiment, the building block is or includes a monosaccharide. Any of a variety of naturally occurring or synthetic monosaccharides can be employed as a building block. Suitable monosaccharides include pyranoses and furanoses, such as glucose, fructose, ribulose, allose, altrose, mannose, gulose, idose, galactose, talose, ribose, arabinose, xylose, lyxose, or the like; erythrose, threose, or the like; inositol, or the like; amino sugars, such as rhammose, fucose, glucosamine, galactosamine, or the like; aldonic and uronic acids, such as gluconic acid, glucuronic acid, glucaric acid, or the like; glycosides including these monosaccharides; disaccharides or oligosaccharides including these monosaccharides, such as sucrose, raffinose, gentianose, cellobiose, maltose, lactose, trehalose, gentiobiose, meliobiose, or the like; a mixture or combination thereof, or the like.

In an embodiment, the building block is or includes a disaccharide. Any of a variety of naturally occurring or synthetic disaccharides can be employed as a building block. Suitable disaccharides include disaccharides or oligosaccharides including the monosaccharides listed above. Such disaccharides include sucrose, raffinose, gentianose, cellobiose, maltose, lactose, trehalose, gentiobiose, meliobiose, or the like; a mixture or combination thereof, or the like.

In an embodiment, the building block is or includes a carbohydrate. Any of a variety of naturally occurring or synthetic carbohydrates can be employed as a building block. Suitable carbohydrates include cellulose, chitin, starch, glycogen, hyaluronic acid, chondroitin sulfates, keratosulfate, heparin, glycoproteins, or the like; a mixture or combination thereof, or the like.

In an embodiment, the building block is or includes a catalytic moiety. Any of a variety of naturally occurring or synthetic catalytic moieties can be employed as or can be a moiety on a building block. Suitable catalytic moieties include coenzymes, metals, metal complexes, nucleophiles, electrophiles, reducing agents, oxidizing agents, general acid catalysts, general base catalysts, a mixture or combination thereof, or the like.

In an embodiment, the building block is or includes a metal binding or complexing moiety. Any of a variety of naturally occurring or synthetic metal binding or complexing moieties can be employed as or can be a moiety on a building block. Suitable metal binding or complexing moieties include synthetic and naturally occurring porphyrin (e.g., etioporphyrin, mesoporphyrin, protoporphyrin (e.g., heme or hematin), coproporphyrin, tetraphenylporphyrin, octaethylporphyrin, or the like), a cobamide coenzyme (e.g., coenzyme B₁₂, a cobalamin such as methyl-cobalamin, or the like), selenocysteine, selenomethionine, ferritin; naturally occurring or synthetic complexes of magnesium, zinc, copper, chromium, iron, cobalt, aluminum (e.g., Al³⁺), titanium (e.g., Ti⁴⁺) or the like; salt thereof, a mixture or combination thereof, or the like.

In an embodiment, the building block is or includes a coenzyme (which can also be called a prosthetic group or cofactor). Any of a variety of naturally occurring or synthetic coenzymes can be employed as or can be a moiety on a building block. Suitable coenzymes include a nicotinamide coenzyme (e.g., NAD, NADH, NADP, NADPH, and the like), a flavin compound (e.g., FAD, FADH₂, FMN, FMNH₂), a lipoic acid (e.g., oxidized or reduced lipoic acid), a glutathione (e.g., oxidized or reduced glutathione), an ascorbic acid, a quinone (e.g., ubiquinone, vitamins K, or the like), a porphyrin (e.g., etioporphyrin, mesoporphyrin, protoporphyrin (e.g., heme or hematin), coproporphyrin, or the like), a nucleoside (e.g., adenine, guanine, cytosine, thymine, uracil), a nucleotide (e.g., AMP, ADP, ATP, GMP, GDP, GTP, CMP, CDP, CTP, TMP, TDP, TTP, UMP, UDP, UTP), a glycerol phosphate, a biotin (e.g., biotin or carboxybiotin), a pyridoxal (e.g., pyridoxal phosphate, pyridoxal, pyridoxamine, pyridoxamine phosphate, or Schiff's bases thereof), an oxoglutaric acid (e.g., 2-oxoglutarate), a coenzyme A, a carnitine, a folic acid (e.g., tetrahydrofolic acid, 5-formyltetrahydrofolic acid, 10-formyltetrahydrofolic acid, 5,10-methenyltetrahydrofolic acid, 5,10-methylenetetrahydrofolic acid, 5-hydroxymethyltetrahydrofolic acid, 5-formiminotetrahydrofolic acid, or the like), an adenosylhomocysteine, a cobamide coenzyme (e.g., coenzyme B₁₂, a cobalamin such as methyl-cobalamin, or the like), adenosine 3′,5′-bisphosphate, thiamin diphosphate, ferritin, salt thereof, a mixture or combination thereof, or the like.

In an embodiment, the building block is or includes a polymer of up to 2000 carbon atoms (e.g., up to 48 carbon atoms). Such a polymer can be naturally occurring or synthetic. Suitable polymers include a polyether or like polymer, such as a PEG, a polyethyleneimine, polyacrylate (e.g., substituted polyacrylates), salt thereof, a mixture or combination thereof, or the like. Suitable PEGs include PEG 1500 up to PEG 20,000, for example, PEG 1450, PEG 3350, PEG 4500, PEG 8000, PEG 20,000, and the like.

In an embodiment, the present building block can be or include a lipophilic moiety. Suitable lipophilic moieties include one or more branched or straight chain C₆₋₃₆ alkyl, C₈₋₂₄ alkyl, C₁₂₋₂₄ alkyl, C₁₂₋₁₈ alkyl, or the like; C₆₋₃₆ alkenyl, C₈₋₂₄ alkenyl, C₁₂₋₂₄ alkenyl, C₁₂₋₁₈ alkenyl, or the like, with, for example, 1 to 4 double bonds; C₆₋₃₆ alkynyl, C₈₋₂₄ alkynyl, C₁₂₋₂₄ alkynyl, C₁₂₋₁₈ alkynyl, or the like, with, for example, 1 to 4 triple bonds; chains with 1-4 double or triple bonds; chains including aryl or substituted aryl moieties (e.g., phenyl or naphthyl moieties at the end or middle of a chain); polyaromatic hydrocarbon moieties; cycloalkane or substituted alkane moieties with numbers of carbons as described for chains; combinations or mixtures thereof; or the like. The alkyl, alkenyl, or alkynyl group can include branching; within chain functionality like an ether group; terminal functionality like alcohol, amide, carboxylate or the like; or the like.

Suitable building blocks include carboxylic acids (e.g., mono and di-carboxylates) with the carboxylate appended to a lipophilic moiety, such as one or more branched or straight chain C₆₋₃₆ alkyl, C₈₋₂₄ alkyl, C₁₂₋₂₄ alkyl, C₁₂₋₁₈ alkyl, or the like; C₆₋₃₆ alkenyl, C₈₋₂₄ alkenyl, C₁₂₋₂₄ alkenyl, C₁₂₋₁₈ alkenyl, or the like, with, for example, 1 to 4 double bonds; C₆₋₃₆ alkynyl, C₈₋₂₄ alkynyl, C₁₂₋₂₄ alkynyl, C₁₂₋₁₈ alkynyl, or the like, with, for example, 1 to 4 triple bonds; chains with 1-4 double or triple bonds; chains including aryl or substituted aryl moieties (e.g., phenyl or naphthyl moieties at the end or middle of a chain); or the like. Such carboxylic acids include arachidonic acid, linoleic acid, linolenic acid, oleic acid, and the like. Such carboxylic acids can be immobilized on a support through covalent bonding or electrostatic interaction between

Suitable building blocks include carboxylic acids (e.g., mono and di-carboxylates) with the carboxylate appended to a an organic radical, such as one or more branched or straight chain C₂₋₈ alkyl, arylalkyl, alkenyl, alkynyl, or the like. These carboxylic acids can include substituted aryl moieties (e.g., phenyl or naphthyl moieties). Such carboxylic acids include acetic acid, propionic acid, butanoic acid, pentanoic acid, hexanoic acid, heptanoic acid, octanoic acid, oxalic acid, malonic acid, succinic acid, glutaric acid, adipic acid, pimelic acid, benzoic acid, and the like. Such carboxylic acids can be immobilized on a support through covalent bonding or electrostatic interaction between the carboxyl(ate) and the support or lawn.

In an embodiment, the building block is or includes an amino acid. Suitable amino acids include a natural or synthetic amino acid. Amino acids include carboxyl and amine functional groups. In their side chains, amino acids can also include a moiety with one or more of positive charge, negative charge, acid, base, electron acceptor, electron donor, hydrogen bond donor, hydrogen bond acceptor, free electron pair, π electrons, charge polarization, hydrophilicity, or hydrophobicity. Suitable amino acids include those with a functional group on the side chain. The side chain functional group can include, for natural amino acids, an amine (e.g., alkyl amine, heteroaryl amine), hydroxyl, phenol, carboxyl, thiol, thioether, or amidino group.

Any of the natural amino acids can be employed as a building block. The natural amino acids include aliphatic amino acids (e.g., alanine, valine, leucine, and isoleucine), hydroxyamino acids (e.g., serine, threonine, and tyrosine), dicarboxylic acids (e.g., glutamic acid and aspartic acid), amides (e.g., glutamine and asparagine), amino acids with basic side chains (e.g., lysine, hydroxylysine, histidine, and arginine), aromatic amino acids (e.g., histidine, phenylalanine, tyrosine, tryptophan, and thyroxine), sulfur containing amino acids (e.g., cysteine, cystine, and methionine), imino acids (e.g., proline and hydroxyproline). Natural amino acids suitable for use as building blocks include, for example, serine, threonine, tyrosine, aspartic acid, glutamic acid, asparagine, glutamine, cysteine, lysine, arginine, histidine.

Synthetic amino acids can include the naturally occurring side chain functional groups or synthetic side chain functional groups which modify or extend the natural amino acids with alkyl, substituted alkyl, cycloalkyl, heterocyclic, substituted heterocyclic, aryl alkyl, aryl, heteroaryl, heteroaryl alkyl, and like moieties and with carboxyl, amine, hydroxyl, phenol, carbonyl, or thiol functional groups. Suitable synthetic amino acids include N-substituted glycine and oligomers of N-substituted glycines. Suitable synthetic amino acids include β-amino acids and homo or β analogs of natural amino acids.

In an embodiment, the building block is or includes a dipeptide. Any of the 400 dipeptides including the 20 natural amino acids in any order can be employed as building blocks. Suitable dipeptides include muramyl dipeptide or the like.

In an embodiment the building block can be or include a therapeutic or pharmacologically active agent. Suitable therapeutic or pharmacologically active agents include a nitrate, nitric oxide, a nitric oxide promoter, nitric oxide donors, dipyridamole, or another vasodilator; HYTRIN® or another antihypertensive agent; a glycoprotein IIb/IlIa inhibitor (abciximab) or another inhibitor of surface glycoprotein receptors; aspirin, ticlopidine, clopidogrel or another antiplatelet agent; colchicine or another antimitotic, or another microtubule inhibitor; a retinoid or another antisecretory agent; cytochalasin or another actin inhibitor; methotrexate or another antimetabolite or antiproliferative agent; tamoxifen citrate, TAXOL®, paclitaxel, or derivatives thereof, rapamycin, vinblastine, vincristine, vinorelbine, etoposide, tenopiside, dactinomycin (actinomycin D), daunorubicin, doxorubicin, idarubicin, an anthracycline, mitoxantrone, bleomycin, plicamycin (mithramycin), mitomycin, mechlorethamine, cyclophosphamide and its analogs, chlorambucil, an ethylenimine, a methylmelamine, an alkyl sulfonate (e.g., busulfan), a nitrosourea (carmustine, etc.), streptozocin, methotrexate (used with many indications), fluorouracil, floxuridine, cytarabine, mercaptopurine, thioguanine, pentostatin, 2-chlorodeoxyadenosine, cisplatin, carboplatin, procarbazine, hydroxyurea, or other anti-cancer chemotherapeutic agents; cyclosporin, tacrolimus (FK-506), azathioprine, mycophenolate mofetil, mTOR inhibitors, or another immunosuppressive agent; cortisol, cortisone, dexamethasone, dexamethasone sodium phosphate, dexamethasone acetate, a dexamethasone derivative, betamethasone, fludrocortisone, prednisone, prednisolone, 6U-methylprednisolone, triamcinolone (e.g., triamcinolone acetonide), or another steroidal agent; trapidil (a PDGF antagonist); dopamine, bromocriptine mesylate, pergolide mesylate, or another dopamine agonist; captopril, enalapril or another angiotensin converting enzyme (ACE) inhibitor; angiotensin receptor blockers; ascorbic acid, alpha tocopherol, deferoxamine, a 21-aminosteroid (lasaroid) or another free radical scavenger, iron chelator or antioxidant; estrogen or another sex hormone; AZT or another antipolymerase; acyclovir, famciclovir, rimantadine hydrochloride, ganciclovir sodium, Norvir, Crixivan, α-methyl-1-adamantanemethylamine, hydroxy-ethoxymethylguanine, adamantanamine, 5-iodo-2′-deoxyuridine, trifluorothymidine, adenine arabinoside, or another antiviral agent; 5-aminolevulinic acid, meta-tetrahydroxyphenylchlorin, hexadecafluorozinc phthalocyanine, tetramethyl hematoporphyrin, rhodamine 123 or other photodynamic therapy agents; PROSCAR®, HYTRIN® or other agents for treating benign prostatic hyperplasia (BHP); mitotane, aminoglutethimide, breveldin, acetaminophen, etodalac, tolmetin, ketorolac, ibuprofen and derivatives, mefenamic acid, meclofenamic acid, piroxicam, tenoxicam, phenylbutazone, oxyphenbutazone, nabumetone, auranofin, aurothioglucose, gold sodium thiomalate, a mixture of any of these, or derivatives of any of these.

In an embodiment, the building block can be or can include an antibiotic. Examples of antibiotics include penicillin, tetracycline, chloramphenicol, minocycline, doxycycline, vancomycin, bacitracin, kanamycin, neomycin, gentamycin, erythromycin and cephalosporins. Examples of cephalosporins include cephalothin, cephapirin, cefazolin, cephalexin, cephradine, cefadroxil, cefamandole, cefoxitin, cefaclor, cefuroxime, cefonicid, ceforanide, cefotaxime, moxalactam, ceftizoxime, ceftriaxone, and cefoperazone.

In an embodiment, the building block can be or can include an enzyme inhibitor. Suitable enzyme inhibitors include edrophonium chloride, N-methylphysostigmine, neostigmine bromide, physostigmine sulfate, tacrine HCL, tacrine, 1-hydroxy maleate, iodotubercidin, p-bromotetramisole, 10-(α-diethylaminopropionyl)-phenothiazine hydrochloride, calmidazolium chloride, hemicholinium-3,3,5-dinitrocatecho-1, diacylglycerol kinase inhibitor I, diacylglycerol kinase inhibitor II, 3-phenylpropargylaminie, N-monomethyl-L-arginine acetate, carbidopa, 3-hydroxybenzylhydrazine HCl, hydralazine HCl, clorgyline HCl, deprenyl HCl L(−), deprenyl HCl D(+), hydroxylamine HCl, iproniazid phosphate, 6-MeO-tetrahydro-9H-pyrido-indole, nialamide, pargyline HCl, quinacrine HCl, semicarbazide HCl, tranylcypromine HCl, N,N-diethylaminoethyl-2,2-di-phenylvalerate hydrochloride, 3-isobutyl-1-methylxanthne, papaverine HCl, indomethacind, 2-cyclooctyl-2-hydroxyethylamine hydrochloride, 2,3-dichloro-α-methylbenzylamine (DCMB), 8,9-dichloro-2,3,4,5-tetrahydro-1H-2-benzazepine hydrochloride, p-aminoglutethimide, p-aminoglutethimide tartrate R(+), p-aminoglutethimide tartrate S(−), 3-iodotyrosine, alpha-methyltyrosine L(−), alpha-methyltyrosine D(−), cetazolamide, dichlorphenamide, 6-hydroxy-2-benzothiazolesulfonamide, allopurinol, and the like.

In an embodiment, the building block is or includes a signal element that produces a detectable signal when a test ligand is bound to the receptor. In an embodiment, the signal element can produce an optical signal or a electrochemical signal. Suitable optical signals include chemiluminescence or fluorescence. The signal element can be a fluorescent moiety. The fluorescent molecule can be one that is quenched by binding to the artificial receptor. For example, the signal element can be a molecule that fluoresces only when binding occurs. Suitable electrochemical signal elements include those that give rise to current or a potential. Suitable electrochemical signal elements include phenols and anilines, such as those with substitutents oriented ortho or para to one another, polynuclear aromatic hydrocarbons, sulfide-disulfide, sulfide-sulfoxide-sulfone, polyenes, polyeneynes, and the like. Suitable electrochemical signal elements include quinones and ferrocenes.

In an embodiment, the building block includes or is substituted with a moiety providing a positive charge (e.g., at neutral pH in aqueous compositions). Suitable positively charged moieties include one or more groups such as amines, quaternary ammonium moieties, sulfonium, phosphonium, ferrocene, and the like. Suitable amines include alkyl amines, alkyl diamines, heteroalkyl amines, aryl amines, heteroaryl amines, aryl alkyl amines, pyridines, heterocyclic amines (saturated or unsaturated, the nitrogen in the ring or not), amidines, hydrazines, and the like. Alkyl amines generally have 1 to 12 carbons, preferably 1-8, rings can have 3-12 carbons, preferably 3-8. Any of the amines can be employed as a quaternary ammonium compound. Additional suitable quaternary ammonium moieties include trimethyl alkyl quaternary ammonium moieties, dimethyl ethyl alkyl quaternary ammonium moieties, dimethyl alkyl quaternary ammonium moieties, aryl alkyl quaternary ammonium moieties, pyridinium quaternary ammonium moieties, and the like.

In an embodiment, the building block includes or is substituted with a moiety providing a negative charge (e.g., at neutral pH in aqueous compositions). Suitable negatively charged moieties include one or more groups such as carboxylates, phenols substituted with strongly electron withdrawing groups (e.g., substituted tetrachlorophenols), phosphates, phosphonates, phosphinates, sulphates, sulphonates, thiocarboxylates, and hydroxamic acids. Suitable carboxylates include alkyl carboxylates, aryl carboxylates, and aryl alkyl carboxylates. Suitable phosphates include phosphate mono-, di-, and tri-esters, and phosphate mono-, di-, and tri-amides. Suitable phosphonates include phosphonate mono- and di-esters, and phosphonate mono- and di-amides (e.g., phosphonamides). Suitable phosphinates include phosphinate esters and amides.

In an embodiment, the building block includes or is substituted with a moiety providing a negative charge and a positive charge (at neutral pH in aqueous compositions), such as sulfoxides, betaines, and amine oxides.

In an embodiment, the building block includes or is substituted with an acidic moiety. Suitable acidic moieties include one or more groups such as carboxylates, phosphates, sulphates, and phenols. Suitable acidic carboxylates include thiocarboxylates. Suitable acidic phosphates include the phosphates listed hereinabove.

In an embodiment, the building block includes or is substituted with a basic moiety. Suitable basic moieties include one or more groups such as amines. Suitable basic amines include alkyl amines, aryl amines, aryl alkyl amines, pyridines, heterocyclic amines (saturated or unsaturated, the nitrogen in the ring or not), amidines, and any additional amines listed hereinabove.

In an embodiment, the building block includes or is substituted with a hydrogen bond donor. Suitable hydrogen bond donors include one or more groups such as amines, amides, carboxyls, protonated phosphates, protonated phosphonates, protonated phosphinates, protonated sulphates, protonated sulphinates, alcohols, and thiols. Suitable amines include alkyl amines, aryl amines, aryl alkyl amines, pyridines, heterocyclic amines (saturated or unsaturated, the nitrogen in the ring or not), amidines, ureas, and any other amines listed hereinabove. Suitable protonated carboxylates, protonated phosphates include those listed hereinabove. Suitable alcohols include primary alcohols, secondary alcohols, tertiary alcohols, and aromatic alcohols (e.g., phenols).

In an embodiment, the building block includes or is substituted with a hydrogen bond acceptor or a moiety with one or more free electron pairs. Suitable groups can include one or more groups such as amines, amides, carboxylates, carboxyl groups, phosphates, phosphonates, phosphinates, sulphates, sulphonates, alcohols, ethers, thiols, and thioethers. Suitable amines include alkyl amines, aryl amines, aryl alkyl amines, pyridines, heterocyclic amines (saturated or unsaturated, the nitrogen in the ring or not), amidines, ureas, and amines as listed hereinabove. Suitable carboxylates include those listed hereinabove. Suitable phosphates, phosphonates and phosphinates include those listed hereinabove. Suitable alcohols include primary alcohols, secondary alcohols, tertiary alcohols, aromatic alcohols, and those listed hereinabove. Suitable ethers include alkyl ethers, aryl alkyl ethers.

In an embodiment, the building block includes or is substituted with a an uncharged polar or hydrophilic group. Suitable groups include one or more groups such as amides, alcohols, ethers, thiols, thioethers, esters, thio esters, boranes, borates, and metal complexes. Suitable alcohols include primary alcohols, secondary alcohols, tertiary alcohols, aromatic alcohols, and those listed hereinabove. Suitable ethers include those listed hereinabove.

In an embodiment, the building block includes or is substituted with an uncharged hydrophobic group. Suitable groups include one or more groups such as alkyl (substituted and unsubstituted), alkene (conjugated and unconjugated), alkyne (conjugated and unconjugated), aromatic. Suitable alkyl groups include lower alkyl, substituted alkyl, cycloalkyl, aryl alkyl, and heteroaryl alkyl. Suitable alkene groups include lower alkene and aryl alkene. Suitable aromatic groups include unsubstituted aryl, heteroaryl, substituted aryl, aryl alkyl, heteroaryl alkyl, alkyl substituted aryl, and polyaromatic hydrocarbons.

In an embodiment, the building block includes or is substituted with a spacer (e.g., small) moiety, such as hydrogen, methyl, ethyl, and the like.

A description of general and specific features and functions of a variety of building blocks and their synthesis can be found in copending U.S. patent application Ser. No. 10/244,727, filed Sep. 16, 2002, and Application No. PCT/US03/05328, filed Feb. 19, 2003, each entitled “ARTIFICIAL RECEPTORS, BUILDING BLOCKS, AND METHODS”, and U.S. Provisional Patent Application Ser. No. 60/500,081, also entitled “ARTIFICIAL RECEPTORS, BUILDING BLOCKS, AND METHODS”, filed Sep. 3, 2003, the disclosures of which are incorporated herein by reference. These patent documents include, in particular, a detailed written description of: function, structure, and configuration of building blocks, framework moieties, recognition elements, synthesis of building blocks, specific embodiments of building blocks, specific embodiments of recognition elements, and sets of building blocks.

Framework

The framework can be selected for functional groups that provide for coupling to the recognition moiety and for coupling to or being the linking moiety. The framework can interact with the ligand as part of the artificial receptor. In an embodiment, the framework includes multiple reaction sites with orthogonal and reliable functional groups. In an embodiment, the framework includes one or more reaction sites with controlled stereochemistry. Suitable functional groups with orthogonal and reliable chemistries include, for example, carboxyl, amine, hydroxyl, phenol, carbonyl, and thiol groups, which can be individually protected, deprotected, and derivatized. In an embodiment, the framework has two, three, or four functional groups with orthogonal and reliable chemistries. In an embodiment, the framework has three functional groups. In such an embodiment, the three functional groups can be independently selected, for example, from carboxyl, amine, hydroxyl, phenol, carbonyl, or thiol group. The framework can include alkyl, substituted alkyl, cycloalkyl, heterocyclic, substituted heterocyclic, aryl alkyl, aryl, heteroaryl, heteroaryl alkyl, and like moieties.

A general structure for a framework with three functional groups can be represented by Formula Ia: 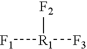
A general structure for a framework with four functional groups can be represented by Formula Ib: 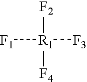
In these general structures: R₁ can be a 1-12, a 1-6, or a 1-4 carbon alkyl, substituted alkyl, cycloalkyl, heterocyclic, substituted heterocyclic, aryl alkyl, aryl, heteroaryl, heteroaryl alkyl, or like group; and F₁, F₂, F₃, or F₄ can independently be a carboxyl, amine, hydroxyl, phenol, carbonyl, or thiol group. F₁, F₂, F₃, or F₄ can independently be a 1-12, a 1-6, a 1-4 carbon alkyl, substituted alkyl, cycloalkyl, heterocyclic, substituted heterocyclic, aryl alkyl, aryl, heteroaryl, heteroaryl alkyl, or inorganic group substituted with carboxyl, amine, hydroxyl, phenol, carbonyl, or thiol group. F₃ and/or F₄ can be absent.

A variety of compounds fit the formulas and text describing the framework including amino acids, and naturally occurring or synthetic compounds including, for example, oxygen and sulfur functional groups. The compounds can be racemic, optically active, or achiral. For example, the compounds can be natural or synthetic amino acids, α-hydroxy acids, thioic acids, and the like.

Suitable molecules for use as a framework include a natural or synthetic amino acid, particularly an amino acid with a functional group (e.g., third functional group) on its side chain. Amino acids include carboxyl and amine functional groups. The side chain functional group can include, for natural amino acids, an amine (e.g., alkyl amine, heteroaryl amine), hydroxyl, phenol, carboxyl, thiol, thioether, or amidino group. Natural amino acids suitable for use as frameworks include, for example, serine, threonine, tyrosine, aspartic acid, glutamic acid, asparagine, glutamine, cysteine, lysine, arginine, histidine. Synthetic amino acids can include the naturally occurring side chain functional groups or synthetic side chain functional groups which modify or extend the natural amino acids with alkyl, substituted alkyl, cycloalkyl, heterocyclic, substituted heterocyclic, aryl alkyl, aryl, heteroaryl, heteroaryl alkyl, and like moieties as framework and with carboxyl, amine, hydroxyl, phenol, carbonyl, or thiol functional groups. Suitable synthetic amino acids include β-amino acids and homo or β analogs of natural amino acids. In an embodiment, the framework amino acid can be serine, threonine, or tyrosine, e.g., serine or tyrosine, e.g., tyrosine.

Although not limiting to the present invention, a framework amino acid, such as serine, threonine, or tyrosine, with a linker and two recognition elements can be visualized with one of the recognition elements in a pendant orientation and the other in an equatorial orientation, relative to the extended carbon chain of the framework.

All of the naturally occurring and many synthetic amino acids are commercially available. Further, forms of these amino acids derivatized or protected to be suitable for reactions for coupling to recognition element(s) and/or linkers can be purchased or made by known methods (see, e.g., Green, T W; Wuts, P G M (1999), Protective Groups in Organic Synthesis Third Edition, Wiley-Interscience, New York, 779 pp.; Bodanszky, M.; Bodanszky, A. (1994), The Practice of Peptide Synthesis Second Edition, Springer-Verlag, New York, 217 pp.).

Additional Frameworks

A framework can be or can include any of a variety of compounds or substructures. For example, a framework can be or include an amino acid (natural or synthetic), a dipeptide, a monosaccharide, a disaccharide, another carbohydrate, a mixture or combination thereof, or the like; a catalytic moiety such as a coenzyme, a metal, a metal complex, or the like; a polymer of up to 2000 carbon atoms (e.g., up to 48 carbon atoms), e.g., a polyether, polyethyleneimine, a polyacrylamide, or like polymer; an α-hydroxy acid, a thioic acid; an enzyme inhibitor (e.g., a protease inhibitor (such as pepstatin), a statin, or the like), a receptor antagonist (e.g., a benzodiazepine), a receptor agonist, a pharmaceutical, a peptide hormone; a natural product, a starting material, intermediate, or end product of a metabolic pathway (e.g., glycolysis, the citric acid cycle, photosynthesis, glucogenesis, mitochondrial electron transport, oxidative phosphorylation, biosynthetic pathways, catabolic pathways, or the like); a mixture or combination thereof, or the like. A framework can be a naturally occurring or synthetic compound; can be racemic, optically active, or achiral; can include positional isomers of any specifically described structure; or can include conformationally restricted functional groups.

In an embodiment, the framework is or includes a monosaccharide. Any of a variety of naturally occurring or synthetic monosaccharides can be employed as a framework. Suitable monosaccharides include pyranoses and furanoses, such as glucose, fructose, ribulose, allose, altrose, mannose, gulose, idose, galactose, talose, ribose, arabinose, xylose, lyxose, or the like; erythrose, threose, or the like; inositol, or the like; amino sugars, such as rhammose, fucose, glucosamine, galactosamine, or the like; aldonic and uronic acids, such as gluconic acid, glucuronic acid, glucaric acid, or the like; glycosides including these monosaccharides; a mixture or combination thereof, or the like.

In an embodiment, the framework is or includes a disaccharide. Any of a variety of naturally occurring or synthetic disaccharides can be employed as a framework. Suitable disaccharides include disaccharides or oligosaccharides including the monosaccharides listed above. Such disaccharides include sucrose, raffinose, gentianose, cellobiose, maltose, lactose, trehalose, gentiobiose, meliobiose, a mixture or combination thereof, or the like.

In an embodiment, the framework is or includes a carbohydrate. Any of a variety of naturally occurring or synthetic carbohydrates can be employed as a framework. Suitable carbohydrates include cellulose, chitin, starch, glycogen, hyaluronic acid, chondroitin sulfates, keratosulfate, heparin, glycoproteins, or the like; a mixture or combination thereof, or the like.

In an embodiment, the framework is or includes a catalytic moiety. Any of a variety of naturally occurring or synthetic catalytic moieties can be employed as or can be a moiety on a framework. Suitable catalytic moieties include coenzymes, metals, metal complexes, nucleophiles, electrophiles, reducing agents, oxidizing agents, general acid catalysts, general base catalysts, a mixture or combination thereof, or the like.

In an embodiment, the framework is or includes a metal binding or complexing moiety. Any of a variety of naturally occurring or synthetic metal binding or complexing moieties can be employed as or can be a moiety on a framework. Suitable metal binding or complexing moieties include synthetic and naturally occurring porphyrin (e.g., etioporphyrin, mesoporphyrin, protoporphyrin (e.g., heme or hematin), coproporphyrin, tetraphenylporphyrin, octaethylporphyrin, or the like), a cobamide coenzyme (e.g., coenzyme B₁₂, a cobalamin such as methyl-cobalamin, or the like), selenocysteine, selenomethionine, ferritin; naturally occurring or synthetic complexes of magnesium, zinc, copper, chromium, iron, cobalt, aluminum (e.g., Al³⁺), titanium (e.g., Ti⁴⁺) or the like; salt thereof, a mixture or combination thereof, or the like.

In an embodiment, the framework is or includes a coenzyme (which can also be called a prosthetic group or cofactor). Any of a variety of naturally occurring or synthetic coenzymes can be employed as or can be a moiety on a framework. Suitable coenzymes include a nicotinamide coenzyme (e.g., NAD, NADH, NADP, NADPH, and the like), a flavin compound (e.g., FAD, FADH₂, FMN, FMNH₂), a lipoic acid (e.g., oxidized or reduced lipoic acid), a glutathione (e.g., oxidized or reduced glutathione), an ascorbic acid, a quinone (e.g., ubiquinone, vitamins K, or the like), a porphyrin (e.g., etioporphyrin, mesoporphyrin, protoporphyrin (e.g., heme or hematin), coproporphyrin, or the like), a nucleoside (e.g., adenine, guanine, cytosine, thymine, uracil), a nucleotide (e.g., AMP, ADP, ATP, GMP, GDP, GTP, CMP, CDP, CTP, TMP, TDP, TTP, UMP, UDP, UTP), a glycerol phosphate, a biotin (e.g., biotin or carboxybiotin), a pyridoxal (e.g., pyridoxal phosphate, pyridoxal, pyridoxamine, pyridoxamine phosphate, or Schiff's bases thereof), an oxoglutaric acid (e.g., 2-oxoglutarate), a coenzyme A, a carnitine, a folic acid (e.g., tetrahydrofolic acid, 5-formyltetrahydrofolic acid, 10-formyltetrahydrofolic acid, 5,10-methenyltetrahydrofolic acid, 5,10-methylenetetrahydrofolic acid, 5-hydroxymethyltetrahydrofolic acid, 5-formiminotetrahydrofolic acid, or the like), an adenosylhomocysteine, a cobamide coenzyme (e.g., coenzyme B₁₂, a cobalamin such as methyl-cobalamin, or the like), adenosine 3′,5′-bisphosphate, thiamin diphosphate, ferritin, salt thereof, a mixture or combination thereof, or the like.

In an embodiment, the framework is or includes a polymer of up to 2000 carbon atoms (e.g., up to 48 carbon atoms). Such a polymer can be naturally occurring or synthetic. Such a polymer can be naturally occurring or synthetic. Suitable polymers include a polyether or like polymer, such as a PEG, a polyethyleneimine, polyacrylate (e.g., substituted polyacrylates), salt thereof, a mixture or combination thereof, or the like. Suitable PEGs include PEG 1500 up to PEG 20,000, for example, PEG 1450, PEG 3350, PEG 4500, PEG 8000, PEG 20,000, and the like.

In an embodiment, the building block is or includes a dipeptide. Any of the 400 dipeptides including the 20 natural amino acids in any order can be employed as building blocks. Suitable dipeptides include muramyl dipeptide or the like.

In an embodiment the framework can be or include a therapeutic or pharmacologically active agent. Suitable therapeutic or pharmacologically active agents include a nitrate, nitric oxide, a nitric oxide promoter, nitric oxide donors, dipyridamole, or another vasodilator; HYTRIN® or another antihypertensive agent; a glycoprotein Ib/IIIa inhibitor (abciximab) or another inhibitor of surface glycoprotein receptors; aspirin, ticlopidine, clopidogrel or another antiplatelet agent; colchicine or another antimitotic, or another microtubule inhibitor; a retinoid or another antisecretory agent; cytochalasin or another actin inhibitor; methotrexate or another antimetabolite or antiproliferative agent; tamoxifen citrate, TAXOL®, paclitaxel, or derivatives thereof, rapamycin, vinblastine, vincristine, vinorelbine, etoposide, tenopiside, dactinomycin (actinomycin D), daunorubicin, doxorubicin, idarubicin, an anthracycline, mitoxantrone, bleomycin, plicamycin (mithramycin), mitomycin, mechlorethamine, cyclophosphamide and its analogs, chlorambucil, an ethylenimine, a methylmelamine, an alkyl sulfonate (e.g., busulfan), a nitrosourea (carmustine, etc.), streptozocin, methotrexate (used with many indications), fluorouracil, floxuridine, cytarabine, mercaptopurine, thioguanine, pentostatin, 2-chlorodeoxyadenosine, cisplatin, carboplatin, procarbazine, hydroxyurea, or other anti-cancer chemotherapeutic agents; cyclosporin, tacrolimus (FK-506), azathioprine, mycophenolate mofetil, mTOR inhibitors, or another immunosuppressive agent; cortisol, cortisone, dexamethasone, dexamethasone sodium phosphate, dexamethasone acetate, a dexamethasone derivative, betamethasone, fludrocortisone, prednisone, prednisolone, 6U-methylprednisolone, triamcinolone (e.g., triamcinolone acetonide), or another steroidal agent; trapidil (a PDGF antagonist); dopamine, bromocriptine mesylate, pergolide mesylate, or another dopamine agonist; captopril, enalapril or another angiotensin converting enzyme (ACE) inhibitor; angiotensin receptor blockers; ascorbic acid, alpha tocopherol, deferoxamine, a 21-aminosteroid (lasaroid) or another free radical scavenger, iron chelator or antioxidant; estrogen or another sex hormone; AZT or another antipolymerase; acyclovir, famciclovir, rimantadine hydrochloride, ganciclovir sodium, Norvir, Crixivan, α-methyl-1-adamantanemethylamine, hydroxy-ethoxymethylguanine, adamantanamine, 5-iodo-2′-deoxyuridine, trifluorothymidine, adenine arabinoside, or another antiviral agent; 5-aminolevulinic acid, meta-tetrahydroxyphenylchlorin, hexadecafluorozinc phthalocyanine, tetramethyl hematoporphyrin, rhodamine 123 or other photodynamic therapy agents; PROSCAR®, HYTRIN® or other agents for treating benign prostatic hyperplasia (BHP); mitotane, aminoglutethimide, breveldin, acetaminophen, etodalac, tolmetin, ketorolac, ibuprofen and derivatives, mefenamic acid, meclofenamic acid, piroxicam, tenoxicam, phenylbutazone, oxyphenbutazone, nabumetone, auranofin, aurothioglucose, gold sodium thiomalate, a mixture of any of these, or derivatives of any of these.

In an embodiment, the framework can be or can include an antibiotic. Examples of antibiotics include penicillin, tetracycline, chloramphenicol, minocycline, doxycycline, vancomycin, bacitracin, kanamycin, neomycin, gentamycin, erythromycin and cephalosporins. Examples of cephalosporins include cephalothin, cephapirin, cefazolin, cephalexin, cephradine, cefadroxil, cefamandole, cefoxitin, cefaclor, cefuroxime, cefonicid, ceforanide, cefotaxime, moxalactam, ceftizoxime, ceftriaxone, and cefoperazone.

In an embodiment, the framework can be or can include an enzyme inhibitor. Suitable enzyme inhibitors include edrophonium chloride, N-methylphysostigmine, neostigmine bromide, physostigmine sulfate, tacrine HCL, tacrine, 1-hydroxy maleate, iodotubercidin, p-bromotetramisole, 10-(α-diethylaminopropionyl)-phenothiazine hydrochloride, calmidazolium chloride, hemicholinium-3,3,5-dinitrocatecho-1, diacylglycerol kinase inhibitor I, diacylglycerol kinase inhibitor II, 3-phenylpropargylaminie, N-monomethyl-L-arginine acetate, carbidopa, 3-hydroxybenzylhydrazine HCl, hydralazine HCl, clorgyline HCl, deprenyl HCl L(−), deprenyl HCl D(+), hydroxylamine HCl, iproniazid phosphate, 6-MeO-tetrahydro-9H-pyrido-indole, nialamide, pargyline HCl, quinacrine HCl, semicarbazide HCl, tranylcypromine HCl, N,N-diethylaminoethyl-2,2-di-phenylvalerate hydrochloride, 3-isobutyl-1-methylxanthne, papaverine HCl, indomethacind, 2-cyclooctyl-2-hydroxyethylamine hydrochloride, 2,3-dichloro-α-methylbenzylamine (DCMB), 8,9-dichloro-2,3,4,5-tetrahydro-1H-2-benzazepine hydrochloride, p-aminoglutethimide, p-aminoglutethimide tartrate R(+), p-aminoglutethimide tartrate S(−), 3-iodotyrosine, alpha-methyltyrosine L(−), alpha-methyltyrosine D(−), cetazolamide, dichlorphenamide, 6-hydroxy-2-benzothiazolesulfonamide, allopurinol, and the like.

In an embodiment, the framework is or includes a signal element that produces a detectable signal when a test ligand is bound to the receptor. In an embodiment, the signal element can produce an optical signal or a electrochemical signal. Suitable optical signals include chemiluminescence or fluorescence. The signal element can be a fluorescent moiety. The fluorescent molecule can be one that is quenched by binding to the artificial receptor. For example, the signal element can be a molecule that fluoresces only when binding occurs. Suitable electrochemical signal elements include those that give rise to current or a potential. Suitable electrochemical signal elements include phenols and anilines, such as those with substitutents oriented ortho or para to one another, polynuclear aromatic hydrocarbons, sulfide-disulfide, sulfide-sulfoxide-sulfone, polyenes, polyeneynes, and the like. Suitable electrochemical signal elements include quinones and ferrocenes.

Recognition Element

The recognition element can be selected to provide one or more structural characteristics to the building block. The recognition element can interact with the ligand as part of the artificial receptor. For example, the recognition element can provide one or more structural characteristics such as positive charge, negative charge, acid, base, electron acceptor, electron donor, hydrogen bond donor, hydrogen bond acceptor, free electron pair, π electrons, charge polarization, hydrophilicity, hydrophobicity, and the like. A recognition element can be a small group or it can be bulky.

In an embodiment the recognition element can be a 1-12, a 1-6, or a 1-4 carbon alkyl, substituted alkyl, cycloalkyl, heterocyclic, substituted heterocyclic, aryl alkyl, aryl, heteroaryl, heteroaryl alkyl, or like group. The recognition element can be substituted with a group that includes or imparts positive charge, negative charge, acid, base, electron acceptor, electron donor, hydrogen bond donor, hydrogen bond acceptor, free electron pair, π electrons, charge polarization, hydrophilicity, hydrophobicity, and the like.

Recognition elements with a positive charge (e.g., at neutral pH in aqueous compositions) include amines, quaternary ammonium moieties, sulfonium, phosphonium, ferrocene, and the like. Suitable amines include alkyl amines, alkyl diamines, heteroalkyl amines, aryl amines, heteroaryl amines, aryl alkyl amines, pyridines, heterocyclic amines (saturated or unsaturated, the nitrogen in the ring or not), amidines, hydrazines, and the like. Alkyl amines generally have 1 to 12 carbons, e.g., 1-8, and rings can have 3-12 carbons, e.g., 3-8. Suitable alkyl amines include that of formula B9. Suitable heterocyclic or alkyl heterocyclic amines include that of formula A9. Suitable pyridines include those of formulas A5 and B5. Any of the amines can be employed as a quaternary ammonium compound. Additional suitable quaternary ammonium moieties include trimethyl alkyl quaternary ammonium moieties, dimethyl ethyl alkyl quaternary ammonium moieties, dimethyl alkyl quaternary ammonium moieties, aryl alkyl quaternary ammonium moieties, pyridinium quaternary ammonium moieties, and the like.

Recognition elements with a negative charge (e.g., at neutral pH in aqueous compositions) include carboxylates, phenols substituted with strongly electron withdrawing groups (e.g., substituted tetrachlorophenols), phosphates, phosphonates, phosphinates, sulphates, sulphonates, thiocarboxylates, and hydroxamic acids. Suitable carboxylates include alkyl carboxylates, aryl carboxylates, and aryl alkyl carboxylates. Suitable phosphates include phosphate mono-, di-, and tri-esters, and phosphate mono-, di-, and tri-amides. Suitable phosphonates include phosphonate mono- and di-esters, and phosphonate mono- and di-amides (e.g., phosphonamides). Suitable phosphinates include phosphinate esters and amides.

Recognition elements with a negative charge and a positive charge (at neutral pH in aqueous compositions) include sulfoxides, betaines, and amine oxides.

Acidic recognition elements can include carboxylates, phosphates, sulphates, and phenols. Suitable acidic carboxylates include thiocarboxylates. Suitable acidic phosphates include the phosphates listed hereinabove.

Basic recognition elements include amines. Suitable basic amines include alkyl amines, aryl amines, aryl alkyl amines, pyridines, heterocyclic amines (saturated or unsaturated, the nitrogen in the ring or not), amidines, and any additional amines listed hereinabove. Suitable alkyl amines include that of formula B9. Suitable heterocyclic or alkyl heterocyclic amines include that of formula A9. Suitable pyridines include those of formulas A5 and B5.

Recognition elements including a hydrogen bond donor include amines, amides, carboxyls, protonated phosphates, protonated phosphonates, protonated phosphinates, protonated sulphates, protonated sulphinates, alcohols, and thiols. Suitable amines include alkyl amines, aryl amines, aryl alkyl amines, pyridines, heterocyclic amines (saturated or unsaturated, the nitrogen in the ring or not), amidines, ureas, and any other amines listed hereinabove. Suitable alkyl amines include that of formula B9. Suitable heterocyclic or alkyl heterocyclic amines include that of formula A9. Suitable pyridines include those of formulas A5 and B5. Suitable protonated carboxylates, protonated phosphates include those listed hereinabove. Suitable amides include those of formulas A8 and B8. Suitable alcohols include primary alcohols, secondary alcohols, tertiary alcohols, and aromatic alcohols (e.g., phenols). Suitable alcohols include those of formulas A7 (a primary alcohol) and B7 (a secondary alcohol).

Recognition elements including a hydrogen bond acceptor or one or more free electron pairs include amines, amides, carboxylates, carboxyl groups, phosphates, phosphonates, phosphinates, sulphates, sulphonates, alcohols, ethers, thiols, and thioethers. Suitable amines include alkyl amines, aryl amines, aryl alkyl amines, pyridines, heterocyclic amines (saturated or unsaturated, the nitrogen in the ring or not), amidines, ureas, and amines as listed hereinabove. Suitable alkyl amines include that of formula B9. Suitable heterocyclic or alkyl heterocyclic amines include that of formula A9. Suitable pyridines include those of formulas A5 and B5. Suitable carboxylates include those listed hereinabove. Suitable amides include those of formulas A8 and B8. Suitable phosphates, phosphonates and phosphinates include those listed hereinabove. Suitable alcohols include primary alcohols, secondary alcohols, tertiary alcohols, aromatic alcohols, and those listed hereinabove. Suitable alcohols include those of formulas A7 (a primary alcohol) and B7 (a secondary alcohol). Suitable ethers include alkyl ethers, aryl alkyl ethers. Suitable alkyl ethers include that of formula A6. Suitable aryl alkyl ethers include that of formula A4. Suitable thioethers include that of formula B6.

Recognition elements including uncharged polar or hydrophilic groups include amides, alcohols, ethers, thiols, thioethers, esters, thio esters, boranes, borates, and metal complexes. Suitable amides include those of formulas A8 and B8. Suitable alcohols include primary alcohols, secondary alcohols, tertiary alcohols, aromatic alcohols, and those listed hereinabove. Suitable alcohols include those of formulas A7 (a primary alcohol) and B7 (a secondary alcohol). Suitable ethers include those listed hereinabove. Suitable ethers include that of formula A6. Suitable aryl alkyl ethers include that of formula A4.

Recognition elements including uncharged hydrophobic groups include alkyl (substituted and unsubstituted), alkene (conjugated and unconjugated), alkyne (conjugated and unconjugated), aromatic. Suitable alkyl groups include lower alkyl, substituted alkyl, cycloalkyl, aryl alkyl, and heteroaryl alkyl. Suitable lower alkyl groups include those of formulas A1, A3, A3a, and B1. Suitable aryl alkyl groups include those of formulas A3, A3a, A4, B3, B3a, and B4. Suitable alkyl cycloalkyl groups include that of formula B2. Suitable alkene groups include lower alkene and aryl alkene. Suitable aryl alkene groups include that of formula B4. Suitable aromatic groups include unsubstituted aryl, heteroaryl, substituted aryl, aryl alkyl, heteroaryl alkyl, alkyl substituted aryl, and polyaromatic hydrocarbons. Suitable aryl alkyl groups include those of formulas A3, A3a and B4. Suitable alkyl heteroaryl groups include those of formulas A5 and B5.

Spacer (e.g., small) recognition elements include hydrogen, methyl, ethyl, and the like. Bulky recognition elements include 7 or more carbon or hetero atoms.

Formulas A1-A9 and B1-B9 are:

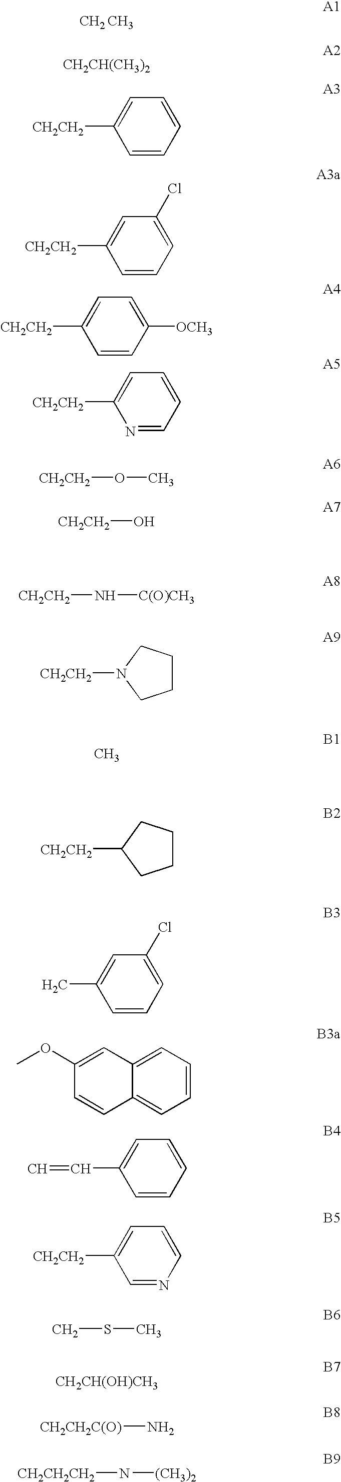

These A and B recognition elements can be called derivatives of, according to a standard reference: A1, ethylamine; A2, isobutylamine; A3, phenethylamine; A4, 4-methoxyphenethylamine; A5, 2-(2-aminoethyl)pyridine; A6, 2-methoxyethylamine; A7, ethanolamine; A8, N-acetylethylenediamine; A9, 1-(2-aminoethyl)pyrrolidine; B1, acetic acid, B2, cyclopentylpropionic acid; B3, 3-chlorophenylacetic acid; B4, cinnamic acid; B5, 3-pyridinepropionic acid; B6, (methylthio)acetic acid; B7, 3-hydroxybutyric acid; B8, succinamic acid; and B9, 4-(dimethylamino)butyric acid.

In an embodiment, the recognition elements include one or more of the structures represented by formulas A1, A2, A3, A3a, A4, A5, A6, A7, A8, and/or A9 (the A recognition elements) and/or B1, B2, B3, B3a, B4, B5, B6, B7, B8, and/or B9 (the B recognition elements). In an embodiment, each building block includes an A recognition element and a B recognition element. In an embodiment, a group of 81 such building blocks includes each of the 81 unique combinations of an A recognition element and a B recognition element. In an embodiment, the A recognition elements are linked to a framework at a pendant position. In an embodiment, the B recognition elements are linked to a framework at an equatorial position. In an embodiment, the A recognition elements are linked to a framework at a pendant position and the B recognition elements are linked to the framework at an equatorial position.

Although not limiting to the present invention, it is believed that the A and B recognition elements represent the assortment of functional groups and geometric configurations employed by polypeptide receptors. Although not limiting to the present invention, it is believed that the A recognition elements represent six advantageous functional groups or configurations and that the addition of functional groups to several of the aryl groups increases the range of possible binding interactions. Although not limiting to the present invention, it is believed that the B recognition elements represent six advantageous functional groups, but in different configurations than employed for the A recognition elements. Although not limiting to the present invention, it is further believed that this increases the range of binding interactions and further extends the range of functional groups and configurations that is explored by molecular configurations of the building blocks.

In an embodiment, the building blocks including the A and B recognition elements can be visualized as occupying a binding space defined by lipophilicity/hydrophilicity and volume. A volume can be calculated (using known methods) for each building block including the various A and B recognition elements. A measure of lipophilicity/hydrophilicity (logP) can be calculated (using known methods) for each building block including the various A and B recognition elements. Negative values of logP show affinity for water over nonpolar organic solvent and indicate a hydrophilic nature. A plot of volume versus logP can then show the distribution of the building blocks through a binding space defined by size and lipophilicity/hydrophilicity.

Reagents that form many of the recognition elements are commercially available. For example, reagents for forming recognition elements A1, A2, A3, A3a, A4, A5, A6, A7, A8, A9 B1, B2, B3, B3a, B4, B5, B6, B7, B8, and B9 are commercially available.

Additional Recognition Elements

In an embodiment the recognition element can be a 1-12, e.g., 1-6, e.g., 1-4 carbon alkyl, substituted alkyl, cycloalkyl, heterocyclic, substituted heterocyclic, aryl alkyl, aryl, heteroaryl, heteroaryl alkyl, or like group. The recognition element can be substituted with a group that includes or imparts positive charge, negative charge, acid, base, electron acceptor, electron donor, hydrogen bond donor, hydrogen bond acceptor, free electron pair, π electrons, charge polarization, hydrophilicity, hydrophobicity, and the like.

A recognition element can be or can include any of a variety of compounds or substructures. For example, a recognition element can be or include an amino acid (natural or synthetic), a dipeptide, a monosaccharide, a disaccharide, another carbohydrate, a mixture or combination thereof, or the like; a catalytic moiety such as a coenzyme, a metal, a metal complex, or the like; a polymer of up to 2000 carbon atoms (e.g., up to 48 carbon atoms), e.g., a polyether, polyethyleneimine, a polyacrylamide, or like polymer; an α-hydroxy acid, a thioic acid; an enzyme inhibitor (e.g., a protease inhibitor (such as pepstatin), a statin, or the like), a receptor antagonist (e.g., a benzodiazepine), a receptor agonist, a pharmaceutical, a peptide hormone; a natural product, a starting material, intermediate, or end product of a metabolic pathway (e.g., glycolysis, the citric acid cycle, photosynthesis, glucogenesis, mitochondrial electron transport, oxidative phosphorylation, biosynthetic pathways, catabolic pathways, or the like); a mixture or combination thereof, or the like. A building block can be a naturally occurring or synthetic compound; can be racemic, optically active, or achiral; can include positional isomers of any specifically described structure; or can include conformationally restricted functional groups.

In an embodiment, the recognition element is or includes a monosaccharide. Any of a variety of naturally occurring or synthetic monosaccharides can be employed as a recognition element. Suitable monosaccharides include pyranoses and furanoses, such as glucose, fructose, ribulose, allose, altrose, mannose, gulose, idose, galactose, talose, ribose, arabinose, xylose, lyxose, or the like; erythrose, threose, or the like; inositol, or the like; amino sugars, such as rhammose, fucose, glucosamine, galactosamine, or the like; aldonic and uronic acids, such as gluconic acid, glucuronic acid, glucaric acid, or the like; glycosides including these monosaccharides; a mixture or combination thereof, or the like.

In an embodiment, the recognition element is or includes a disaccharide. Any of a variety of naturally occurring or synthetic disaccharides can be employed as a building block. Suitable disaccharides include disaccharides or oligosaccharides including the monosaccharides listed above. Such disaccharides include sucrose, raffinose, gentianose, cellobiose, maltose, lactose, trehalose, gentiobiose, meliobiose, a mixture or combination thereof, or the like.

In an embodiment, the recognition element is or includes a carbohydrate. Any of a variety of naturally occurring or synthetic carbohydrates can be employed as a recognition element. Suitable carbohydrates include cellulose, chitin, starch, glycogen, hyaluronic acid, chondroitin sulfates, keratosulfate, heparin, glycoproteins, or the like; a mixture or combination thereof, or the like.

In an embodiment, the recognition element is or includes a catalytic moiety. Any of a variety of naturally occurring or synthetic catalytic moieties can be employed as or can be a moiety on a recognition element. Suitable catalytic moieties include coenzymes, metals, metal complexes, nucleophiles, electrophiles, reducing agents, oxidizing agents, general acid catalysts, general base catalysts, a mixture or combination thereof, or the like.

In an embodiment, the recognition element is or includes a metal binding or complexing moiety. Any of a variety of naturally occurring or synthetic metal binding or complexing moieties can be employed as or can be a moiety on a recognition element. Suitable metal binding or complexing moieties include synthetic and naturally occurring porphyrin (e.g., etioporphyrin, mesoporphyrin, protoporphyrin (e.g., heme or hematin), coproporphyrin, tetraphenylporphyrin, octaethylporphyrin, or the like), a cobamide coenzyme (e.g., coenzyme B₁₂, a cobalamin such as methyl-cobalamin, or the like), selenocysteine, selenomethionine, ferritin; naturally occurring or synthetic complexes of magnesium, zinc, copper, chromium, iron, cobalt, aluminum (e.g., Al³⁺), titanium (e.g., Ti⁴⁺) or the like; salt thereof, a mixture or combination thereof, or the like.

In an embodiment, the recognition element is or includes a coenzyme (which can also be called a prosthetic group or cofactor). Any of a variety of naturally occurring or synthetic coenzymes can be employed as or can be a moiety on a recognition element. Suitable coenzymes include a nicotinamide coenzyme (e.g., NAD, NADH, NADP, NADPH, and the like), a flavin compound (e.g., FAD, FADH₂, FMN, FMNH₂), a lipoic acid (e.g., oxidized or reduced lipoic acid), a glutathione (e.g., oxidized or reduced glutathione), an ascorbic acid, a quinone (e.g., ubiquinone, vitamins K, or the like), a porphyrin (e.g., etioporphyrin, mesoporphyrin, protoporphyrin (e.g., heme or hematin), coproporphyrin, or the like), a nucleoside (e.g., adenine, guanine, cytosine, thymine, uracil), a nucleotide (e.g., AMP, ADP, ATP, GMP, GDP, GTP, CMP, CDP, CTP, TMP, TDP, TTP, UMP, UDP, UTP), a glycerol phosphate, a biotin (e.g., biotin or carboxybiotin), a pyridoxal (e.g., pyridoxal phosphate, pyridoxal, pyridoxamine, pyridoxamine phosphate, or Schiff's bases thereof), an oxoglutaric acid (e.g., 2-oxoglutarate), a coenzyme A, a carnitine, a folic acid (e.g., tetrahydrofolic acid, 5-formyltetrahydrofolic acid, 10-formyltetrahydrofolic acid, 5,10-methenyltetrahydrofolic acid, 5,10-methylenetetrahydrofolic acid, 5-hydroxymethyltetrahydrofolic acid, 5-formiminotetrahydrofolic acid, or the like), an adenosylhomocysteine, a cobamide coenzyme (e.g., coenzyme B₁₂, a cobalamin such as methyl-cobalamin, or the like), adenosine 3′,5′-bisphosphate, thiamin diphosphate, ferritin, salt thereof, a mixture or combination thereof, or the like.

In an embodiment, the present recognition element can be or include a lipophilic moiety. Suitable lipophilic moieties include one or more branched or straight chain C₆₋₃₆ alkyl, C₈₋₂₄ alkyl, C₁₂₋₂₄ alkyl, C₁₂₋₁₈ alkyl, or the like; C₆₋₃₆ alkenyl, C₈₋₂₄ alkenyl, C₁₂₋₂₄ alkenyl, C₁₂₋₁₈ alkenyl, or the like, with, for example, 1 to 4 double bonds; C₆₋₃₆ alkynyl, C₈₋₂₄ alkynyl, C₁₂₋₂₄ alkynyl, C₁₂₋₁₈ alkynyl, or the like, with, for example, 1 to 4 triple bonds; chains with 1-4 double or triple bonds; chains including aryl or substituted aryl moieties (e.g., phenyl or naphthyl moieties at the end or middle of a chain); polyaromatic hydrocarbon moieties; cycloalkane or substituted alkane moieties with numbers of carbons as described for chains; combinations or mixtures thereof; or the like. The alkyl, alkenyl, or alkynyl group can include branching; within chain functionality like an ether group; terminal functionality like alcohol, amide, carboxylate or the like; or the like.

Suitable recognition elements include carboxylic acids (e.g., mono and di-carboxylates) with the carboxylate appended to a lipophilic moiety, such as one or more branched or straight chain C₆₋₃₆ alkyl, C₈₋₂₄ alkyl, C₁₂₋₂₄ alkyl, C₁₂₋₁₈ alkyl, or the like; C₆₋₃₆ alkenyl, C₈₋₂₄ alkenyl, C₁₂₋₂₄ alkenyl, C₁₂₋₁₈ alkenyl, or the like, with, for example, 1 to 4 double bonds; C₆₋₃₆ alkynyl, C₈₋₂₄ alkynyl, C₁₂₋₂₄ alkynyl, C₁₂₋₁₈ alkynyl, or the like, with, for example, 1 to 4 triple bonds; chains with 1-4 double or triple bonds; chains including aryl or substituted aryl moieties (e.g., phenyl or naphthyl moieties at the end or middle of a chain); or the like. Such carboxylic acids include arachidonic acid, linoleic acid, linolenic acid, oleic acid, and the like. Such carboxylic acids can be immobilized on a support through covalent bonding or electrostatic interaction between

Suitable recognition elements include carboxylic acids (e.g., mono and di-carboxylates) with the carboxylate appended to a an organic radical, such as one or more branched or straight chain C₂₋₈ alkyl, arylalkyl, alkenyl, alkynyl, or the like. These carboxylic acids can include substituted aryl moieties (e.g., phenyl or naphthyl moieties). Such carboxylic acids include acetic acid, propionic acid, butanoic acid, pentanoic acid, hexanoic acid, heptanoic acid, octanoic acid, oxalic acid, malonic acid, succinic acid, glutaric acid, adipic acid, pimelic acid, benzoic acid, and the like. Such carboxylic acids can be immobilized on a support through covalent bonding or electrostatic interaction between the carboxyl(ate) and the support or lawn.

In an embodiment, the recognition element is or includes an amino acid. Suitable amino acids include a natural or synthetic amino acid. Amino acids include carboxyl and amine functional groups. In their side chains, amino acids can also include a moiety with one or more of positive charge, negative charge, acid, base, electron acceptor, electron donor, hydrogen bond donor, hydrogen bond acceptor, free electron pair, π electrons, charge polarization, hydrophilicity, or hydrophobicity. Suitable amino acids include those with a functional group on the side chain. The side chain functional group can include, for natural amino acids, an amine (e.g., alkyl amine, heteroaryl amine), hydroxyl, phenol, carboxyl, thiol, thioether, or amidino group.

Any of the natural amino acids can be employed as a recognition element. The natural amino acids include aliphatic amino acids (e.g., alanine, valine, leucine, and isoleucine), hydroxyamino acids (e.g., serine, threonine, and tyrosine), dicarboxylic acids (e.g., glutamic acid and aspartic acid), amides (e.g., glutamine and asparagine), amino acids with basic side chains (e.g., lysine, hydroxylysine, histidine, and arginine), aromatic amino acids (e.g., histidine, phenylalanine, tyrosine, tryptophan, and thyroxine), sulfur containing amino acids (e.g., cysteine, cystine, and methionine), imino acids (e.g., proline and hydroxyproline). Natural amino acids suitable for use as recognition elements include, for example, serine, threonine, tyrosine, aspartic acid, glutamic acid, asparagine, glutamine, cysteine, lysine, arginine, histidine.

Synthetic amino acids can include the naturally occurring side chain functional groups or synthetic side chain functional groups which modify or extend the natural amino acids with alkyl, substituted alkyl, cycloalkyl, heterocyclic, substituted heterocyclic, aryl alkyl, aryl, heteroaryl, heteroaryl alkyl, and like moieties as framework and with carboxyl, amine, hydroxyl, phenol, carbonyl, or thiol functional groups. Preferred synthetic amino acids include β-amino acids and homo or β analogs of natural amino acids.

In an embodiment, the building block is or includes a dipeptide. Any of the 400 dipeptides including the 20 natural amino acids in any order can be employed as building blocks. Suitable dipeptides include muramyl dipeptide or the like.

In an embodiment the recognition element can be or include a therapeutic or pharmacologically active agent. Suitable therapeutic or pharmacologically active agents include a nitrate, nitric oxide, a nitric oxide promoter, nitric oxide donors, dipyridamole, or another vasodilator; HYTRIN® or another antihypertensive agent; a glycoprotein IIb/IIIa inhibitor (abciximab) or another inhibitor of surface glycoprotein receptors; aspirin, ticlopidine, clopidogrel or another antiplatelet agent; colchicine or another antimitotic, or another microtubule inhibitor; a retinoid or another antisecretory agent; cytochalasin or another actin inhibitor; methotrexate or another antimetabolite or antiproliferative agent; tamoxifen citrate, TAXOL®, paclitaxel, or derivatives thereof, rapamycin, vinblastine, vincristine, vinorelbine, etoposide, tenopiside, dactinomycin (actinomycin D), daunorubicin, doxorubicin, idarubicin, an anthracycline, mitoxantrone, bleomycin, plicamycin (mithramycin), mitomycin, mechlorethamine, cyclophosphamide and its analogs, chlorambucil, an ethylenimine, a methylmelamine, an alkyl sulfonate (e.g., busulfan), a nitrosourea (carmustine, etc.), streptozocin, methotrexate (used with many indications), fluorouracil, floxuridine, cytarabine, mercaptopurine, thioguanine, pentostatin, 2-chlorodeoxyadenosine, cisplatin, carboplatin, procarbazine, hydroxyurea, or other anti-cancer chemotherapeutic agents; cyclosporin, tacrolimus (FK-506), azathioprine, mycophenolate mofetil, mTOR inhibitors, or another immunosuppressive agent; cortisol, cortisone, dexamethasone, dexamethasone sodium phosphate, dexamethasone acetate, a dexamethasone derivative, betamethasone, fludrocortisone, prednisone, prednisolone, 6U-methylprednisolone, triamcinolone (e.g., triamcinolone acetonide), or another steroidal agent; trapidil (a PDGF antagonist); dopamine, bromocriptine mesylate, pergolide mesylate, or another dopamine agonist; captopril, enalapril or another angiotensin converting enzyme (ACE) inhibitor; angiotensin receptor blockers; ascorbic acid, alpha tocopherol, deferoxamine, a 21-aminosteroid (lasaroid) or another free radical scavenger, iron chelator or antioxidant; estrogen or another sex hormone; AZT or another antipolymerase; acyclovir, famciclovir, rimantadine hydrochloride, ganciclovir sodium, Norvir, Crixivan, α-methyl-1-adamantanemethylamine, hydroxy-ethoxymethylguanine, adamantanamine, 5-iodo-2′-deoxyuridine, trifluorothymidine, adenine arabinoside, or another antiviral agent; 5-aminolevulinic acid, meta-tetrahydroxyphenylchlorin, hexadecafluorozinc phthalocyanine, tetramethyl hematoporphyrin, rhodamine 123 or other photodynamic therapy agents; PROSCAR®, HYTRIN® or other agents for treating benign prostatic hyperplasia (BHP); mitotane, aminoglutethimide, breveldin, acetaminophen, etodalac, tolmetin, ketorolac, ibuprofen and derivatives, mefenamic acid, meclofenamic acid, piroxicam, tenoxicam, phenylbutazone, oxyphenbutazone, nabumetone, auranofin, aurothioglucose, gold sodium thiomalate, a mixture of any of these, or derivatives of any of these.

In an embodiment, the recognition element can be or can include an antibiotic. Examples of antibiotics include penicillin, tetracycline, chloramphenicol, minocycline, doxycycline, vancomycin, bacitracin, kanamycin, neomycin, gentamycin, erythromycin and cephalosporins. Examples of cephalosporins include cephalothin, cephapirin, cefazolin, cephalexin, cephradine, cefadroxil, cefamandole, cefoxitin, cefaclor, cefuroxime, cefonicid, ceforanide, cefotaxime, moxalactam, ceftizoxime, ceftriaxone, and cefoperazone.

In an embodiment, the recognition element can be or can include an enzyme inhibitor. Suitable enzyme inhibitors include edrophonium chloride, N-methylphysostigmine, neostigmine bromide, physostigmine sulfate, tacrine HCL, tacrine, 1-hydroxy maleate, iodotubercidin, p-bromotetramisole, 10-(α-diethylaminopropionyl)-phenothiazine hydrochloride, calmidazolium chloride, hemicholinium-3,3,5-dinitrocatecho-1, diacylglycerol kinase inhibitor I, diacylglycerol kinase inhibitor II, 3-phenylpropargylaminie, N-monomethyl-L-arginine acetate, carbidopa, 3-hydroxybenzylhydrazine HCl, hydralazine HCl, clorgyline HCl, deprenyl HCl L(−), deprenyl HCl D(+), hydroxylamine HCl, iproniazid phosphate, 6-MeO-tetrahydro-9H-pyrido-indole, nialamide, pargyline HCl, quinacrine HCl, semicarbazide HCl, tranylcypromine HCl, N,N-diethylaminoethyl-2,2-di-phenylvalerate hydrochloride, 3-isobutyl-1-methylxanthne, papaverine HCl, indomethacind, 2-cyclooctyl-2-hydroxyethylamine hydrochloride, 2,3-dichloro-α-methylbenzylamine (DCMB), 8,9-dichloro-2,3,4,5-tetrahydro-1H-2-benzazepine hydrochloride, p-aminoglutethimide, p-aminoglutethimide tartrate R(+), p-aminoglutethimide tartrate S(−), 3-iodotyrosine, alpha-methyltyrosine L(−), alpha-methyltyrosine D(−), cetazolamide, dichlorphenamide, 6-hydroxy-2-benzothiazolesulfonamide, allopurinol, and the like.

In an embodiment, the recognition element is or includes a signal element that produces a detectable signal when a test ligand is bound to the receptor. In an embodiment, the signal element can produce an optical signal or a electrochemical signal. Suitable optical signals include chemiluminescence or fluorescence. The signal element can be a fluorescent moiety. The fluorescent molecule can be one that is quenched by binding to the artificial receptor. For example, the signal element can be a molecule that fluoresces only when binding occurs. Suitable electrochemical signal elements include those that give rise to current or a potential. Suitable electrochemical signal elements include phenols and anilines, such as those with substitutents oriented ortho or para to one another, polynuclear aromatic hydrocarbons, sulfide-disulfide, sulfide-sulfoxide-sulfone, polyenes, polyeneynes, and the like. Suitable electrochemical signal elements include quinones and ferrocenes.

Linkers

The linker is selected to provide a suitable coupling of the building block to a scaffold. The linker can interact with the ligand as part of the artificial receptor. The linker can also provide bulk, distance from the scaffold, hydrophobicity, hydrophilicity, and like structural characteristics to the building block. Coupling building blocks to the scaffold can employ covalent bonding or noncovalent interactions. Suitable noncovalent interactions include interactions between ions, hydrogen bonding, van der Waals interactions, and the like. In an embodiment, the linker includes moieties that can engage in covalent bonding or noncovalent interactions. In an embodiment, the linker includes moieties that can engage in covalent bonding. Suitable groups for forming covalent and reversible covalent bonds are described hereinabove.

Linkers for Reversibly Immobilizable Building Blocks

The linker can be selected to provide suitable reversible immobilization of the building block on a scaffold, support or lawn. In an embodiment, the linker forms a covalent bond with a functional group on the framework. In an embodiment, the linker also includes a functional group that can reversibly interact with the scaffold, e.g., through reversible covalent bonding or noncovalent interactions.

In an embodiment, the linker includes one or more moieties that can engage in reversible covalent bonding. Suitable groups for reversible covalent bonding include those described hereinabove. An artificial receptor can include building blocks reversibly immobilized on the scaffold through, for example, imine, acetal, ketal, disulfide, ester, or like linkages. Such functional groups can engage in reversible covalent bonding. Such a functional group can be referred to as a covalent bonding moiety, e.g., a second covalent bonding moiety.

In an embodiment, the linker can be functionalized with moieties that can engage in noncovalent interactions. For example, the linker can include functional groups such as an ionic group, a group that can hydrogen bond, or a group that can engage in van der Waals or other hydrophobic interactions. Such functional groups can include cationic groups, anionic groups, lipophilic groups, amphiphilic groups, and the like.

In an embodiment, the present methods and compositions can employ a linker including a charged moiety (e.g., a second charged moiety). Suitable charged moieties include positively charged moieties and negatively charged moieties. Suitable positively charged moieties include amines, quaternary ammonium moieties, sulfonium, phosphonium, ferrocene, and the like. Suitable negatively charged moieties (e.g., at neutral pH in aqueous compositions) include carboxylates, phenols substituted with strongly electron withdrawing groups (e.g., tetrachlorophenols), phosphates, phosphonates, phosphinates, sulphates, sulphonates, thiocarboxylates, and hydroxamic acids.

In an embodiment, the present methods and compositions can employ a linker including a group that can hydrogen bond, either as donor or acceptor (e.g., a second hydrogen bonding group). For example, the linker can include one or more carboxyl groups, amine groups, hydroxyl groups, carbonyl groups, or the like. Ionic groups can also participate in hydrogen bonding.

In an embodiment, the present methods and compositions can employ a linker including a lipophilic moiety (e.g., a second lipophilic moiety). Suitable lipophilic moieties include one or more branched or straight chain C₆₋₃₆ alkyl, C₈₋₂₄ alkyl, C₁₂₋₂₄ alkyl, C₁₂₋₁₈ alkyl, or the like; C₆₋₃₆ alkenyl, C₈₋₂₄ alkenyl, C₁₂₋₂₄ alkenyl, C₁₂₋₁₈ alkenyl, or the like, with, for example, 1 to 4 double bonds; C₆₋₃₆ alkynyl, C₈₋₂₄ alkynyl, C₁₂₋₂₄ alkynyl, C₁₂₋₁₈ alkynyl, or the like, with, for example, 1 to 4 triple bonds; chains with 1-4 double or triple bonds; chains including aryl or substituted aryl moieties (e.g., phenyl or naphthyl moieties at the end or middle of a chain); polyaromatic hydrocarbon moieties; cycloalkane or substituted alkane moieties with numbers of carbons as described for chains; combinations or mixtures thereof; or the like. The alkyl, alkenyl, or alkynyl group can include branching; within chain functionality like an ether group; terminal functionality like alcohol, amide, carboxylate or the like; or the like. In an embodiment the linker includes or is a lipid, such as a phospholipid. In an embodiment, the lipophilic moiety includes or is a 12-carbon aliphatic moiety.

In an embodiment, the linker includes a lipophilic moiety (e.g., a second lipophilic moiety) and a covalent bonding moiety (e.g., a second covalent bonding moiety). In an embodiment, the linker includes a lipophilic moiety (e.g., a second lipophilic moiety) and a charged moiety (e.g., a second charged moiety).

In an embodiment, the linker forms or can be visualized as forming a covalent bond with an alcohol, phenol, thiol, amine, carbonyl, or like group on the framework. Between the bond to the framework and the group participating in or formed by the reversible interaction with the scaffold or lawn, the linker can include an alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or like moiety.

For example, suitable linkers can include: the functional group participating in or formed by the bond to the framework, the functional group or groups participating in or formed by the reversible interaction with the scaffold or lawn, and a linker backbone moiety. The linker backbone moiety can include about 4 to about 48 carbon or heteroatoms, about 8 to about 14 carbon or heteroatoms, about 12 to about 24 carbon or heteroatoms, about 16 to about 18 carbon or heteroatoms, about 4 to about 12 carbon or heteroatoms, about 4 to about 8 carbon or heteroatoms, or the like. The linker backbone can include an alkyl, substituted alkyl, cycloalkyl, heterocyclic, substituted heterocyclic, aryl alkyl, aryl, heteroaryl, heteroaryl alkyl, ethoxy or propoxy oligomer, a glycoside, mixtures thereof, or like moiety.

In an embodiment, the linker includes a lipophilic moiety, the functional group participating in or formed by the bond to the framework, and, optionally, one or more moieties for forming a reversible covalent bond, a hydrogen bond, or an ionic interaction. In such an embodiment, the lipophilic moiety can have about 4 to about 48 carbons, about 8 to about 14 carbons, about 12 to about 24 carbons, about 16 to about 18 carbons, or the like. In such an embodiment, the linker can include about 1 to about 8 reversible bond/interaction moieties or about 2 to about 4 reversible bond/interaction moieties. Suitable linkers have structures such as (CH₂)ₙCOOH, with n=12-24, n=17-24, or n=16-18.

Additional Embodiments of Linkers

The linker can be selected to provide a suitable covalent coupling of the building block to a scaffold. The linker can interact with the ligand as part of the artificial receptor. The linker can also provide bulk, distance from the scaffold, hydrophobicity, hydrophilicity, and like structural characteristics to the building block. In an embodiment, the linker forms a covalent bond with a functional group on the framework. In an embodiment, before attachment to the scaffold, the linker also includes a functional group that can be activated to react with or that will react with a functional group on the scaffold. In an embodiment, once attached to the scaffold, the linker forms a covalent bond with the scaffold and with the framework.

In an embodiment, the linker forms or can be visualized as forming a covalent bond with an alcohol, phenol, thiol, amine, carbonyl, or like group on the framework. The linker can include a carboxyl, alcohol, phenol, thiol, amine, carbonyl, maleimide, or like group that can react with or be activated to react with the scaffold. Between the bond to the framework and the group formed by the attachment to the scaffold, the linker can include an alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or like moiety.

The linker can include a good leaving group bonded to, for example, an alkyl or aryl group. The leaving group being “good” enough to be displaced by the alcohol, phenol, thiol, amine, carbonyl, or like group on the framework. Such a linker can include a moiety represented by the formula: R—X, in which X is a leaving group such as halogen (e.g., —Cl, —Br or —I), tosylate, mesylate, triflate, and R is alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or like moiety.

Suitable linker groups include those of formula: (CH₂)ₙCOOH, with n=1-16, n=2-8, n=2-6, or n=3. Reagents that form suitable linkers are commercially available and include any of a variety of reagents with orthogonal functionality.

Embodiments of Building Blocks

In an embodiment, building blocks can be represented by Formula 2: 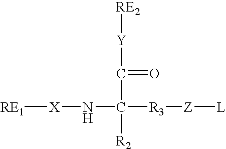
in which: RE₁ is recognition element 1, RE₂ is recognition element 2, and L is a linker. X is absent, C═O, CH₂, NR, NR2, NH, NHCONH, SCONH, CH═N, or OCH₂NH. Preferably X is absent or C═O. Y is absent, NH, O, CH₂, or NRCO. Preferably Y is NH or O. Preferably Y is NH. Z is CH2, O, NH, S, CO, NR, NR2, NHCONH, SCONH, CH═N, or OCH₂NH. Preferably Z is O. R₂ is H, CH₃, or another group that confers chirality on the building block and has size similar to or smaller than a methyl group. R₃ is CH₂; CH₂-phenyl; CHCH₃; (CH₂)ₙ with n=2-3; or cyclic alkyl with 3-8 carbons, preferably 5-6 carbons, phenyl, naphthyl. Preferably R₃ is CH₂ or CH₂-phenyl.

In an embodiment, L is the functional group participating in or formed by the bond to the framework (such groups are described herein), the functional group or groups participating in or formed by the reversible interaction with the support or lawn (such groups are described herein), and a linker backbone moiety. In an embodiment, the linker backbone moiety is about 4 to about 48 carbon or heteroatom alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or mixtures thereof; or about 8 to about 14 carbon or heteroatoms, about 12 to about 24 carbon or heteroatoms, about 16 to about 18 carbon or heteroatoms, about 4 to about 12 carbon or heteroatoms, about 4 to about 8 carbon or heteroatoms.

In an embodiment, the L is the functional group participating in or formed by the bond to the framework (such groups are described herein) and a lipophilic moiety (such groups are described herein) of about 4 to about 48 carbons, about 8 to about 14 carbons, about 12 to about 24 carbons, about 16 to about 18 carbons. In an embodiment, this L also includes about 1 to about 8 reversible bond/interaction moieties (such groups are described herein) or about 2 to about 4 reversible bond/interaction moieties. In an embodiment, L is (CH₂)ₙCOOH, with n=12-24, n=17-24, or n=16-18.

In an embodiment, RE1 and RE2 can independently be any of the recognition elements listed hereinabove.

Scaffolds

In an embodiment, an artificial receptor of the present invention includes a plurality of building blocks coupled to a scaffold. In an embodiment, a scaffold supports an artificial receptor including a combination of 2, 3, 4, or more building blocks occupying distinct positions relative to one another on the scaffold. Such an artificial receptor is referred to as a scaffold artificial receptor. A scaffold artificial receptor is not coupled to a support unless explicitly described as being so coupled. In an embodiment, a scaffold, having coupled to it a plurality of building blocks, can additionally be coupled to a support.

In an embodiment, the scaffold can be envisioned as forming one or more linker moieties. In an embodiment, the scaffold can be envisioned as forming one or more framework moieties. In an embodiment, the scaffold can be envisioned as forming a combination of: zero, one or more framework moieties; and/or zero, one or more linker moieties; at each distinct position on the scaffold. Each distinct position can also be called a reactive site.

The scaffold can be an organic molecule, inorganic molecule, organometallic molecule, or any combination or assembly thereof. The scaffold can be an organic molecule generally formed of carbon and heteroatoms (and may additionally include coordinated metals or organometallic functional groups) combined in hydrocarbon building blocks and functional groups. In an embodiment, the scaffold is less than or equal to approximately 1 nanometer in size. Organic molecules less than or equal to 1 nanometer in size include small organic molecules, including buckminsterfullerene (C₆₀, approximately 1 nm in diameter). In an embodiment, the scaffold can include alkyl, substituted alkyl, cycloalkyl, heterocyclic, substituted heterocyclic, aryl alkyl, aryl, heteroaryl, heteroaryl alkyl, and like moieties. In an embodiment, the scaffold is greater than approximately 1 nanometer in size, up to approximately 10 nanometers, but may be as large as 100 nanometers. Organic molecules greater than 1 nanometer in size include, for example, macromolecules, such as dendrimers and those generated by traditional polymer chemistry, as well as biological macromolecules, including DNA, RNA, and proteins.

The scaffold can be selected for functional groups to provide a suitable coupling of the building blocks to the scaffold. In an embodiment, the functional groups of the scaffold are located at distinct positions, each position being a reaction site. Coupling building blocks to the scaffold can employ covalent bonding, weaker than covalent bonding and ionic bonding interactions. Suitable noncovalent interactions include interactions between ions, hydrogen bonding, van der Waals interactions, and the like. In an embodiment, the scaffold includes moieties that can engage in covalent bonding or noncovalent interactions. In an embodiment, the scaffold includes moieties that can engage in covalent bonding. Suitable groups for forming covalent and reversible covalent bonds are described herein.

In an embodiment, the scaffold includes one or more moieties that can engage in reversible covalent bonding. Suitable groups for reversible covalent bonding include those described hereinabove. An artificial receptor can include building blocks reversibly immobilized on a scaffold through, for example, imine, acetal, ketal, disulfide, ester, or like linkages. Such functional groups can engage in reversible covalent bonding. Such a functional group can be referred to as a covalent bonding moiety, e.g., a second covalent bonding moiety.

In an embodiment, the scaffold can be functionalized with moieties that can engage in covalent bonding, e.g., reversible covalent bonding. The present invention can employ any of a variety of the numerous known functional groups, reagents, and reactions for forming reversible covalent bonds. Suitable reagents for forming reversible covalent bonds include those described in Green, T W; Wuts, P G M (1999), Protective Groups in Organic Synthesis Third Edition, Wiley-Interscience, New York, 779 pp. For example, the scaffold can include functional groups such as a carbonyl group, a carboxyl group, a silane group, boric acid or ester, an amine group (e.g., a primary, secondary, or tertiary amine, a hydroxylamine, a hydrazine, or the like), a thiol group, an alcohol group (e.g., primary, secondary, or tertiary alcohol), a diol group (e.g., a 1,2 diol or a 1,3 diol), a phenol group, a catechol group, or the like. These functional groups can form groups with reversible covalent bonds, such as ether (e.g., alkyl ether, silyl ether, thioether, or the like), ester (e.g., alkyl ester, phenol ester, cyclic ester, thioester, or the like), acetal (e.g., cyclic acetal), ketal (e.g., cyclic ketal), silyl derivative (e.g., silyl ether), boronate (e.g., cyclic boronate), amide, hydrazide, imine, carbamate, or the like. Such a functional group can be referred to as a covalent bonding moiety, e.g., a first covalent bonding moiety.

A carbonyl group on the scaffold and an amine group on a building block can form an imine or Schiff's base. The same is true of an amine group on the scaffold and a carbonyl group on a building block. A carbonyl group on the scaffold and an alcohol group on a building block can form an acetal or ketal. The same is true of an alcohol group on the scaffold and a carbonyl group on a building block. A thiol (e.g., a first thiol) on the scaffold and a thiol (e.g., a second thiol) on the building block can form a disulfide.

A carboxyl group on the scaffold and an alcohol group on a building block can form an ester. The same is true of an alcohol group on the scaffold and a carboxyl group on a building block. Any of a variety of alcohols and carboxylic acids can form esters that provide covalent bonding that can be reversed in the context of the present invention. For example, reversible ester linkages can be formed from alcohols such as phenols with electron withdrawing groups on the aryl ring, other alcohols with electron withdrawing groups acting on the hydroxyl-bearing carbon, other alcohols, or the like; and/or carboxyl groups such as those with electron withdrawing groups acting on the acyl carbon (e.g., nitrobenzylic acid, R—CF₂—COOH, R—CCl₂—COOH, and the like), other carboxylic acids, or the like.

In an embodiment, the scaffold can be functionalized with moieties that can engage in noncovalent or weaker than covalent interactions. For example, the scaffold can include functional groups such as an ionic group, a group that can hydrogen bond, a group that can engage in host-guest interactions, or a group that can engage in van der Waals or other hydrophobic interactions. Such functional groups can include cationic groups, anionic groups, lipophilic groups, amphiphilic groups, and the like.

In an embodiment, the present methods and compositions can employ a scaffold including a charged moiety (e.g., a second charged moiety). Suitable charged moieties include positively charged moieties and negatively charged moieties. Suitable positively charged moieties include amines, quaternary ammonium moieties, sulfonium, phosphonium, ferrocene, and the like. Suitable negatively charged moieties (e.g., at neutral pH in aqueous compositions) include carboxylates, phenols substituted with strongly electron withdrawing groups (e.g., tetrachlorophenols), phosphates, phosphonates, phosphinates, sulphates, sulphonates, thiocarboxylates, and hydroxamic acids.

In an embodiment, the present methods and compositions can employ a scaffold including a group that can hydrogen bond, either as donor or acceptor (e.g., a second hydrogen bonding group). For example, the scaffold can include one or more carboxyl groups, amine groups, hydroxyl groups, carbonyl groups, or the like. Ionic groups can also participate in hydrogen bonding.

In an embodiment, the scaffold includes multiple reaction sites with orthogonal and reliable functional groups and with controlled stereochemistry. Suitable functional groups with orthogonal and reliable chemistries include, for example, carboxyl, amine, hydroxyl, phenol, carbonyl, and thiol groups, which can be individually protected, deprotected, and derivatized. In an embodiment, the scaffold has a number of functional groups with orthogonal and reliable chemistries, wherein the number of functional groups equals or exceeds the number of building blocks to be coupled to the scaffold. In an embodiment, the number of building blocks to be coupled exceeds the number of functional groups. In an embodiment, the scaffold has two, three, four, five, six, or more functional groups with orthogonal and reliable chemistries. In an embodiment, the scaffold has three functional groups. In such an embodiment, the three functional groups can be independently selected, for example, from carboxyl, amine, hydroxyl, phenol, carbonyl, or thiol group.

In an embodiment, a scaffold molecule forms or can be visualized as forming a covalent bond with an alcohol, phenol, thiol, amine, carbonyl, or like group on the linker or framework of each of a plurality of building blocks. The linker or framework can include a carboxyl, alcohol, phenol, thiol, amine, carbonyl, maleimide, or like group that can react with or be activated to react with the scaffold.

The scaffold can include a good leaving group bonded to, for example, an alkyl or aryl group. The leaving group being “good” enough to be displaced by the alcohol, phenol, thiol, amine, carbonyl, or like group on the framework or linker. Such a scaffold can include a moiety represented by the formula: R—X, in which X is a leaving group such as halogen (e.g., —Cl, —Br or —I), tosylate, mesylate, triflate, and R is alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or like moiety.

The scaffold can interact with the ligand as part of the artificial receptor. The scaffold can also provide bulk, hydrophobicity, hydrophilicity, flexibility, rigidity, and like structural characteristics to the artificial receptor. The scaffold can also control proximity, density, and orientation of the building blocks, as further described below.

A scaffold supports an artificial receptor including a combination of 2, 3, 4, 5, 6, 7, or more building blocks occupying distinct positions relative to one another on the scaffold. For example, building block 1 can be adjacent to any of building blocks 2, 3, or 4, etc. . . . This can be illustrated by considering the building blocks coupled to different functional groups on a scaffold. Scaffold positional isomer artificial receptors can be made, for example, on a scaffold with multiple functional groups that can be protected and deprotected by orthogonal chemistries. In an embodiment, the functional group at each reaction side is protected and deprotected by orthogonal chemistries. In an embodiment, a scaffold supports an artificial receptor including heterogeneous building blocks. In an embodiment, scaffolds can include functional groups for coupling to, for example, 2, 3, 4, 5, 6, or 7 building blocks.

In an embodiment, the region in which the building blocks are coupled to the scaffold comprises a reaction site (distinct position) for each building block. Each reaction site on the scaffold comprises a functional group suitable for coupling a building block. The number of distinct positions and relative spacing of the functional groups at the distinct positions can be used to select a scaffold based on desired characteristics of the artificial receptors. The scaffold can be selected to provide a density of building blocks sufficient to provide interactions of more than one building block with a ligand. In an embodiment, the scaffold can be selected to place the building blocks in proximity to one another on the scaffold. Evidence of proximity of different building blocks on a scaffold is provided by altered (e.g., tighter or looser) binding of a ligand to a scaffold with a plurality of building blocks compared to the scaffold with only one of the building blocks.

In an embodiment, the building blocks coupled to the scaffold are commonly oriented towards the potential ligand binding site. The orientation of the building blocks is partly controlled by the scaffold. For example, e.g., substituents on phenyl rings are equatorial, while substituents on cycloalkyls predictably transition between axial and equatorial positions. Less constrained systems, such as linear alkyls provide additional degrees of freedom (e.g. bond rotation) allowing a larger number of conformers. The effect on relative proximity and orientation of the distinct positions for coupling by the scaffold on building blocks is greatest for building blocks directly coupled to the scaffold. In an embodiment, a scaffold providing distinct positions for coupling (reaction sites) on a common face of the scaffold can be selected to assist in commonly orienting the building blocks. In an embodiment, a scaffold can provide reaction sites on both faces of a planar scaffold. Where the building block and scaffold are coupled via linkers, or flexible framework, there is less control over orientation of the building block and proximity of the building blocks is additionally controlled by the length and flexibility of the linker, framework and scaffold flexibility.

In an embodiment, the scaffold is flexible. In an embodiment, the scaffold is a substituted alkane. In the absence of rings, double bonds, and bulky substituent groups, the bonds within an alkyl chain will generally rotate, allowing an abundance of scaffold conformers. Additional examples of flexible scaffolds include substituted cyclohexane and other cycloalkanes (greater than C₅) or polycycloalkanes. The conformational mobility in cyclohexane and derivatives thereof has been extensively studied. A cyclohexane ring, dependent on the bulk of the substituents, transitions from chair₁ to boat to chair₂, thereby inverting the axial and equatorial positions. The flexibility in the ring allows for various conformations, thereby changing the proximity and orientation of the building blocks. In an embodiment, building blocks are preferably positioned on alternate carbons in cycloalkanes to allow concerted axial orientation.

In an embodiment, the scaffold can be a polyamine, for example, a cyclic alkyl molecule with a plurality of primary amine groups around the ring. Such a scaffold can include a plurality of building blocks coupled to the amines.

Aromatic ring systems, for example, substituted phenyl rings, substituted napthyl rings, or porphyrins (tetrapyroles, e.g, protoporphyrin IX, or Fe(II)heme), provide more rigid, generally planar scaffolds. In these systems, because substituents are preferably equatorially positioned in the plane of the ring(s), in an embodiment each building block is coupled to the scaffold via a flexible linker or framework of sufficient length and flexibility to allow the building blocks to reach and potentially bind a ligand positioned above or below the plane of the conjugated ring system.

In an embodiment, building blocks can be noncovalently coupled to a scaffold using hydrophobic interactions. For example, a scaffold derivatized with a plurality of hydrophobic groups, such as saturated C₁₈ chains, will associate with similar hydrophobic groups on one or more building blocks, thereby coupling the building blocks to the scaffold. In an embodiment, building blocks with lipophilic groups can be non-covalently coupled to large scaffolds, such as liposomes, micelles, dendrimers, and membranes.

In an embodiment, the scaffold includes a lipophilic moiety (e.g., a first lipophilic moiety). Suitable lipophilic moieties include branched or straight chain C₆₋₃₆ alkyl, C₈₋₂₄ alkyl, C₁₂₋₂₄ alkyl, C₁₂₋₁₈ alkyl, or the like; C₆₋₃₆ alkenyl, C₈₋₂₄ alkenyl, C₁₂₋₂₄ alkenyl, C₁₂₋₁₈ alkenyl, or the like, with, for example, 1 to 4 double bonds; C₆₋₃₆ alkynyl, C₈₋₂₄ alkynyl, C₁₂₋₂₄ alkynyl, C₁₂₋₁₈ alkynyl, or the like, with, for example, 1 to 4 triple bonds; chains with 1-4 double or triple bonds; chains including aryl or substituted aryl moieties (e.g., phenyl or naphthyl moieties at the end or middle of a chain); polyaromatic hydrocarbon moieties; cycloalkane or substituted alkane moieties with numbers of carbons as described for chains; combinations or mixtures thereof; or the like. The alkyl, alkenyl, or alkynyl group can include branching; within chain functionality like an ether group; terminal functionality like alcohol, amide, carboxylate or the like; or the like. A lipophilic moiety like a quaternary ammonium lipophilic moiety can also include a positive charge.

In an embodiment, one or more building blocks can be coupled to the scaffold utilizing host-guest interactions. In an embodiment, a scaffold comprises a host moiety and the building block comprises a corresponding guest moiety. In an embodiment, a building block comprises a host moiety and the scaffold comprises a corresponding guest moiety. Examples of host-guest pairs include: crown ethers which complex positive ions (metallic, ammonium or substituted ammonium); Other hosts with binding similar to crown ethers include: macrocyclic and bicyclic compounds containing nitrogen or sulfur or more than one kind of hetero atom (also called cryptands); pherands, calixarenes, cryptophanes, hemispherands, podands, lariat ethers and starands. (Smith, B. and March, J., (2001) “March's Advanced Organic Chemistry.” 5th Ed., John Wiley & Sons, Inc.) The strongest host-guest interactions occur when combination of the guest with the host causes the least amount of distortion of the host. Cyclodextrins are also host molecules that form channel or cage complexes with an internalized guest by Van der Waals forces. Suitable guests are for example nonpolar organic molecules matched in size to the internal space in the cyclodextrin.

In an embodiment, the scaffold can be selected for properties affecting solubility, such as hydrophobicity or hydrophilicity. In an embodiment, a scaffold artificial receptor is soluble in solution, for example aqueous solution. In an embodiment, the solubility of the scaffold is selected for the solution conditions where ligand binding to the artificial receptor is desired. In an embodiment utilizing aqueous solutions, selection of a scaffold with hydrophilic properties is preferred for a soluble scaffold artificial receptor. In an embodiment, a scaffold with hydrophobic properties can be selected if association of the scaffold with a hydrophobic environment is desired. For example a hydrophobic scaffold may encourage aggregation in aqueous solution, association with a lipid bilayer or micelle, or solubility in a non-polar solvent.

In an embodiment, the scaffold molecule can be any of the variety of known molecular scaffolds employed in combinatorial research. Suitable scaffold molecules include those illustrated in Scheme 6. The compounds illustrated in Scheme 6 are either commercially available or can be made by known methods. For example, compounds 1, 2, 4, 5, and 12 are commercially available from Aldrich. Compound 3 can be prepared by the method of Pattarawarapan (2000) (Pattarawarapan, M and Burgess, K, “A Linker Scaffold to Present Dimers of Pharmacophores Prepared by Solid-Phase Synthesis”, Angew. Chem. Int. Ed., 39, 4299-4301 (2000)). Compound 6 can be made in the o-NH₂ form (shown) by the method of Kimura (2001) (Kimura, M; Shiba, T; Yamazaki, M; Hanabusa, K; Shirai, H and Kobayashi, N, “Construction of Regulated Nanospace around a Porphyrin Core”, J. Am. Chem. Soc., 123, 5636-5642 (2001)) and in the p-COOH (not shown) by the method of Jain (2000) (Jain, R K; Hamilton, A D (2000), “Protein Surface Recognition by Synthetic Receptors Based on a Tetraphenylporphyrin Scaffold”, Org. Lett. 2, pp. 1721-1723). Compound 7 can be made in the —COOH form (shown) or in the —OH form (not shown) by the method of Hamuro (1997) (Hamuro, Y. et al., (Andrew Hamilton), “A Calixarene with four Peptide Loops: An Antibody Mimic for Recognition of Protein Surfaces”, Angew. Chem. Int. Ed. Engl., 36, pp. 2680-2683). Compound 8 can be used with three functional groups in the —NH₂ form (shown), with four functional groups including both the —COOH and —NH₂ groups (as shown), or as a dimer product with 6-NH₂ functional groups (not shown). Each of these forms of compound 8 can be made by the method of Opatz (2001) (Opatz, T; Liskamp, R M (2001), “A Selectively Deprotectable Triazacyclophane Scaffold for the Construction of Artificial Receptors”, Org. Lett., 3, pp. 3499-3502). Compound 9 can be made by the method of Wong (1988) (Wong, C-H, Hendrix, M, Manning, D D, Rosenbohm, C, Greenberg, W A, (1988), “A Library approach to the discovery of small molecules that recognize RNA: use of a 1,3-hydroxyamine motif as core.”, J. Am. Chem. Soc., 120:8319-8327. Compound 10 is a xanthene tetraisocyanate scaffold, which can be made by the method of Shipps (1997) (Shipps, G W, Pryor K E, Xian J, Skyler D A, Davidson E H, Rebek J, “Synthesis and screening of small molecule libraries active in binding to DNA.” Proc. Natl. Acad. Sci. USA, (1997), 94:11833-11838). A derivatized calixarene scaffold, such as compound 11, is readily synthesized from commercially available calixarene. (Park H S, Lin Q, Hamilton A D, “Protein surface recognition by synthetic receptors: a route to novel submicromolar inhibitors for chymotrypsin.” (1999) J. Am. Chem. Soc., 121:8-13).

For general discussion of scaffolds and further examples, see Srinivasan, N and Kilburn, J D, (2004) “Combinatorial Approaches to Synthetic Receptors”, Cur. Op. Chem. Bio., 8:305-310; and Linton, B and Hamilton, D, (1999) “Host-guest Chemistry: Combinatorial Receptors,” Curr. Op. Str. Biol., 3:307-312. 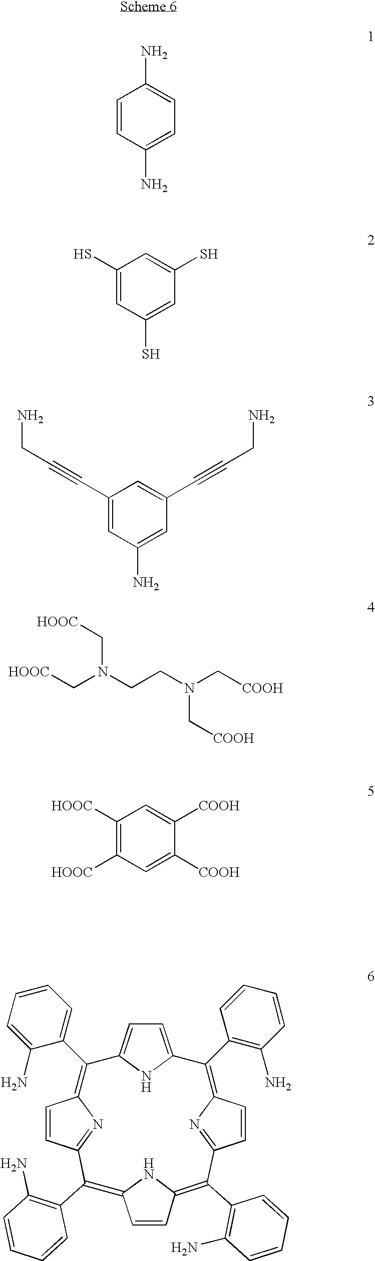 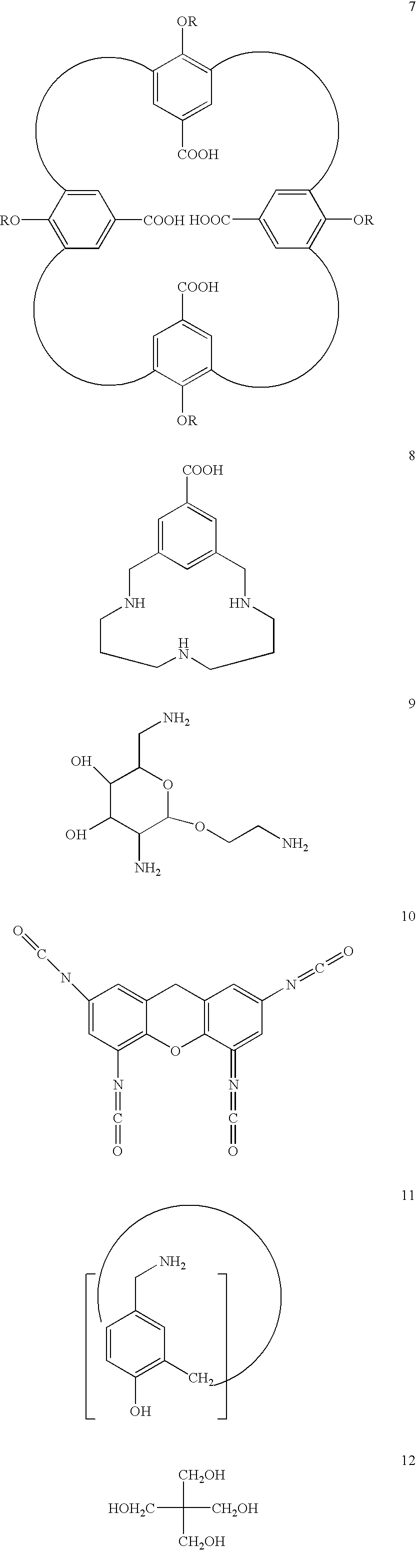
Techniques for Using Artificial Receptors

In an embodiment, the scaffold artificial receptors are in solution. The solution is a homogeneous mixture at the molecular or ionic level, of one or more substances, including scaffold artificial receptors (solute(s)), in one or more other substances (solvent(s)). Solvents can be a substance or mixture that is able to dissolve the solute(s). Solvents are typically liquid and possess polarity characteristics from polar (e.g., water) to non-polar (e.g., hydrocarbon solvents). Various general examples include: water (aqueous), alcohols, esters, ethers, ketones, amines, aromatic hydrocarbons, aliphatic hydrocarbons, and nitrated and chlorinated hydrocarbons. Mixtures of miscible solvents may also be used as solvent for solutions including scaffold artificial receptors.

In an embodiment, the solution can include additional solvents and/or solutes to improve solubility of the scaffold artificial receptors. Example additives can include: surfactants, hydrotropes, salts, acids/bases and co-solvents. Interaction of the scaffold artificial receptors in solution may also be altered by additional solvents and/or solutes. For example, to adjust pH, adjust ionic strength, discourage aggregation, prevent precipitation, or discourage/encourage colloid formation.

In an embodiment, the solution is similar in nature to the desired binding environment of ligand to scaffold artifical receptor. The solution can include additional components, including for example: proteins, cells, ions, sugars, etc. . . . For example, for a scaffold articial receptor that binds glucose in blood, either blood or a solution emulating blood can be used. In an embodiment, the scaffold artifical receptors are in an aqueous solution and can include additional solvent or solute components.

In an embodiment, the solution is isolated in a location. A location holds a quantity of solution, where the quantity of solution can comprise one or more scaffold artificial receptors. A location can include: one of a plurality of drops spaced on a support, such as a plate or slide; one of a plurality of pits on a compact disc (CD); or one of a plurality of compartments, on a multi-compartment support, such as a multi-well plate. In an embodiment, a quantity of solution at each location can be about 1 nanoliter (nL) to about 1 microliter (μL).

In an embodiment, the solution at each location comprises a pluralty of homogeneous scaffold artificial receptors. In an embodiment, the solution at each location comprises a pluralty of heterogeneous scaffold artificial receptors. In an embodiment, the solution at each location comprises a single homogeneous scaffold artificial receptor. In an embodiment, the solution at each location comprises a single of heterogeneous scaffold artificial receptor.

The present invention includes a method of using artificial receptors. The present invention includes a method of screening candidate artificial receptors to find lead artificial receptors that bind a particular test ligand. Detecting test ligand bound to a candidate artificial receptor can be accomplished using known methods for detecting binding. For example, the method can employ test ligand labeled with a detectable label, such as a fluorophore or an enzyme that produces a detectable product. Alternatively, the method can employ an antibody (or other binding agent) specific for the test ligand and including a detectable label. In an embodiment, the scaffold artificial receptors in solution are in locations on a support. Each location may include one or more scaffold artificial receptors. The particular test ligand is added to each location. One or more of the locations that are labeled by the test ligand or that are more or most intensely labeled with the test ligand are selected as lead artificial receptors. The degree of labeling can be evaluated by evaluating the signal strength from the label. The amount of signal can be directly proportional to the amount of label and binding.

In an embodiment, the scaffold artificial receptor is made by coupling the building blocks to a scaffold in solution in a location on a support. The scaffold artificial receptors at each location can vary in identity of the building blocks and/or identity of the scaffold. Each location contains a different population of scaffold artificial receptors. The population of scaffold artificial receptors can be zero (e.g., a control), one, and greater than one, to an upper limit dependent on saturation of the solution. In an embodiment, the population is less than 1M. In an embodiment, the population is less than 1 μM. In an embodiment, the population is less than 1 nM. In an embodiment, the population is less than 1 pM. In a further embodiment, the artificial receptor is screened for ligand binding in the locations on a support.

According to the present method, screening candidate artificial receptors against a test ligand can yield one or more lead artificial receptors. One or more lead artificial receptors can be a working artificial receptor. That is, the one or more lead artificial receptors can be useful for detecting the ligand of interest as is. The method can then employ the one or more artificial receptors as a working artificial receptor for monitoring or detecting the test ligand. Alternatively, the one or more lead artificial receptors can be employed in the method for developing a working artificial receptor. For example, the one or more lead artificial receptors can provide structural or other information useful for designing or screening for an improved lead artificial receptor or a working artificial receptor. Such designing or screening can include making and testing additional candidate artificial receptors including combinations of a subset of building blocks, a different set of building blocks, or a different number of building blocks.

The present invention includes a method of screening candidate artificial receptors to find lead artificial receptors that bind a particular test ligand. The method can include allowing movement of the building blocks that make up the artificial receptors. Movement of building blocks can include mobilizing the building block to move along or on the scaffold and/or to leave the scaffold and enter a fluid (e.g., liquid) phase separate from the scaffold or lawn.

In an embodiment, building blocks can be mobilized to move along or on the scaffold (translate or shuffle). Such translation can be employed, for example, to allow building blocks already bound to a test ligand to rearrange into a lower energy or tighter binding configuration still bound to the test ligand. Such translation can be employed, for example, to allow the ligand access to building blocks that are on the scaffold but not bound to the ligand. These building blocks can translate into proximity with and bind to a test ligand.

Building blocks can be induced to move along or on the scaffold or to be reversibly immobilized on the scaffold through any of a variety of mechanisms. For example, inducing mobility of building blocks can include altering the conditions of the scaffold or lawn. That is, altering the conditions can reverse the immobilization of the building blocks, thus mobilizing them. Reversibly immobilizing the building blocks after they have moved can include, for example, returning to the previous conditions. Suitable alterations of conditions include changing pH, changing temperature, changing polarity or hydrophobicity, changing ionic strength, changing nucleophilicity or electrophilicity (e.g. of solvent or solute), and the like.

A building block reversibly immobilized by hydrophobic interactions can be mobilized by increasing the temperature, by exposing the scaffold, or building block to a more hydrophobic solvent (e.g., an organic solvent or a surfactant), or by reducing ionic strength around the building block. In an embodiment, the organic solvent includes acetonitrile, acetic acid, an alcohol, tetrahydrofuran (THF), dimethylformamide (DMF), hydrocarbons such as hexane or octane, acetone, chloroform, methylene chloride, or the like, or mixture thereof. In an embodiment, the surfactant includes a nonionic surfactant, such as a nonylphenol ethoxylate, or the like. A building block that is mobile on a scaffold can be reversibly immobilized by hydrophobic interactions, for example, by decreasing the temperature, exposing the scaffold, or building block to a more hydrophilic solvent (e.g., an aqueous solvent) or increased ionic strength.

A building block reversibly immobilized by hydrogen bonding can be mobilized by increasing the ionic strength, concentration of hydrophilic solvent, or concentration of a competing hydrogen bonder in the environs of the building block. A building block that is mobile on a scaffold can be reversibly immobilized through an electrostatic interaction by decreasing ionic strength of the hydrophilic solvent, or the like.

A building block reversibly immobilized by an electrostatic interaction can be mobilized by increasing the ionic strength in the environs of the building block. Increasing ionic strength can disrupt electrostatic interactions. A building block that is mobile on a scaffold can be reversibly immobilized through an electrostatic interaction by decreasing ionic strength.

A building block reversibly immobilized by an imine, acetal, or ketal bond can be mobilized by decreasing the pH or increasing concentration of a nucleophilic catalyst in the environs of the building block. In an embodiment, the pH is about 1 to about 4. Imines, acetals, and ketals undergo acid catalyzed hydrolysis. A building block that is mobile on a scaffold can be reversibly immobilized by a reversible covalent interaction, such as by forming an imine, acetal, or ketal bond, by increasing the pH.

In an embodiment, building blocks can be mobilized to leave the scaffold and enter a fluid (e.g., liquid) phase separate from the scaffold (exchange). For example, building blocks can be exchanged onto and/or off of the scaffold. Exchange can be employed, for example, to allow building blocks on a scaffold but not bound to a test ligand to be removed from the scaffold. Exchange can be employed, for example, to add additional building blocks to the scaffold. The added building blocks can have structures selected based on knowledge of the structures of the building blocks in artificial receptors that bind the test ligand. The added building blocks can have structures selected to provide additional structural diversity. The added building blocks can include all of the building blocks.

A building block reversibly immobilized by hydrophobic interactions can be released from the scaffold by, for example, raising the temperature, e.g., of the scaffold and/or artificial receptor. For example, the hydrophobic interactions (e.g., the hydrophobic group on the scaffold and on the building block) can be selected to provide immobilized building block at about room temperature or below and release can be accomplished at a temperature above room temperature. For example, the hydrophobic interactions can be selected to provide immobilized building block at about refrigerator temperature (e.g., 4° C.) or below and release can be accomplished at a temperature of, for example, room temperature or above. By way of further example, a building block can be reversibly immobilized by hydrophobic interactions, for example, by contacting the surface or artificial receptor with a fluid containing the building block and that is at or below room temperature.

A building block reversibly immobilized by hydrophobic interactions can be released from the scaffold by, for example, contacting the artificial receptor with a sufficiently hydrophobic fluid (e.g., an organic solvent or a surfactant). In an embodiment, the organic solvent includes acetonitrile, acetic acid, an alcohol, tetrahydrofuran (THF), dimethylformamide (DMF), hydrocarbons such as hexane or octane, acetone, chloroform, methylene chloride, or the like, or mixture thereof. In an embodiment, the surfactant includes a nonionic surfactant, such as a nonylphenol ethoxylate, or the like.

A building block reversibly immobilized by an imine, acetal, or ketal bond can be released from the scaffold by, for example, contacting the artificial receptor with fluid having an acid pH or including a nucleophilic catalyst. In an embodiment, the pH is about 1 to about 4. A building block can be reversibly immobilized by a reversible covalent interaction, such as by forming an imine, acetal, or ketal bond, by contacting the surface or artificial receptor with fluid having a neutral or basic pH.

A building block reversibly immobilized by an electrostatic interaction can be released by, for example, contacting the artificial receptor with fluid having sufficiently high ionic strength to disrupt the electrostatic interaction. A building block can be reversibly immobilized through an electrostatic interaction by contacting the surface or artificial receptor with fluid having ionic strength that promotes electrostatic interaction between the building block and the scaffold and/or lawn.

The above specification, examples and data provide a complete description of the manufacture and use of the composition of the invention. Since many embodiments of the invention can be made without departing from the spirit and scope of the invention, the invention resides in the claims hereinafter appended.

### EXAMPLES

### Example 1

### Synthesis of Building Blocks

Selected building blocks representative of the alkyl-aromatic-polar span of the an embodiment of the building blocks were synthesized and demonstrated effectiveness of these building blocks for making candidate artificial receptors. These building blocks were made on a framework that can be represented by tyrosine and included numerous recognition element pairs. These recognition element pairs include enough of the range from alkyl, to aromatic, to polar to represent a significant degree of the interactions and functional groups of the full set of 81 such building blocks.

Synthesis

Building block synthesis employed a general procedure outlined in Scheme 7, which specifically illustrates synthesis of a building block on a tyrosine framework with recognition element pair A4B4. This general procedure was employed for synthesis of building blocks including TyrA1B1 [1-1], TyrA2B2, TyrA2B4, TyrA2B6, TyrA2B8, TyrA4B2, TyrA4B4, TyrA4B6, TyrA4B8, TyrA6B2, TyrA6B4, TyrA6B6, TyrA6B8, TyrA8B2, TyrA8B4, TyrA8B6, TyrA8B8, and TyrA9B9, respectively. 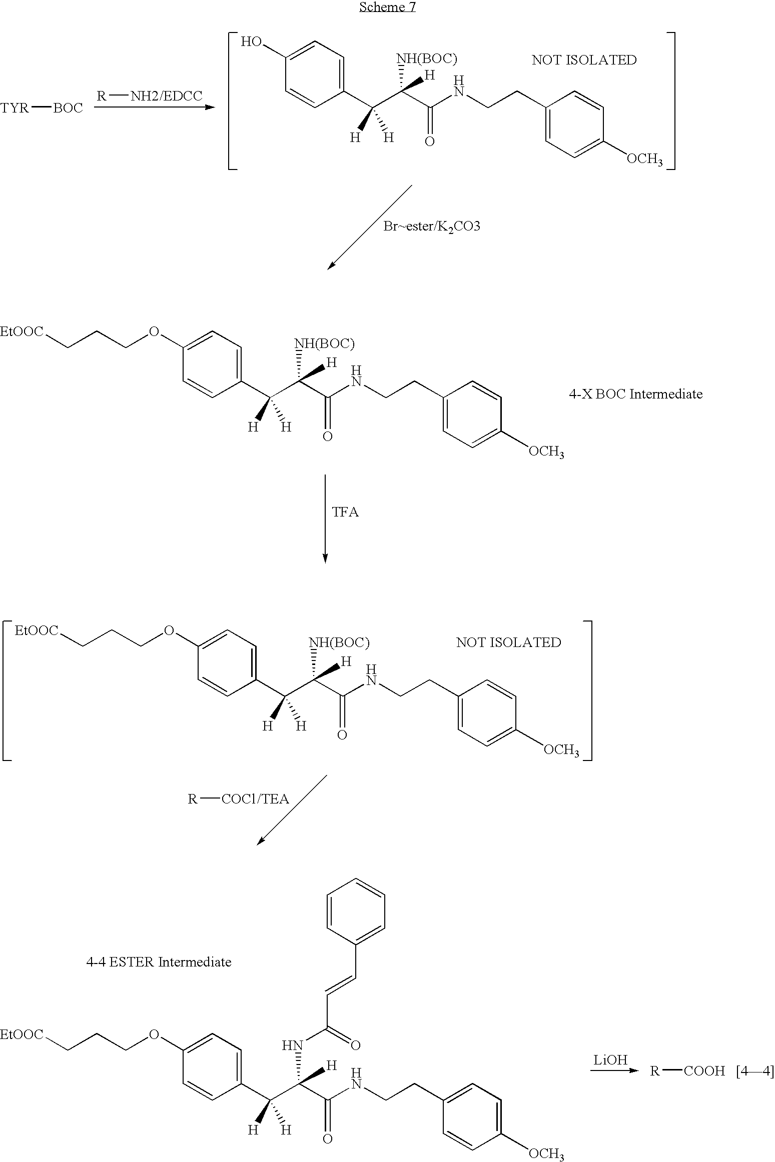
Results

Synthesis of the desired building blocks proved to be generally straightforward. These syntheses illustrate the relative simplicity of preparing the building blocks with 2 recognition elements having different structural characteristics or structures (e.g. A4B2, A6B3, etc.) once the building blocks with corresponding recognition elements (e.g. A2B2, A4B4, etc) have been prepared via their X BOC intermediate.

The conversion of one of these building blocks to a building block with a lipophilic linker can be accomplished by reacting the activated building block with, for example, dodecyl amine.

### Example 2

### Preparation and Evaluation of Microarrays of Candidate Artificial Receptors

Microarrays of candidate artificial receptors were made and evaluated for binding several protein ligands. The results obtained demonstrate the 1) the simplicity with which microarrays of candidate artificial receptors can be prepared, 2) binding affinity and binding pattern reproducibility, 3) significantly improved binding for building block heterogeneous receptor environments when compared to the respective homogeneous controls, and 4) ligand distinctive binding patterns (e.g., working receptor complexes).

Materials and Methods

Building blocks were synthesized and activated as described in Example 1. The building blocks employed in this example were TyrA1B1 [1-1], TyrA2B2, TyrA2B4, TyrA2B6, TyrA4B2, TyrA4B4, TyrA4B6, TyrA6B2, TyrA6B4, and TyrA6B6. The abbreviation for the building block including a linker, a tyrosine framework, and recognition elements AxBy is TyrAxBy.

Microarrays for the evaluation of the 130 n=2 and n=3, and for evaluation of the 273 n=2, n=3, and n=4, candidate receptor environments were prepared as follows by modifications of known methods. As used herein, “n” is the number of different building blocks employed in a receptor environment. Briefly: Amine modified (amine “lawn”; SuperAmine Microarray plates) microarray plates were purchased from Telechem Inc., Sunnyvale, Calif. (www.arrayit.com). These plates were manufactured specifically for microarray preparation and had a nominal amine load of 2-4 amines per square nm according to the manufacturer. The CAM microarrays were prepared using a pin microarray spotter instrument from Telechem Inc. (SpotBot™ Arrayer) typically with 200 um diameter spotting pins from Telechem Inc. (Stealth Micro Spotting Pins, SMP6) and 400-420 um spot spacing.

The 9 building blocks were activated in aqueous dimethylformamide (DMF) solution as described above. For preparing the 384-well feed plate, the activated building block solutions were diluted 10-fold with a solution of DMF/H₂O/PEG400 (90/10/10, v/v/v; PEG400 is polyethylene glycol nominal 400 FW, Aldrich Chemical Co., Milwaukee, Wis.). These stock solutions were aliquotted (10 μl per aliquot) into the wells of a 384-well microwell plate (Telechem Inc.). A separate series of controls were prepared by aliquotting 10 μl of building block with either 10 μl or 20 μl of the activated [1-1] solution. The plate was covered with aluminum foil and placed on the bed of a rotary shaker for 15 minutes at 1,000 RPM. This master plate was stored covered with aluminum foil at −20° C. when not in use.

For preparing the 384-well SpotBot™ plate, a well-to-well transfer (e.g. A-1 to A-1, A-2 to A-2, etc.) from the feed plate to a second 384-well plate was performed using a 4 μl transfer pipette. This plate was stored tightly covered with aluminum foil at −20° C. when not in use. The SpotBot™ was used to prepare up to 13 microarray plates per run using the 4 μl microwell plate. The SpotBot™ was programmed to spot from each microwell in quadruplicate. The wash station on the SpotBot™ used a wash solution of EtOH/H₂O (20/80, v/v). This wash solution was also used to rinse the microarrays on completion of the SpotBot™ printing run. The plates were given a final rinse with deionized (DI) water, dried using a stream of compressed air, and stored at room temperature.

Certain of the microarrays were further modified by reacting the remaining amines with succinic anhydride to form a carboxylate lawn in place of the amine lawn.

The following test ligands and labels were used in these experiments:

1) r-Phycoerythrin, a commercially available and intrinsically fluorescent protein with a FW of 2,000,000.

2) Ovalbumin labeled with the Alexa™ fluorophore (Molecular Probes Inc., Eugene, Oreg.).

3) BSA, bovine serum albumin, labeled with activated Rhodamine (Pierce Chemical, Rockford, Ill.) using the known activated carboxylprotocol. BSA has a FW of 68,000; the material used for this study had ca. 1.0 rhodamine per BSA.

4) Horseradish peroxidase (HRP) modified with extra amines and labeled as the acetamide derivative or with a 2,3,7,8-tetrachlorodibenzodixoin derivative were available through known methods. Fluorescence detection of these HRP conjugates was based on the Alexa 647-tyramide kit available from Molecular Probes, Eugene, Oreg.

5) Cholera toxin labeled with the Alexa™ fluorophore (Molecular Probes Inc., Eugene, Oreg.).

Microarray incubation and analysis was conducted as follows: For test ligand incubation with the microarrays, solutions (e.g. 500 μl) of the target proteins in PBS-T (PBS with 20 μl/L of Tween-20) at typical concentrations of 10, 1.0 and 0.1 μg/ml were placed onto the surface of a microarray and allowed to react for, e.g., 30 minutes. The microarray was rinsed with PBS-T and DI water and dried using a stream of compressed air.

The incubated microarray was scanned using an Axon Model 4200A Fluorescence Microarray Scanner (Axon Instruments, Union City, Calif.). The Axon scanner and its associated software produce a false color 16-bit image of the fluorescence intensity of the plate. This 16-bit data is integrated using the Axon software to give a Fluorescence Units value (range 0-65,536) for each spot on the microarray. This data is then exported into an Excel file (Microsoft) for further analysis including mean, standard deviation and coefficient of variation calculations.

Results

The CARA™: Combinatorial Artificial Receptor Array™ concept has been demonstrated using a microarray format. A CARA microarray based on N=9 building blocks was prepared and evaluated for binding to several protein and substituted protein ligands. This microarray included 144 candidate receptors (18 n=1 controls plus 6 blanks; 36 n=2 candidate receptors; 84 n=3 candidate receptors). This microarray demonstrated: 1) the simplicity of CARA microarray preparation, 2) binding affinity and binding pattern reproducibility, 3) significantly improved binding for building block heterogeneous receptor environments when compared to the respective homogeneous controls, and 4) ligand distinctive binding patterns.

Reading the Arrays

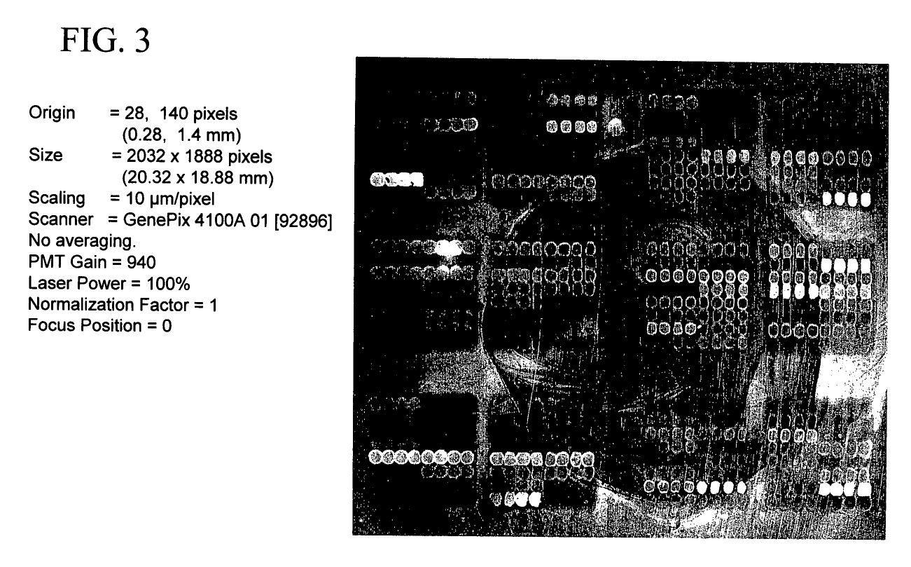

A typical false color/gray scale image of a microarray that was incubated with 2.0 μg/ml r-phycoerythrin is shown in FIG. 3. This image illustrates that the processes of both preparing the microarray and probing it with a protein test ligand produced the expected range of binding as seen in the visual range of relative fluorescence from dark to bright spots.

The starting point in analysis of the data was to take the integrated fluorescence units data for the array of spots and normalize to the observed value for the [1-1] building block control. Subsequent analysis included mean, standard deviation and coefficient of variation calculations. Additionally, control values for homogeneous building blocks were obtained from the building block plus [1-1] data.

First Set of Experiments

The following protein ligands were evaluated for binding to the candidate artificial receptors in the microarray. The resulting Fluorescence Units versus candidate receptor environment data is presented in both a 2D format where the candidate receptors are placed along the X-axis and the Fluorescence Units are shown on the Y-axis and a 3D format where the Candidate Receptors are placed in an X-Y format and the Fluorescence Units are shown on the Z-axis. A key for the composition of each spot was developed (not shown). A key for the building blocks in each of the 2D and 3D representations of the results was also developed (not shown). The data presented are for 1-2 μg/ml protein concentrations.

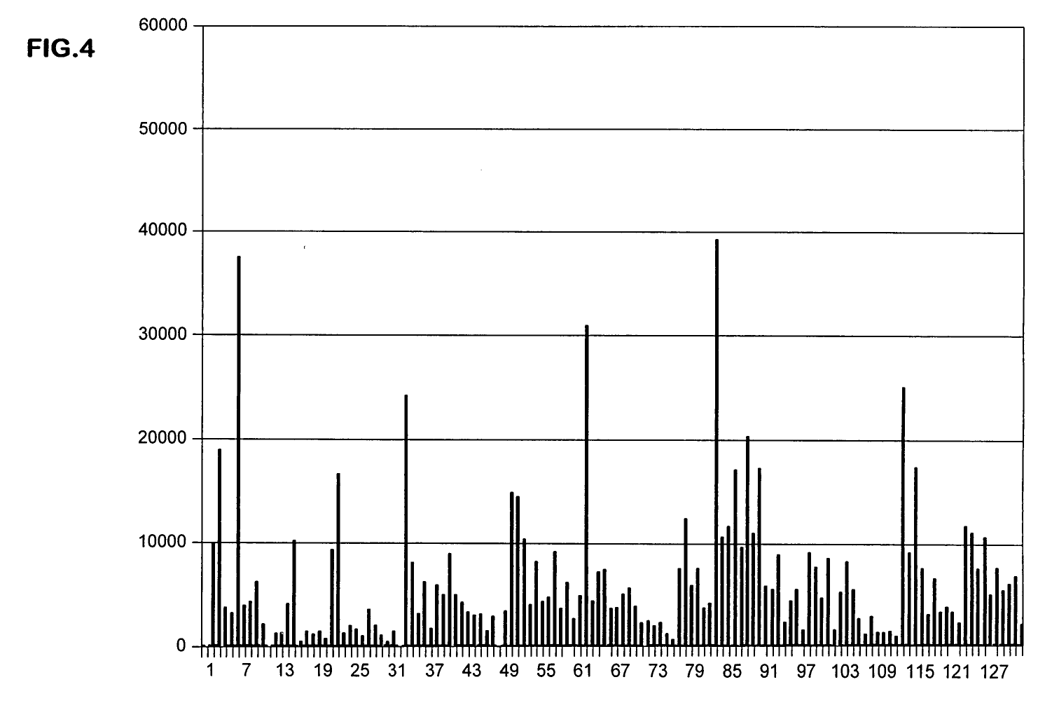

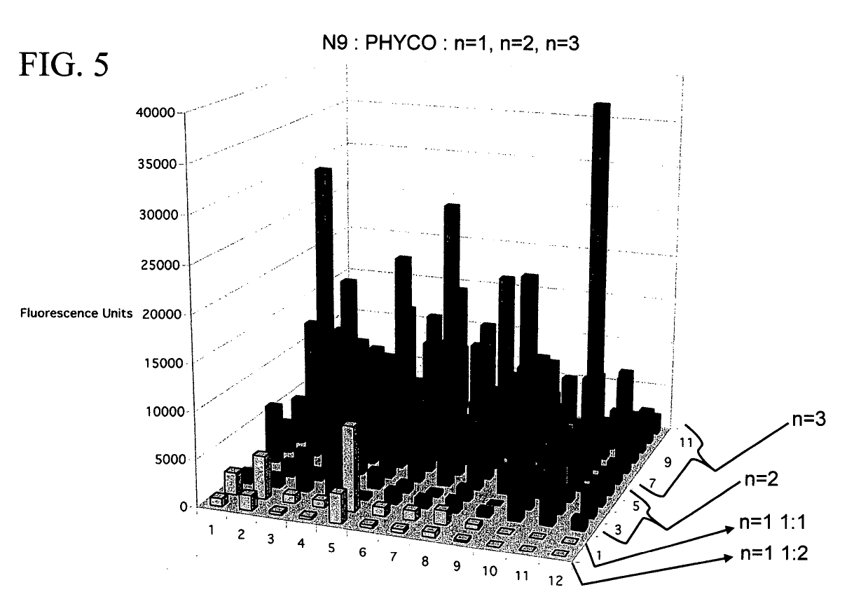

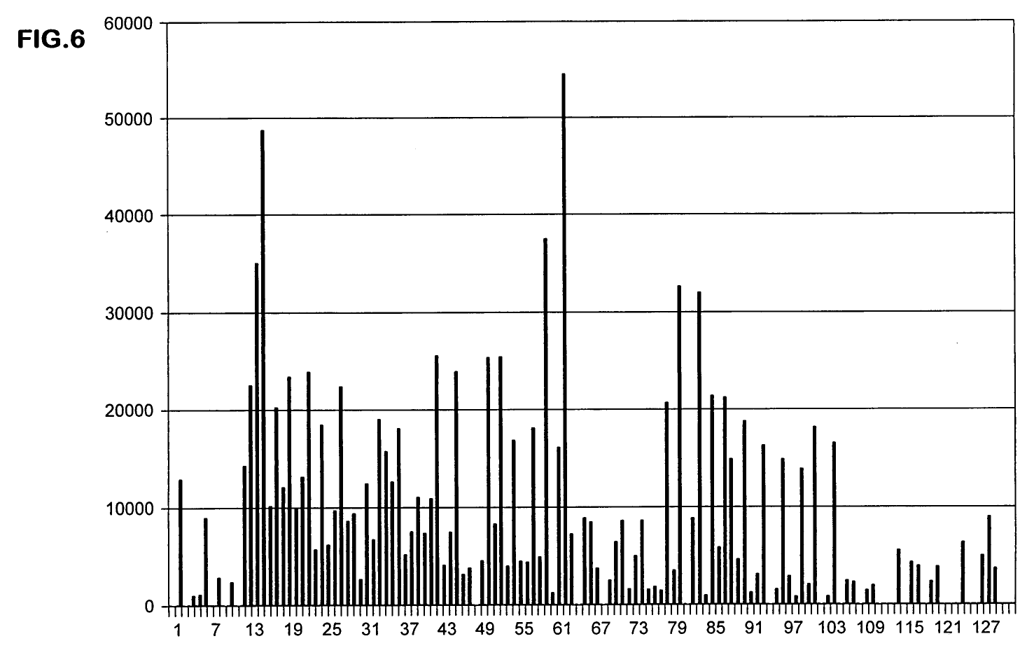

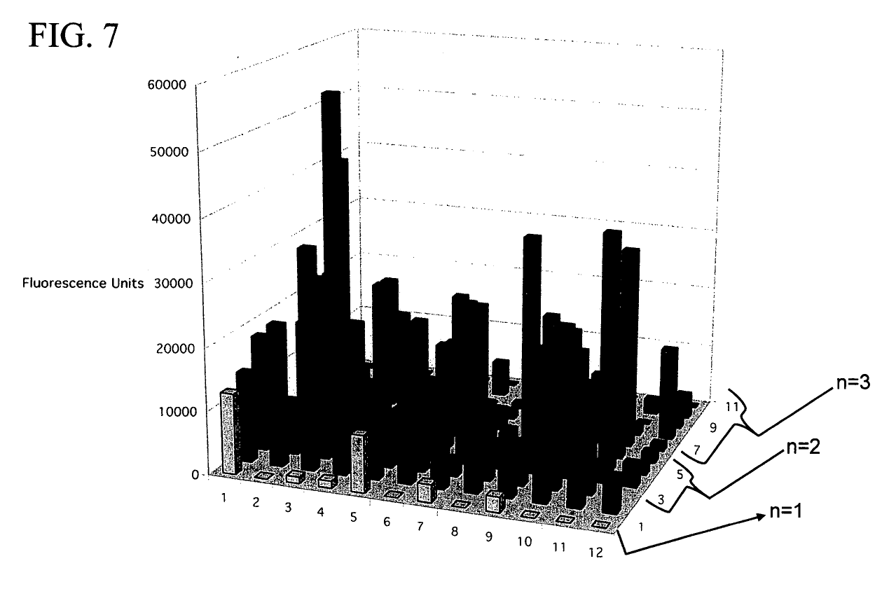

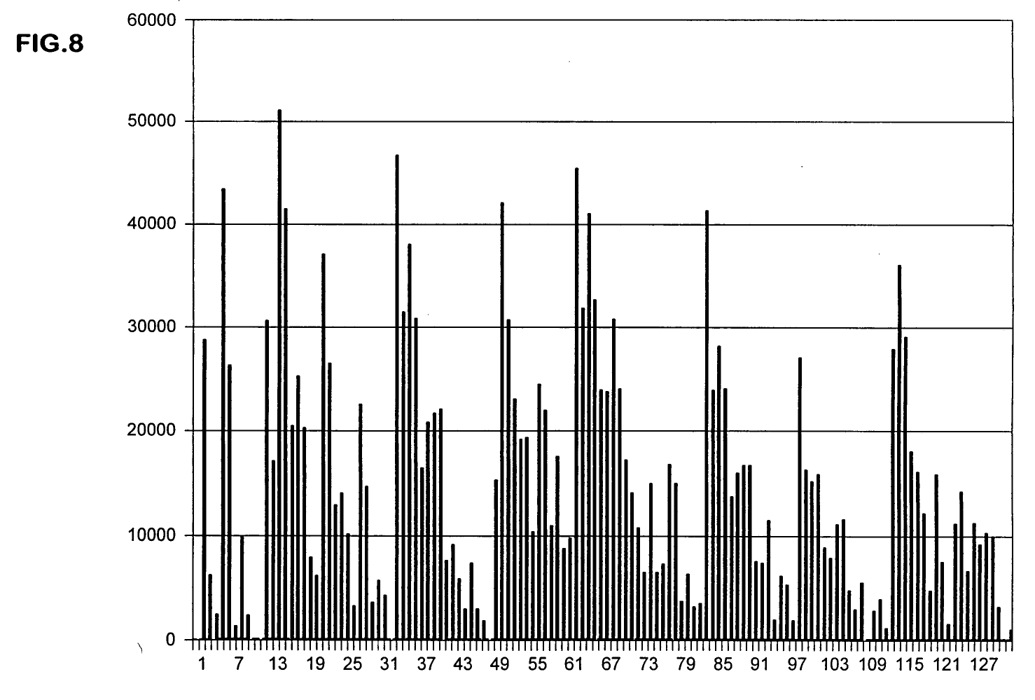

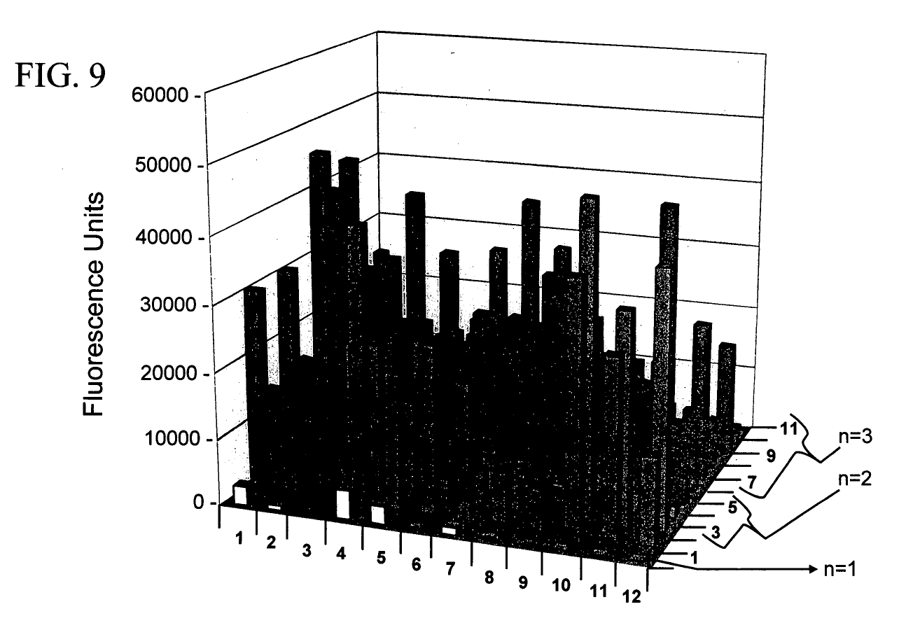

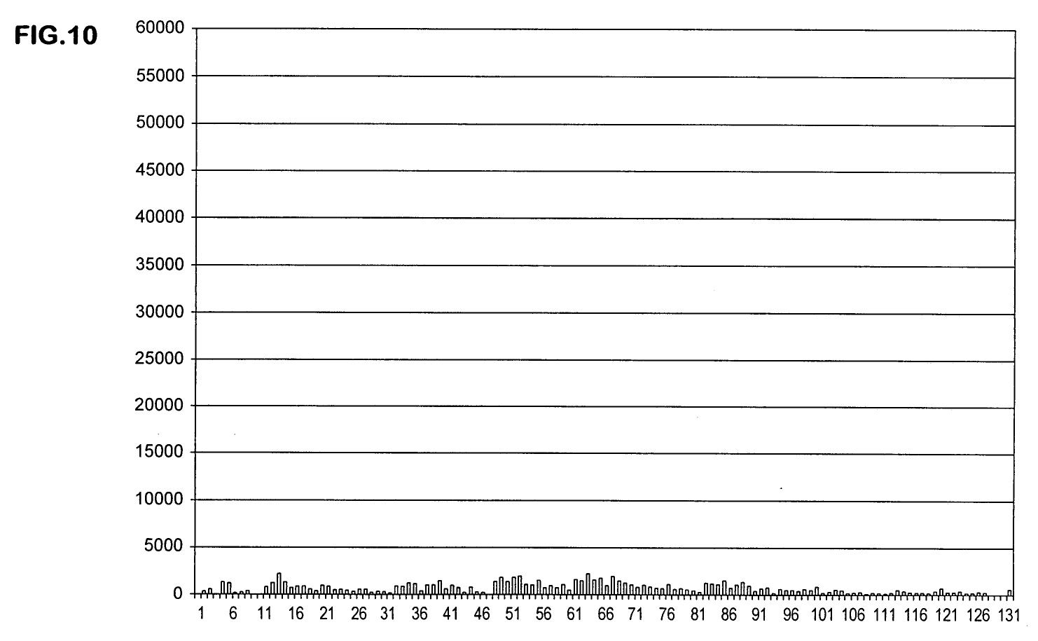

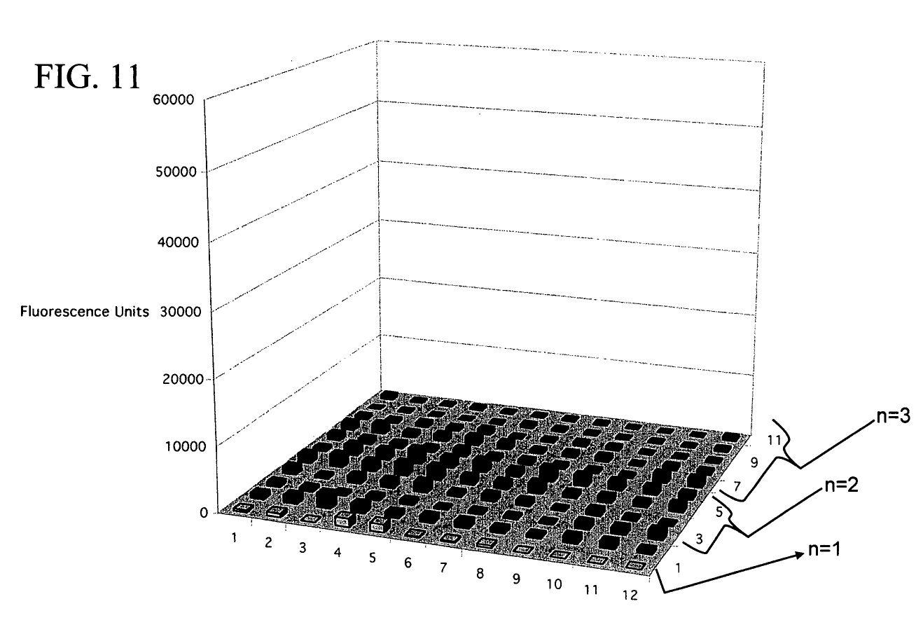

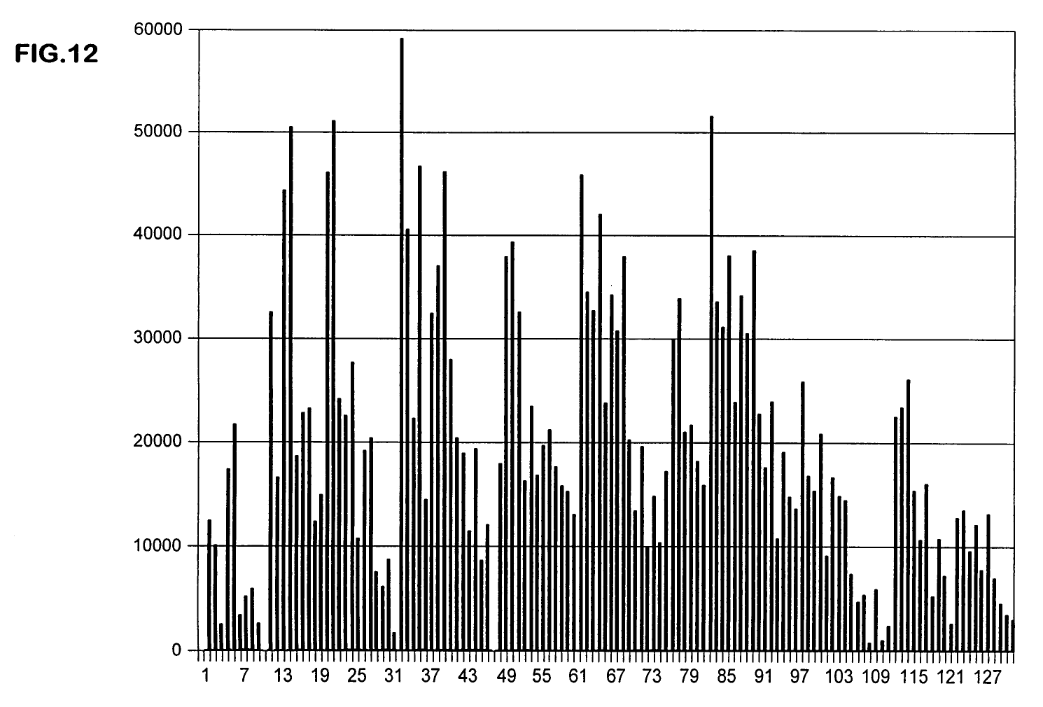

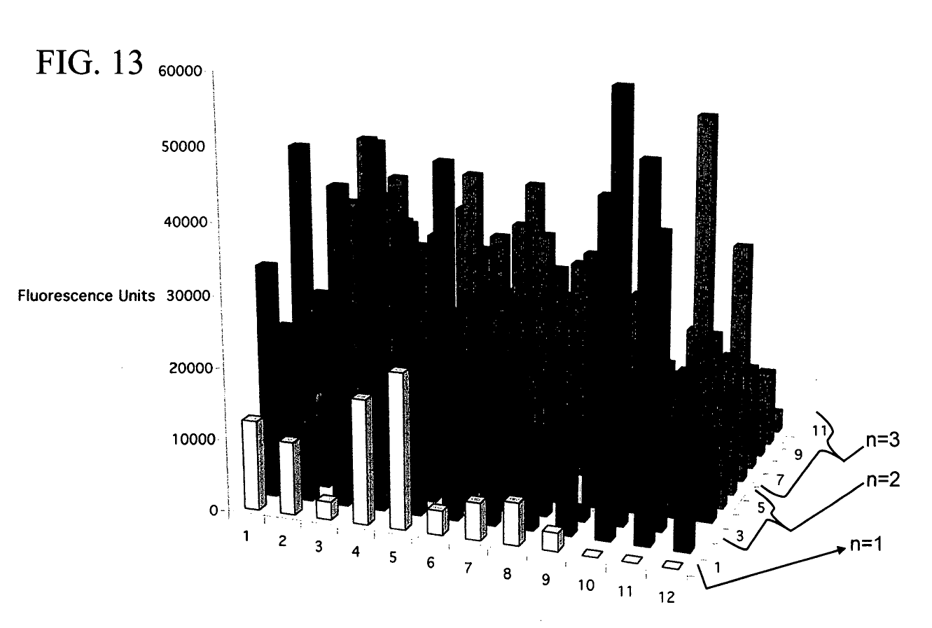

FIGS. 4 and 5 illustrate binding data for r-phycoerythrin (intrinsic fluorescence). FIGS. 6 and 7 illustrate binding data for ovalbumin (commercially available with fluorescence label). FIGS. 8 and 9 illustrate binding data for bovine serum albumin (labeled with rhodamine). FIGS. 10 and 11 illustrate binding data for HRP-NH-Ac (fluorescent tyramide read-out). FIGS. 12 and 13 illustrate binding data for HRP-NH-TCDD (fluorescent tyramide read-out).

These results demonstrate not only the application of the CARA microarray to candidate artificial receptor evaluation but also a few of the many read-out methods (e.g. intrinsic fluorescence, fluorescently labeled, in situ fluorescence labeling) which can be utilized for high throughput candidate receptor evaluation.

The evaluation of candidate receptors benefits from reproducibility. The following results demonstrate that the present microarrays provided reproducible ligand binding.

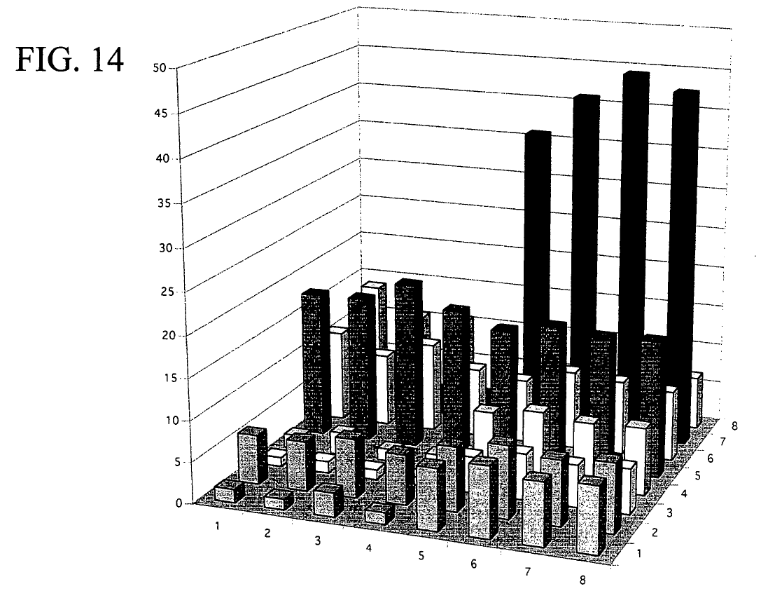

The microarrays were printed with each combination of building blocks spotted in quadruplicate. Visual inspection of a direct plot (FIG. 14) of the raw fluorescence data (from the run illustrated in FIG. 3) for one block of binding data obtained for r-phycoerythrin demonstrates that the candidate receptor environment “spots” showed reproducible binding to the test ligand. Further analysis of the r-phycoerythrin data (FIG. 3) led to only 9 out of 768 spots (1.2%) being deleted as outliers. Analysis of the r-phycoerythrin quadruplicate data for the entire array gives a mean standard deviation for each experimental quadruplicate set of 938 fluorescence units, with a mean coefficient of variation of 19.8%.

Although these values are acceptable, a more realistic comparison employed the standard deviation and coefficient of variation of the more strongly bound, more fluorescent receptors. The overall mean standard deviation unrealistically inflates the coefficient of variation for the weakly bound, less fluorescent receptors. The coefficient of variation for the 19 receptors with greater than 10,000 Fluorescent Units of bound target is 11.1%, which is well within the range required to produce meaningful binding data.

One goal of the CARA approach is the facile preparation of a significant number of candidate receptors through combinations of structurally simple building blocks. The following results establish that both the individual building blocks and combinations of building blocks have a significant, positive effect on test ligand binding.

The binding data illustrated in FIGS. 12-13 demonstrate that heterogeneous combinations of building blocks (n=2, n=3) are dramatically superior candidate receptors made from a single building block (n=1). For example, FIG. 5 illustrates both the diversity of binding observed for n=2, n=3 candidate receptors with fluorescent units ranging from 0 to ca. 40,000. These data also illustrate and the ca. 10-fold improvement in binding affinity obtained upon going from the homogeneous (n=1) to heterogeneous (n=2, n=3) receptor environments.

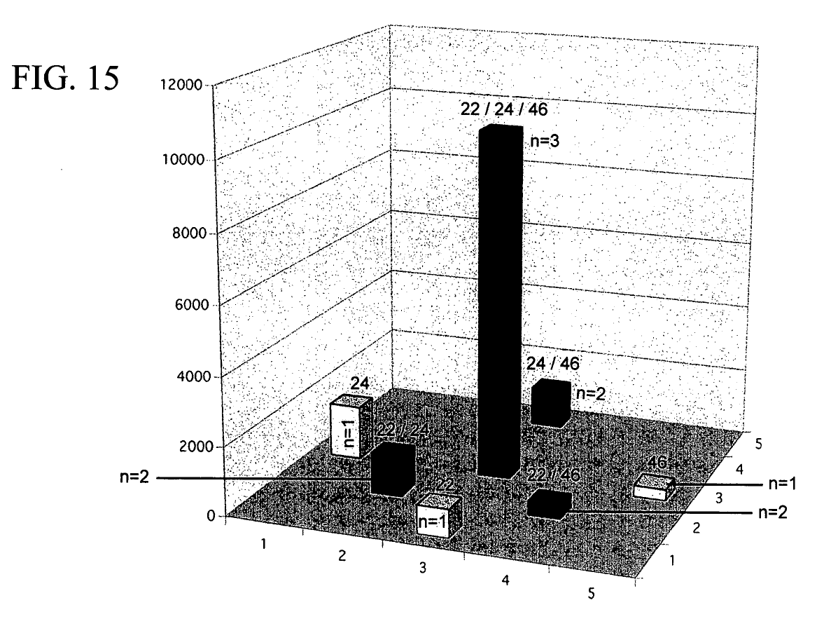

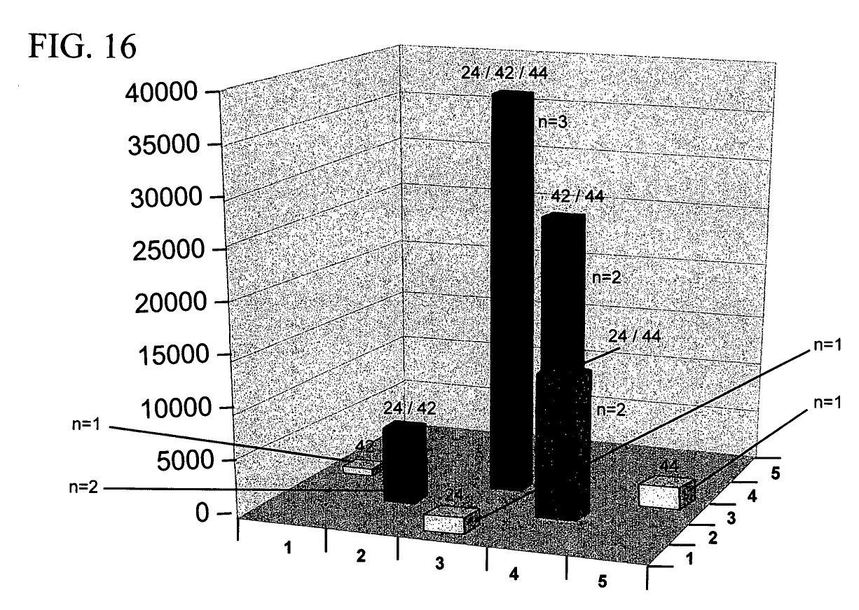

The effect of heterogeneous building blocks is most easily observed by comparing selected n=3 receptor environments candidate receptors including 1 or 2 of those building blocks (their n=2 and n=1 subsets). FIGS. 15 and 16 illustrate this comparison for two different n=3 receptor environments using the r-phycoerythrin data. In these examples, it is clear that progression from the homogeneous system (n=1) to the heterogeneous systems (n=2, n=3) produces significantly enhanced binding.

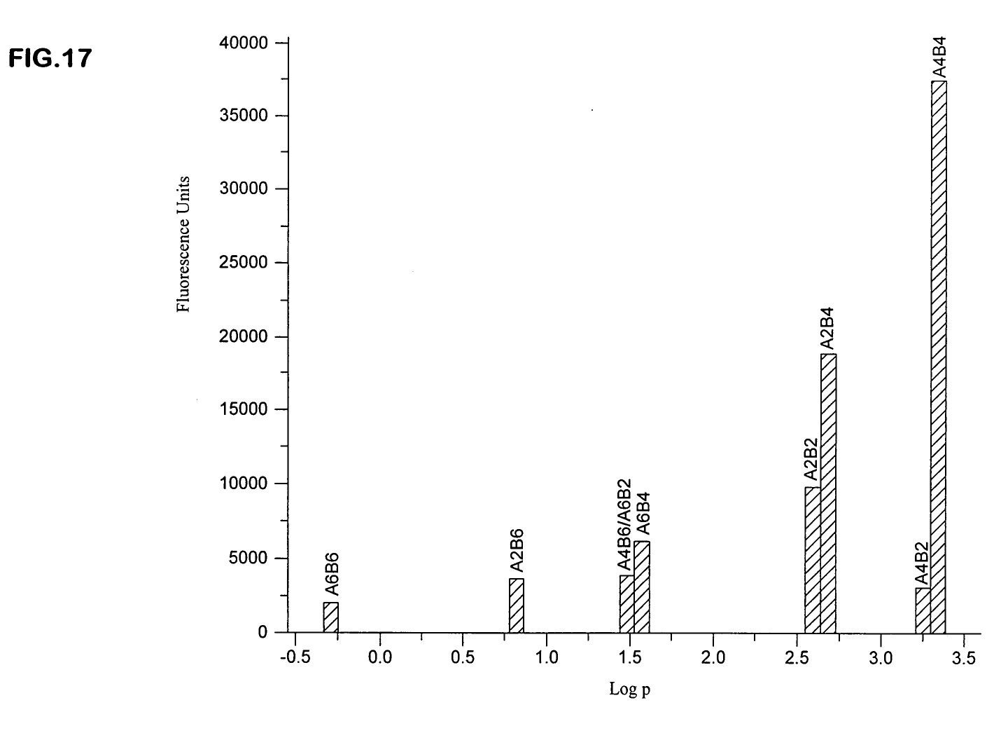

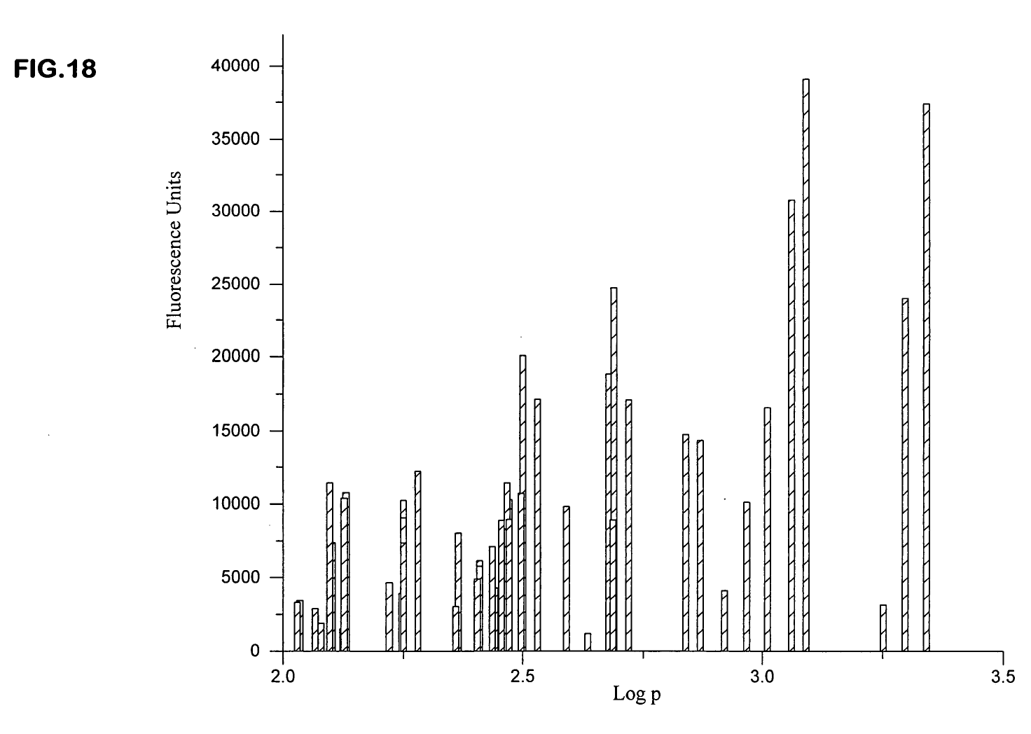

Although van der Waals interactions are an important part of molecular recognition, it is important to establish that the observed binding is not a simple case of hydrophobic/hydrophilic partitioning. That is, that the observed binding was the result of specific interactions between the individual building blocks and the target The simplest way to evaluate the effects of hydrophobicity and hydrophilicity is to compare building block logP value with observed binding. LogP is a known and accepted measure of lipophilicity, which can be measured or calculated by known methods for each of the building blocks. FIGS. 17 and 18 establish that the observed target binding, as measured by fluorescence units, is not directly proportional to building block logP. The plots in FIGS. 17 and 18 illustrate a non-linear relationship between binding (fluorescence units) and building block logP.

One advantage of the present methods and arrays is that the ability to screen large numbers of candidate receptor environments will lead to a combination of useful target affinities and to significant target binding diversity. High target affinity is useful for specific target binding, isolation, etc. while binding diversity can provide multiplexed target detection systems. This example employed a relatively small number of building blocks to produce ca. 120 binding environments. The following analysis of the present data clearly demonstrates that even a relatively small number of binding environments can produce diverse and useful artificial receptors.

The target binding experiments performed for this study used protein concentrations including 0.1 to 10 μg/ml. Considering the BSA data as representative, it is clear that some of the receptor environments readily bound 1.0 ug/ml BSA concentrations near the saturation values for fluorescence units (see, e.g., FIG. 9). Based on these data and the formula weight of 68,000 for BSA, several of the receptor environments readily bind BSA at ca. 15 picomole/ml or 15 nanomolar concentrations. Additional experiments using lower concentrations of protein (data not shown) indicate that, even with a small selection of candidate receptor environments, femptomole/ml or picomolar detection limits have been attained.

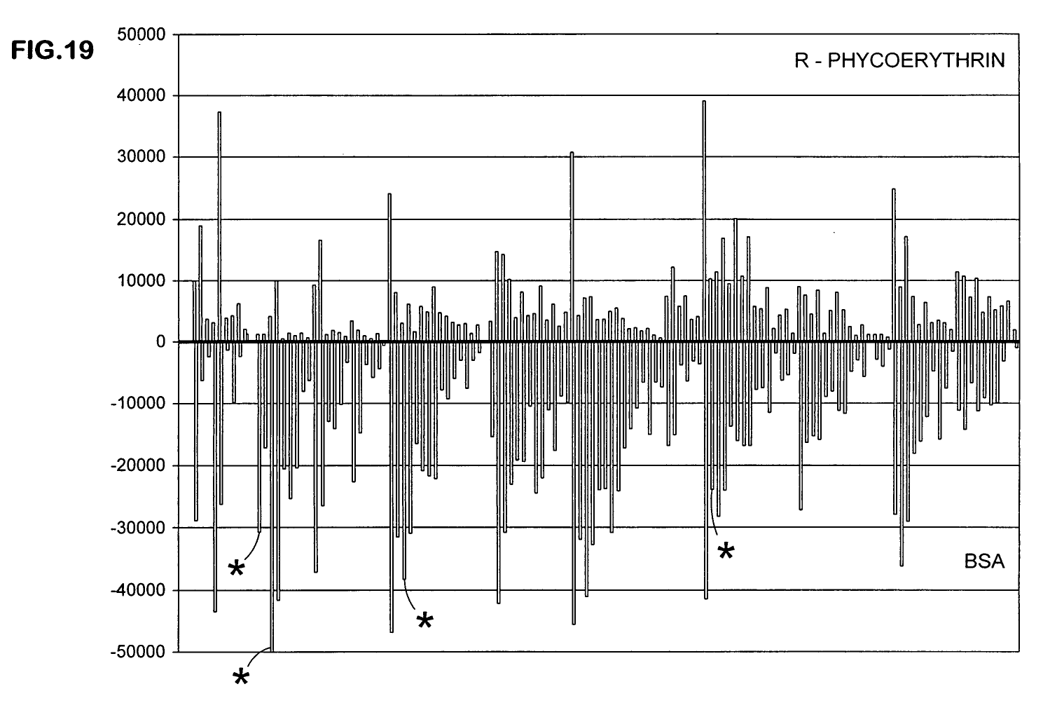

One goal of artificial receptor development is the specific recognition of a particular target. FIG. 19 compares the observed binding for r-phycoerythrin and BSA. Comparison of the overall binding pattern indicates some general similarities. However, comparison of specific features of binding for each receptor environment demonstrates that the two targets have distinctive recognition features as indicated by the (*) in FIG. 19.

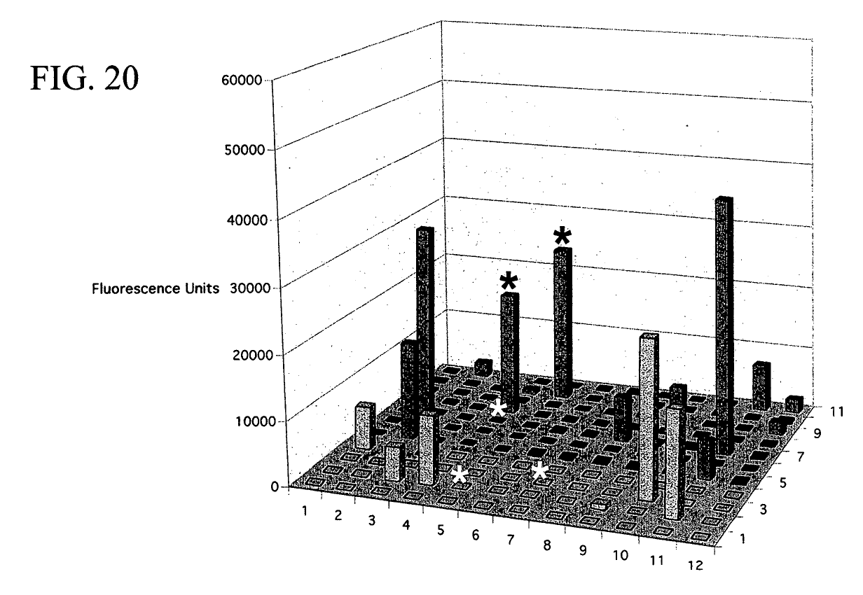

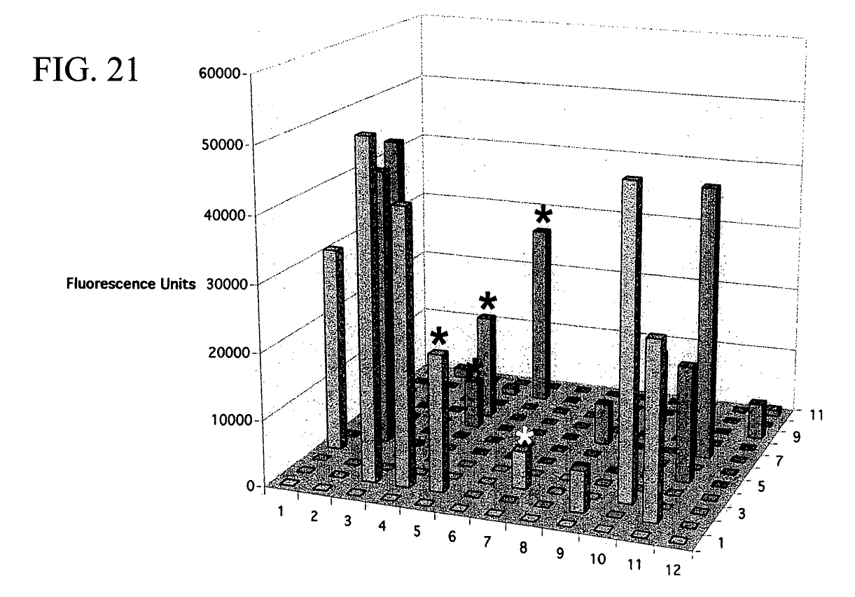

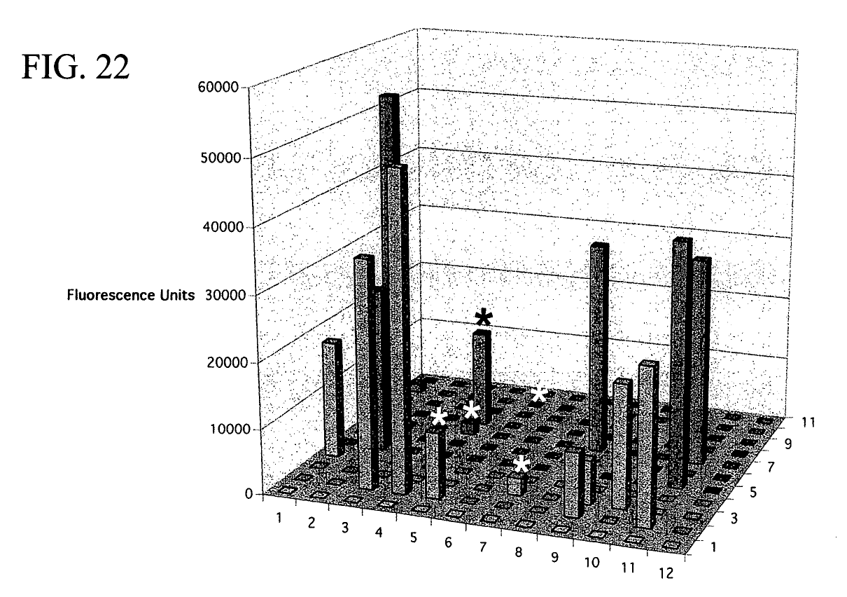

One goal of artificial receptor development is to develop receptors which can be used for the multiplexed detection of specific targets. Comparison of the r-phycoerythrin, BSA and ovalbumin data from this study (FIGS. 5, 7, and 9) were used to select representative artificial receptors for each target. FIGS. 20, 21, and 22 employ data obtained in the present example to illustrate identification of each of these three targets by their distinctive binding patterns.

Conclusions

The optimum receptor for a particular target requires molecular recognition which is greater than the expected sum of the individual hydrophilic, hydrophobic, ionic, etc. interactions. Thus, the identification of an optimum (specific, sensitive) artificial receptor from the limited pool of candidate receptors explored in this prototype study, was not expected and not likely. Rather, the goal was to demonstrate that all of the key components of the CARA: Combinatorial Artificial Receptor Array concept could be assembled to form a functional receptor microarray. This goal has been successfully demonstrated.

This study has conclusively established that CARA microarrays can be readily prepared and that target binding to the candidate receptor environments can be used to identify artificial receptors and test ligands. In addition, these results demonstrate that there is significant binding enhancement for the building block heterogeneous (n=2, n=3, or n=4) candidate receptors when compared to their homogeneous (n=1) counterparts. When combined with the binding pattern recognition results and the demonstrated importance of both the heterogeneous receptor elements and heterogeneous building blocks, these results clearly demonstrate the significance of the CARA Candidate Artificial Receptor->Lead Artificial Receptor->Working Artificial Receptor strategy.

### Example 3

### Preparation and Evaluation of Microarrays of Candidate Artificial Receptors Including Reversibly Immobilized Building Blocks

Microarrays of candidate artificial receptors including building blocks immobilized through van der Waals interactions were made and evaluated for binding of a protein ligand. The evaluation was conducted at several temperatures, above and below a phase transition temperature for the lawn (vide infra).

Materials and Methods

Building blocks 2-2, 2-4, 2-6, 4-2, 4-4, 4-6, 6-2, 6-4, 6-6 where prepared as described in Example 1. The C 12 amide was prepared using the previously described carbodiimide activation of the carboxyl followed by addition of dodecylamine. This produced a building block with a 12 carbon alkyl chain linker for reversible immobilization in the C18 lawn.

Amino lawn microarray plates (Telechem) were modified to produce the C 18 lawn by reaction of stearoyl chloride (Aldrich Chemical Co.) in A) dimethylformamide/PEG 400 solution (90:10, v/v, PEG 400 is polyethylene glycol average MW 400 (Aldrich Chemical Co.) or B) methylene chloride/TEA solution (100 ml methylene chloride, 200 μl triethylamine) using the lawn modification procedures generally described in Example 2.

The C18 lawn plates where printed using the SpotBot standard procedure as described in Example 2. The building blocks were in printing solutions prepared by solution of ca. 10 mg of each building block in 300 μl of methylene chloride and 100 μl methanol. To this stock was added 900 μl of dimethylformamide and 100 μl of PEG 400. The 36 combinations of the 9 building blocks taken two at a time (N9:n2, 36 combinations) where prepared in a 384-well microwell plate which was then used in the SpotBot to print the microarray in quadruplicate. A random selection of the print positions contained only print solution.

The selected microarray was incubated with a 1.0 μg/ml solution of the test ligand, cholera toxin subunit B labeled with the Alexa™ fluorophore (Molecular Probes Inc., Eugene, Oreg.), using the following variables: 1) the microarray was washed with methylene chloride, ethanol and water to create a control plate; and 2) the microarray was incubated at 4° C., 23° C., or 44° C. After incubation, the plate(s) were rinsed with water, dried and scanned (AXON 4100A). Data analysis was as described in Example 2.

Results

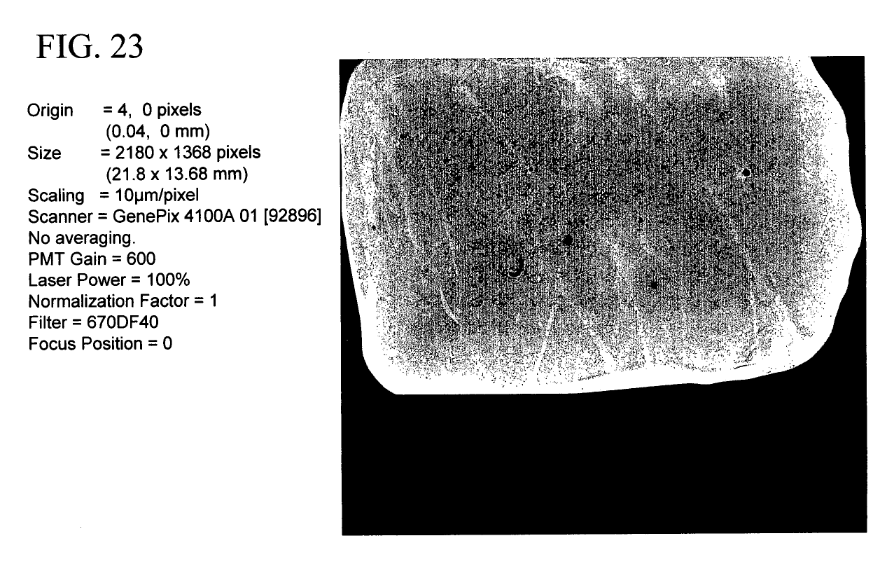

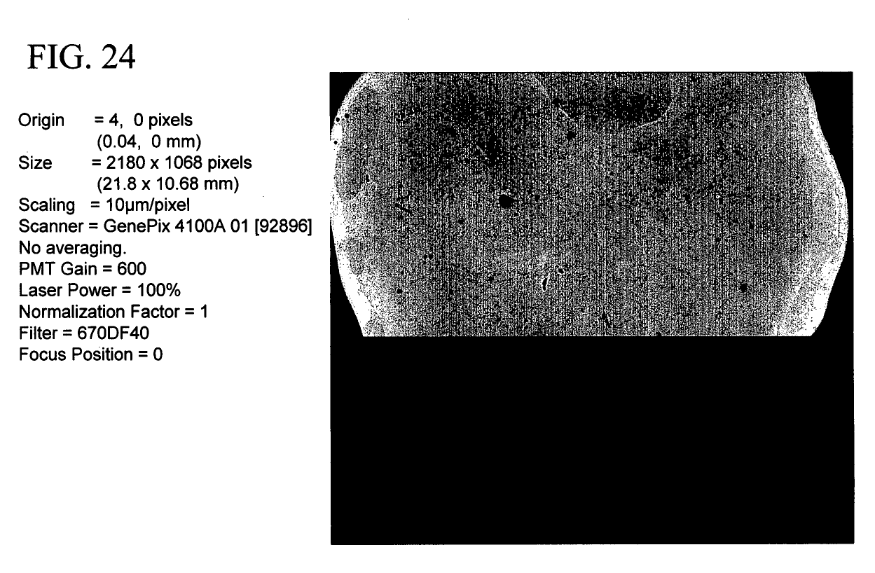

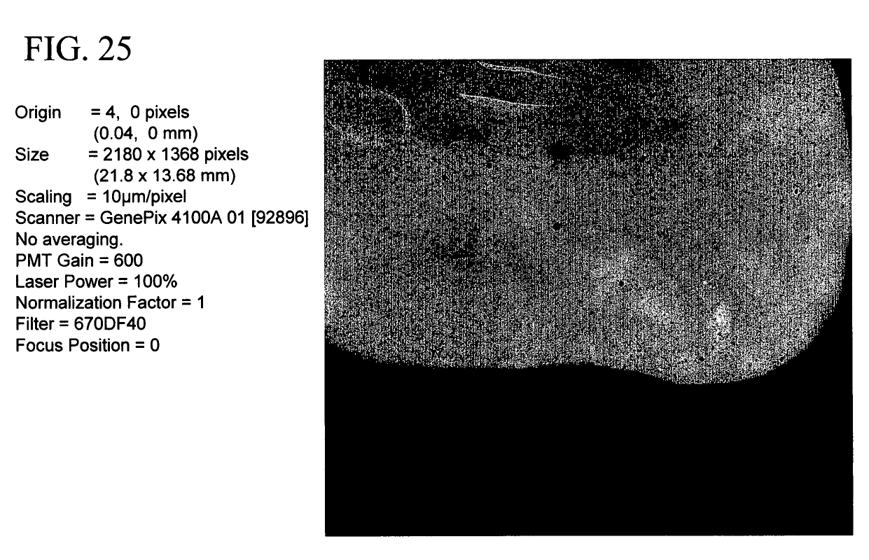

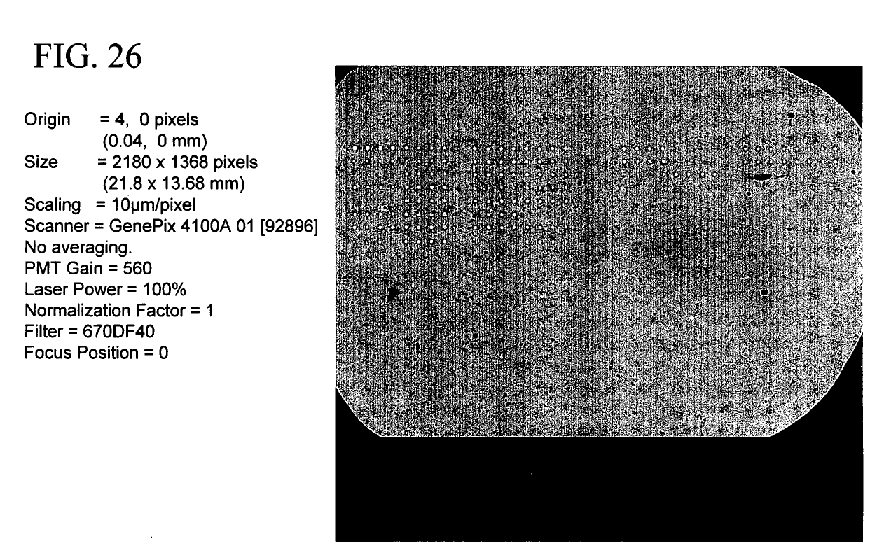

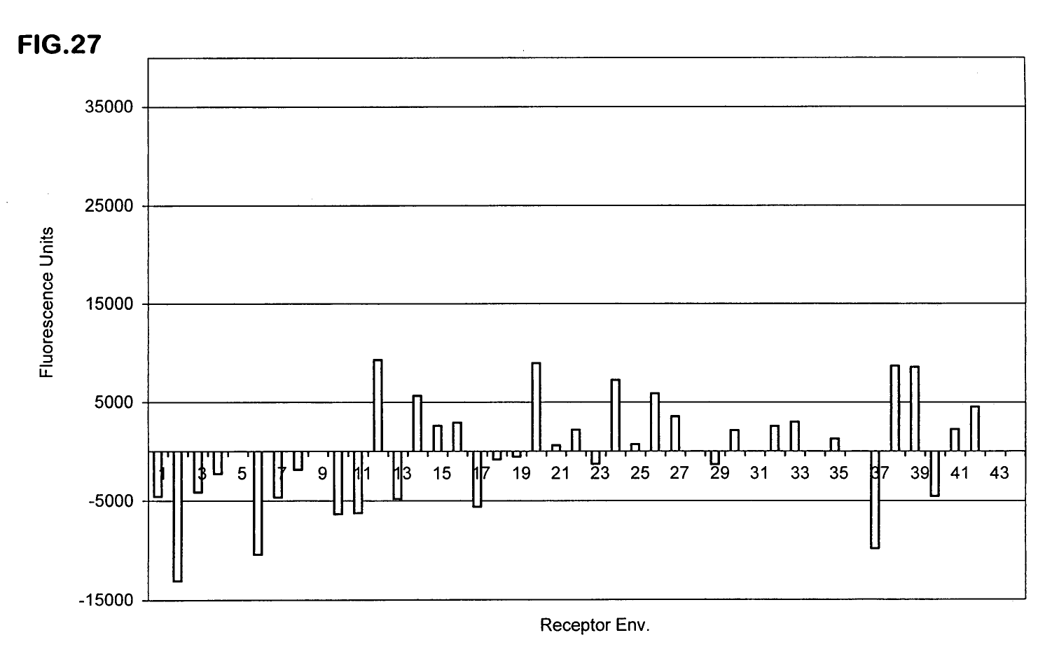

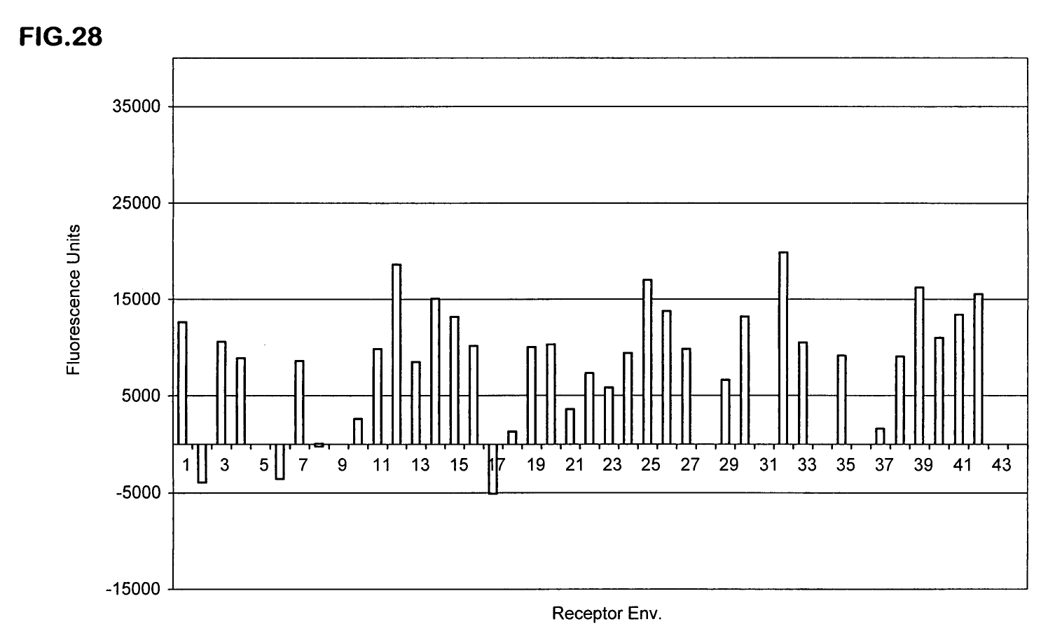

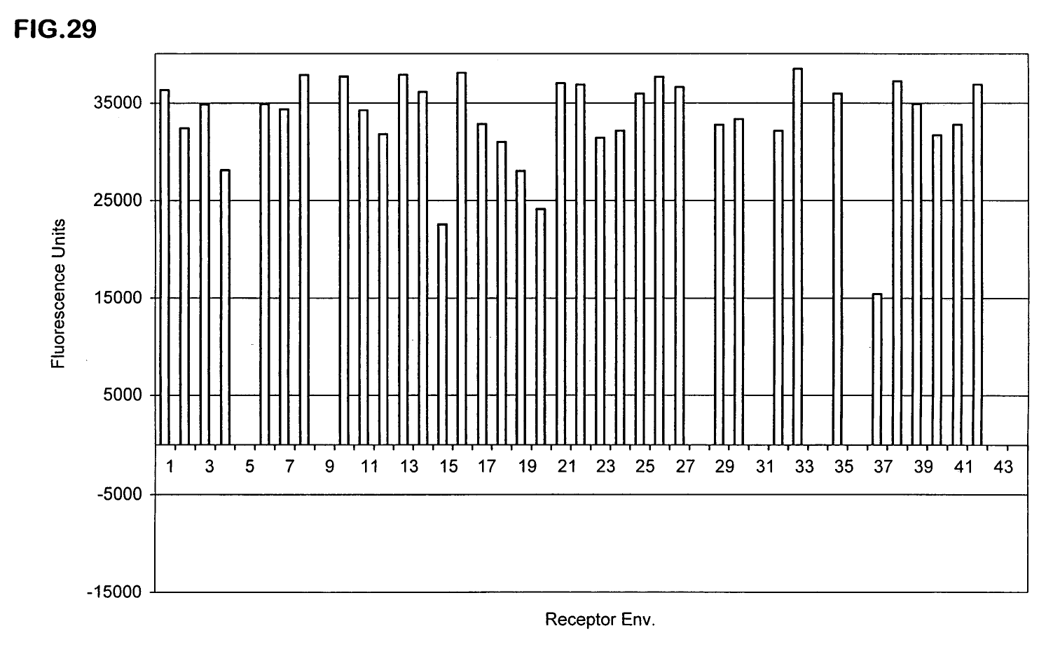

A control array from which the building blocks had been removed by washing with organic solvent did not bind cholera toxin (FIG. 23). FIGS. 24-26 illustrate fluorescence signals from arrays printed identically, but incubated with cholera toxin at 4° C., 23° C., or 44° C., respectively. Spots of fluorescence can be seen in each array, with very pronounced spots produced by incubation at 44° C. The fluorescence values for the spots in each of these three arrays are shown in FIGS. 27-29. Fluorescence signal generally increases with temperature, with many nearly equally large signals observed after incubation at 44° C. Linear increases with temperature can reflect expected improvements in binding with temperature. Nonlinear increases reflect rearrangement of the building blocks on the surface to achieve improved binding, which occurred above the phase transition for the lipid surface (vide infra).

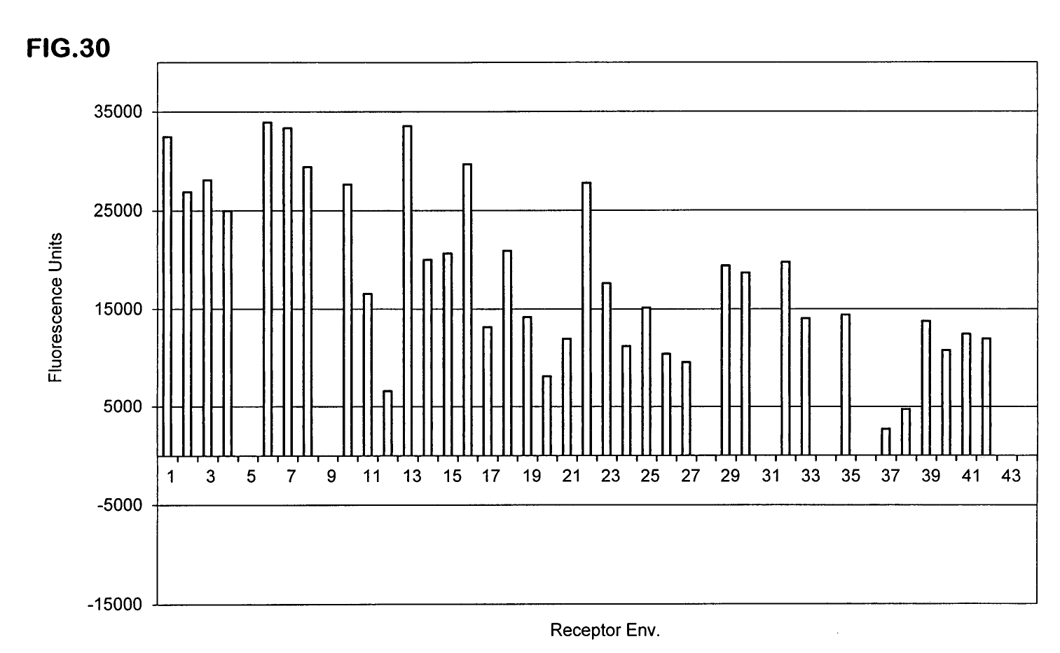

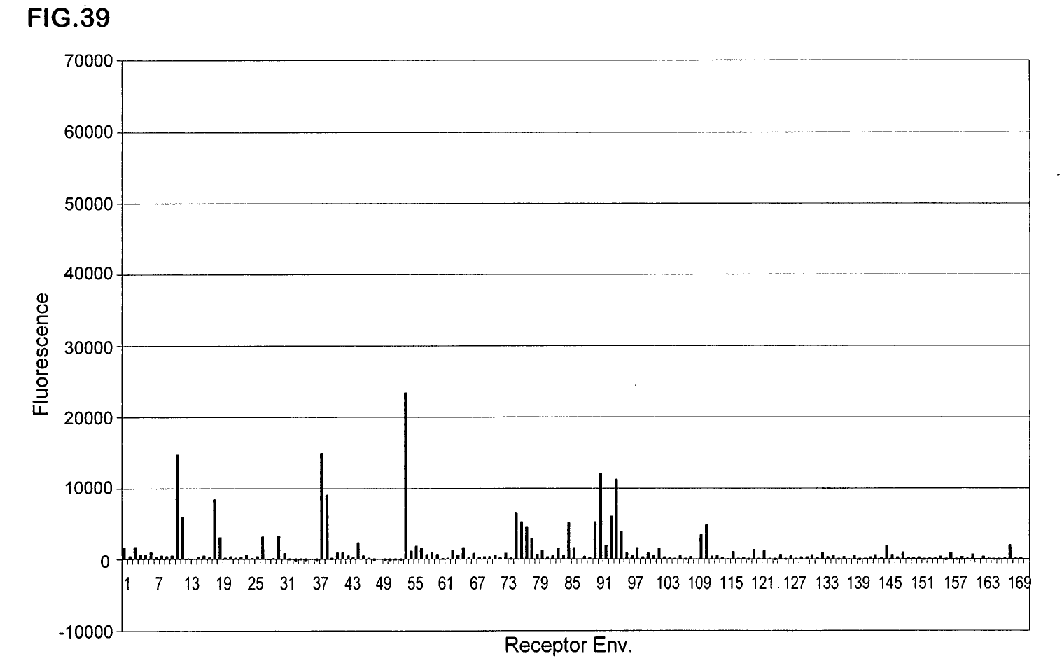

FIG. 30 can be compared to FIG. 39. The fluorescence signals plotted in FIG. 39 resulted from binding to reversibly immobilized building blocks on a support at 23° C. The fluorescence signals plotted in FIG. 30 resulted from binding to covalently immobilized building blocks on a support at 23° C. These figures compare the same combinations of building blocks in the same relative positions, but immobilized in two different ways.

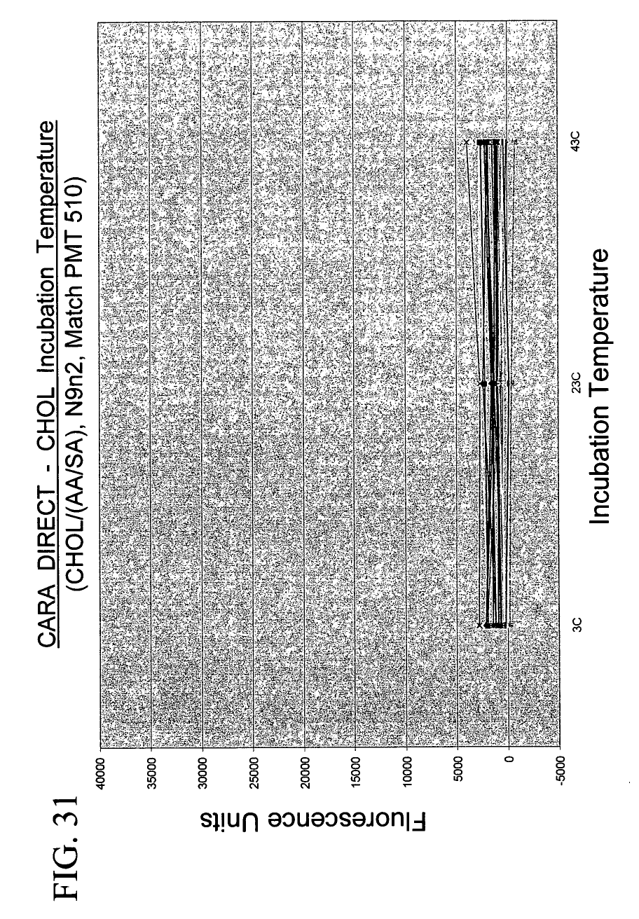

The binding to covalently immobilized building blocks was also evaluated at 4° C., 23° C., or 44° C. FIG. 31 illustrates the changes in fluorescence signal from individual combinations of covalently immobilized building blocks at 4° C., 23° C., or 44° C. Binding increased modestly with temperature. The mean increase in binding was 1.3-fold. A plot of the fluorescence signal for each of the covalently immobilized artificial receptors at 23° C. against its signal at 44° C. (not shown) yields a linear correlation with a correlation coefficient of 0.75. This linear correlation indicates that the mean 1.3-fold increase in binding is a thermodynamic effect and not optimization of binding.

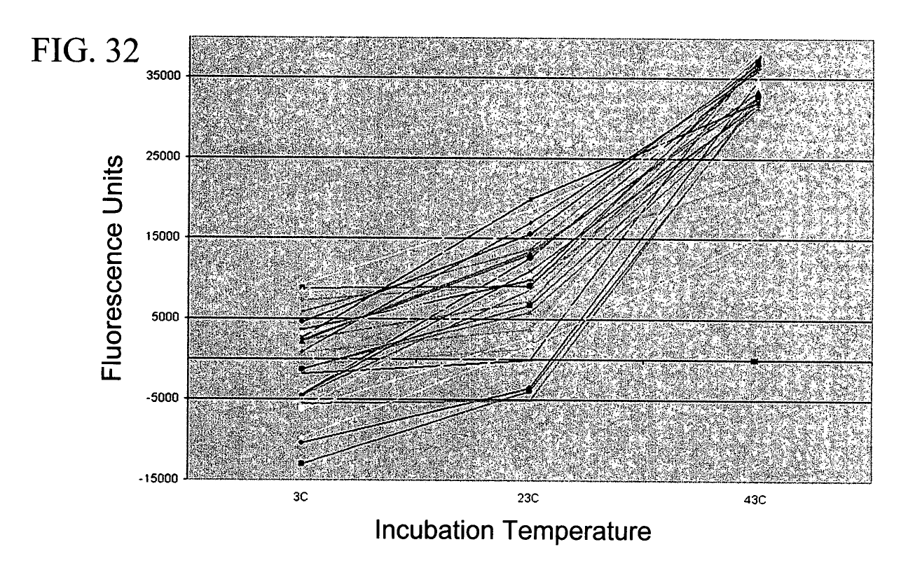

FIG. 32 illustrates the changes in fluorescence signal from individual combinations of reversibly immobilized building blocks at 4° C., 23° C., or 44° C. This graph illustrates that at least one combination of building blocks (candidate artificial receptor) exhibited a signal that remained constant as temperature increased. At least one candidate artificial receptor exhibited an approximately linear increase in signal as temperature increased. Such a linear increase indicates normal temperature effects on binding. The candidate artificial receptor with the lowest binding signal at 4° C. became one of the best binders at 44° C. This indicates that rearrangement of the building blocks of this receptor above the phase transition for the lawn, which increases the building blocks' mobility, produced increased binding. Other receptors characterized by greater changes in binding between 23° C. and 44° C. (compared to between 4° C. and 23° C.) also underwent dynamic affinity optimization.

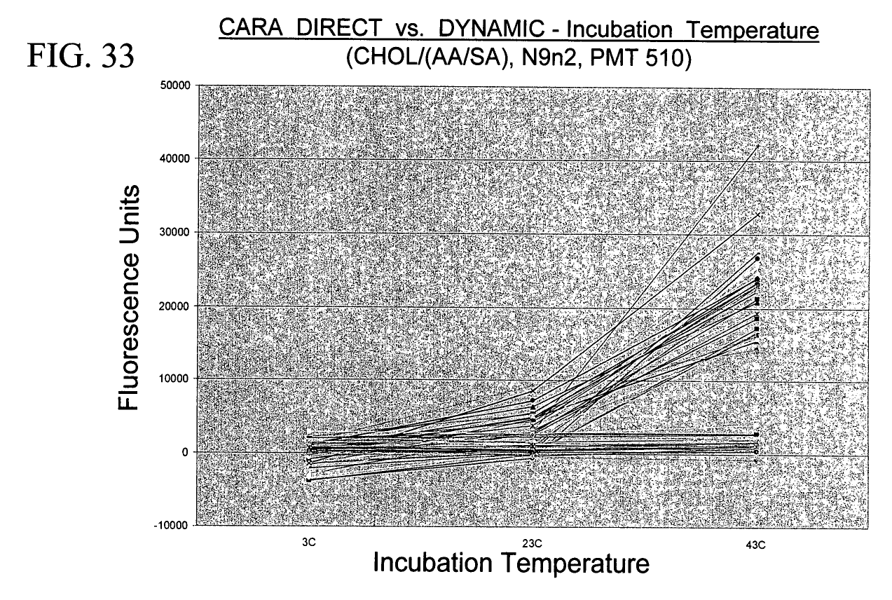

FIG. 33 illustrates the data presented in FIG. 31 (lines marked A) and the data presented in FIG. 32 (lines marked B). The increases in binding observed with the reversibly immobilized building blocks are significantly greater than the increases observed with covalently bound building blocks. Binding to reversibly immobilized building blocks increased from 23° C. and 44° C. by a median value of 6.1-fold and a mean value of 24-fold. This confirms that movement of the reversibly immobilized building blocks within the receptors increased binding (i.e., the receptor underwent dynamic affinity optimization).

A plot of the fluorescence signal for each of the reversibly immobilized artificial receptors at 23° C. against its signal at 44° C. (not shown) yields no correlation (correlation coefficient of 0.004). A plot of the fluorescence signal for each of the reversibly immobilized artificial receptors at 44° C. against the signal for the corresponding covalently immobilized receptor (not shown) also yields no correlation (correlation coefficient 0.004). This lack of correlation provides further evidence that movement of the reversibly immobilized building blocks within the receptors increased binding.

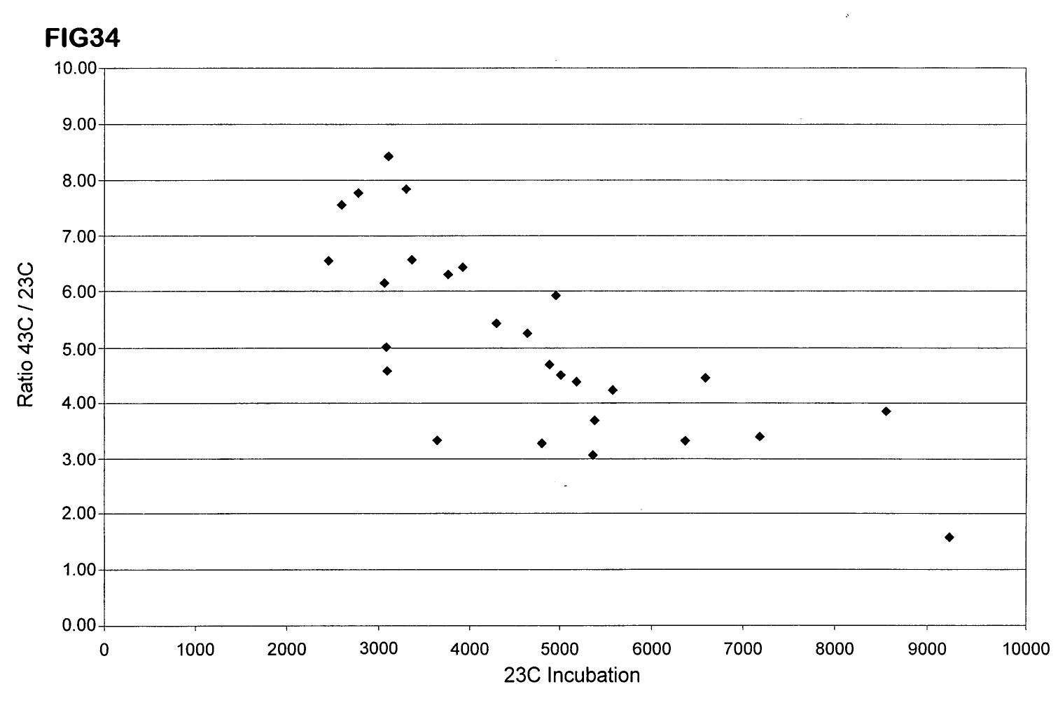

FIG. 34 illustrates a graph of the fluorescence signal at 44° C. divided by the signal at 23° C. against the fluorescence signal obtained from binding at 23° C. for the artificial receptors with reversibly immobilized receptors. This comparison indicates that the binding enhancement is independent of the initial affinity of the receptor for the test ligand.

Table 1 identifies the reversibly immobilized building blocks making up each of the artificial receptors, lists the fluorescence signal (binding strength) at 44° C. and 23° C., and the ratios of the observed binding at these two temperatures. These data illustrate that each artificial receptor reflects a unique attribute for each combination of building blocks relative to the role of each individual building block.

TABLE 1

| Building Blocks | | | Ratio |
|---|---|---|---|
| Making Up | Signal | Signal | of Signals, |
| Receptor | at 44° C. | at 23° C. | 44° C./23° C. |
| 22 24 | 24136 | 4611 | 5.23 |
| 22 26 | 16660 | 43 | 387.44 |
| 22 42 | 17287 | −167 | −103.51 |
| 22 44 | 16726 | 275 | 60.82 |
| 22 46 | 25016 | 3903 | 6.41 |
| 22 62 | 13990 | 3068 | 4.56 |
| 22 64 | 15294 | 3062 | 4.99 |
| 22 66 | 11980 | 3627 | 3.30 |
| 24 26 | 22688 | 1291 | 17.57 |
| 24 42 | 26808 | −662 | −40.50 |
| 24 44 | 23154 | 904 | 25.61 |
| 24 46 | 42197 | 2814 | 15.00 |
| 24 62 | 19374 | 2567 | 7.55 |
| 24 64 | 27599 | 262 | 105.34 |
| 24 66 | 16238 | 5334 | 3.04 |
| 26 42 | 22282 | 4974 | 4.48 |
| 26 44 | 26240 | 530 | 49.51 |
| 26 46 | 23144 | 4273 | 5.42 |
| 26 62 | 29022 | 4920 | 5.90 |
| 26 64 | 23416 | 5551 | 4.22 |
| 26 66 | 19553 | 5353 | 3.65 |
| 42 44 | 29093 | 6555 | 4.44 |
| 42 46 | 18637 | 3039 | 6.13 |
| 42 62 | 22643 | 4853 | 4.67 |
| 42 64 | 20836 | 6343 | 3.28 |
| 42 66 | 14391 | 9220 | 1.56 |
| 44 46 | 25600 | 3266 | 7.84 |
| 44 62 | 15544 | 4771 | 3.26 |
| 44 64 | 25842 | 3073 | 8.41 |
| 44 66 | 22471 | 5142 | 4.37 |
| 46 62 | 32764 | 8522 | 3.84 |
| 46 64 | 21901 | 3343 | 6.55 |
| 46 66 | 23516 | 3742 | 6.28 |
| 62 64 | 24069 | 7149 | 3.37 |
| 62 66 | 15831 | 2424 | 6.53 |
| 64 66 | 21310 | 2746 | 7.76 |

Conclusions

This experiment demonstrated that an array including reversibly immobilized building blocks binds a protein substrate, like an array with covalently immobilized building blocks. The binding increased nonlinearly as temperature increased, indicating that movement of the building blocks increased binding. Many of the candidate artificial receptors demonstrated improved binding upon mobilization of the building blocks.

### Example 4

### The Oligosaccharide Portion of GM1 Competes With Artificial Receptors for Binding to Cholera Toxin

Microarrays of candidate artificial receptors were made and evaluated for binding of cholera toxin. The arrays were also evaluated for disrupting that binding. Disrupting of binding employed a compound that binds to cholera toxin, the oligosaccharide moiety from GM1 (GM1 OS). The results obtained demonstrate that a ligand of a protein specifically disrupted binding of the protein to the microarray.

Materials and Methods

Building blocks were synthesized and activated as described in Example 1. The building blocks employed in this example were TyrA1B1 [1-1], TyrA2B2, TyrA2B4, TyrA2B6, TyrA2B8, TyrA3B3, TyrA3B5, TyrA3B7, TyrA4B2, TyrA4B4, TyrA4B6, TyrA4B8, TyrA5B3, TyrA5B5, TyrA5B7, TyrA6B2, TyrA6B4, TyrA6B6, TyrA6B8, TyrA7B3, TyrA7B5, TyrA7B7, TyrA8B2, TyrA8B4, TyrA8B6, and TyrA8B8. The abbreviation for the building block including a linker, a tyrosine framework, and recognition elements AxBy is TyrAxBy.

Microarrays for the evaluation of the 171 n=2 candidate receptor environments were prepared as follows by modifications of known methods. An “n=2” receptor environment includes two different building blocks. Briefly: Amine modified (amine “lawn”; SuperAmine Microarray plates) microarray plates were purchased from Telechem Inc., Sunnyvale, Calif. These plates were manufactured specifically for microarray preparation and had a nominal amine load of 2-4 amines per square nm according to the manufacturer. The microarrays were prepared using a pin microarray spotter instrument from Telechem Inc. (SpotBot™ Arrayer) typically with 200 μm diameter spotting pins from Telechem Inc. (Stealth Micro Spotting Pins, SMP6) and 400-420 μm spot spacing.

The 19 building blocks were activated in aqueous dimethylformamide (DMF) solution as described above. For preparing the 384-well feed plate, the activated building block solutions were diluted 10-fold with a solution of DMF/H₂O/PEG400 (90/10/10, v/v/v; PEG400 is polyethylene glycol nominal 400 FW, Aldrich Chemical Co., Milwaukee, Wis.). These stock solutions were aliquotted (10 μl per aliquot) into the wells of a 384-well microwell plate (Telechem Inc.). Control spots included the building block [1-1]. The plate was covered with aluminum foil and placed on the bed of a rotary shaker for 15 minutes at 1,000 RPM. This master plate was stored covered with aluminum foil at −20° C. when not in use.

For preparing the 384-well SpotBot™ plate, a well-to-well transfer (e.g. A-1 to A-1, A-2 to A-2, etc.) from the feed plate to a second 384-well plate was performed using a 411 transfer pipette. This plate was stored tightly covered with aluminum foil at −20° C. when not in use. The SpotBot™ was used to prepare up to 13 microarray plates per run using the 4 μl microwell plate. The SpotBot™ was programmed to spot from each microwell in quadruplicate. The wash station on the SpotBot™ used a wash solution of EtOH/H₂O (20/80, v/v). This wash solution was adjusted to pH 4 with 1 M HCl and used to rinse the microarrays on completion of the SpotBot™ printing run. The plates were given a final rinse with deionized (DI) water, dried using a stream of compressed air, and stored at room temperature. The microarrays were further modified by reacting the remaining amines with acetic anhydride to form an acetamide lawn in place of the amine lawn.

The test ligand employed in these experiments was cholera toxin labeled with the Alexa™ fluorophore (Molecular Probes Inc., Eugene, Oreg.). The candidate disruptor employed in these experiments was GM1 OS (GM1 oligosaccharide), a known ligand for cholera toxin.

Microarray incubation and analysis was conducted as follows: For control incubations with the microarrays, solutions (e.g. 500 μL) of the cholera toxin in PBS-T (PBS with 201 μl/L of Tween-20) at a concentrations of 1.7 pmol/ml (0.1 μg/ml) was placed onto the surface of a microarray and allowed to react for 30 minutes. For disruptor incubations with the microarrays, solutions (e.g. 500 μl) of the cholera toxin (1.7 pmol/ml, 0.1 μg/ml) and the desired concentration of GM1 OS in PBS-T (PBS with 20 μl/L of Tween-20) was placed onto the surface of a microarray and allowed to react for 30 minutes. GM1 OS was added at 0.34 and at 5.1 μM in separate experiments. After either of these incubations, the microarray was rinsed with PBS-T and DI water and dried using a stream of compressed air.

The incubated microarray was scanned using an Axon Model 4200A Fluorescence Microarray Scanner (Axon Instruments, Union City, Calif.). The Axon scanner and its associated software produce a false color 16-bit image of the fluorescence intensity of the plate. This 16-bit data is integrated using the Axon software to give a Fluorescence Units value (range 0-65,536) for each spot on the microarray. This data is then exported into an Excel file (Microsoft) for further analysis including mean, standard deviation and coefficient of variation calculations.

Table 2 identifies the building blocks in each of the first 150 receptor environments.

TABLE 2

| | Building Blocks |
|---|---|
| 1 | 22 24 |
| 2 | 22 28 |
| 3 | 22 42 |
| 4 | 22 46 |
| 5 | 22 55 |
| 6 | 22 64 |
| 7 | 22 68 |
| 8 | 22 82 |
| 9 | 22 86 |
| 10 | 24 26 |
| 11 | 24 33 |
| 12 | 24 44 |
| 13 | 26 77 |
| 14 | 26 84 |
| 15 | 26 88 |
| 16 | 28 42 |
| 17 | 22 26 |
| 18 | 22 33 |
| 19 | 22 44 |
| 20 | 22 48 |
| 21 | 22 62 |
| 22 | 22 66 |
| 23 | 22 77 |
| 24 | 22 84 |
| 25 | 22 88 |
| 26 | 24 28 |
| 27 | 24 42 |
| 28 | 26 82 |
| 29 | 26 85 |
| 30 | 28 33 |
| 31 | 28 44 |
| 32 | 28 46 |
| 33 | 28 55 |
| 34 | 28 64 |
| 35 | 28 68 |
| 36 | 28 82 |
| 37 | 28 86 |
| 38 | 33 42 |
| 39 | 33 46 |
| 40 | 42 88 |
| 41 | 44 48 |
| 42 | 44 62 |
| 43 | 44 66 |
| 44 | 44 77 |
| 45 | 44 84 |
| 46 | 44 88 |
| 47 | 46 55 |
| 48 | 28 48 |
| 49 | 28 62 |
| 50 | 28 66 |
| 51 | 28 77 |
| 52 | 28 84 |
| 53 | 28 88 |
| 54 | 33 44 |
| 55 | 44 46 |
| 56 | 44 55 |
| 57 | 44 64 |
| 58 | 44 68 |
| 59 | 44 82 |
| 60 | 44 86 |
| 61 | 46 48 |
| 62 | 46 62 |
| 63 | 24 46 |
| 64 | 24 55 |
| 65 | 24 64 |
| 66 | 24 68 |
| 67 | 24 82 |
| 68 | 24 86 |
| 69 | 26 28 |
| 70 | 26 42 |
| 71 | 26 46 |
| 72 | 26 55 |
| 73 | 26 64 |
| 74 | 26 68 |
| 75 | 33 48 |
| 76 | 33 63 |
| 77 | 33 66 |
| 78 | 33 77 |
| 79 | 24 48 |
| 80 | 24 62 |
| 81 | 24 66 |
| 82 | 24 77 |
| 83 | 24 84 |
| 84 | 24 88 |
| 85 | 26 33 |
| 86 | 26 44 |
| 87 | 26 48 |
| 88 | 26 62 |
| 89 | 26 66 |
| 90 | 33 55 |
| 91 | 33 64 |
| 92 | 33 68 |
| 93 | 33 82 |
| 94 | 33 84 |
| 95 | 33 88 |
| 96 | 42 46 |
| 97 | 42 55 |
| 98 | 42 64 |
| 99 | 42 68 |
| 100 | 42 82 |
| 101 | 42 86 |
| 102 | 46 88 |
| 103 | 48 62 |
| 104 | 48 66 |
| 105 | 46 77 |
| 106 | 48 84 |
| 107 | 48 88 |
| 108 | 55 64 |
| 109 | 55 68 |
| 110 | 33 86 |
| 111 | 42 44 |
| 112 | 42 48 |
| 113 | 42 62 |
| 114 | 42 66 |
| 115 | 42 77 |
| 116 | 42 84 |
| 117 | 48 55 |
| 118 | 48 64 |
| 119 | 48 68 |
| 120 | 48 82 |
| 121 | 48 86 |
| 122 | 55 62 |
| 123 | 55 66 |
| 124 | 55 77 |
| 125 | 46 64 |
| 126 | 46 68 |
| 127 | 46 82 |
| 128 | 46 86 |
| 129 | 62 77 |
| 130 | 62 84 |
| 131 | 62 88 |
| 132 | 64 68 |
| 133 | 64 82 |
| 134 | 64 86 |
| 135 | 66 68 |
| 136 | 66 82 |
| 137 | 66 86 |
| 138 | 68 77 |
| 139 | 68 84 |
| 140 | 68 88 |
| 141 | 46 66 |
| 142 | 46 77 |
| 143 | 46 84 |
| 144 | 62 82 |
| 145 | 62 86 |
| 146 | 64 66 |
| 147 | 64 77 |
| 148 | 64 84 |
| 149 | 64 88 |
| 150 | 66 77 |

Results
Low Concentration of GM1 OS

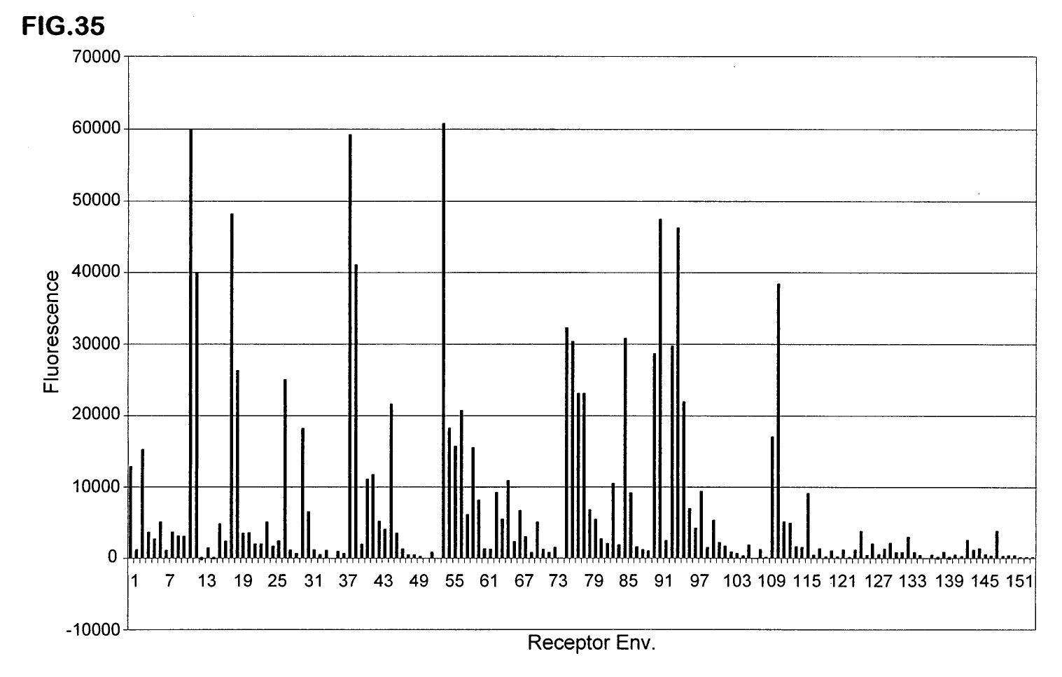

FIG. 35 illustrates binding of cholera toxin to the microarray of candidate artificial receptors followed by washing with buffer produced fluorescence signals. These fluorescence signals demonstrate that the cholera toxin bound strongly to certain receptor environments, weakly to others, and undetectably to some. Comparison to experiments including those reported in Example 2 indicates that cholera toxin binding was reproducible from array to array and from month to month.

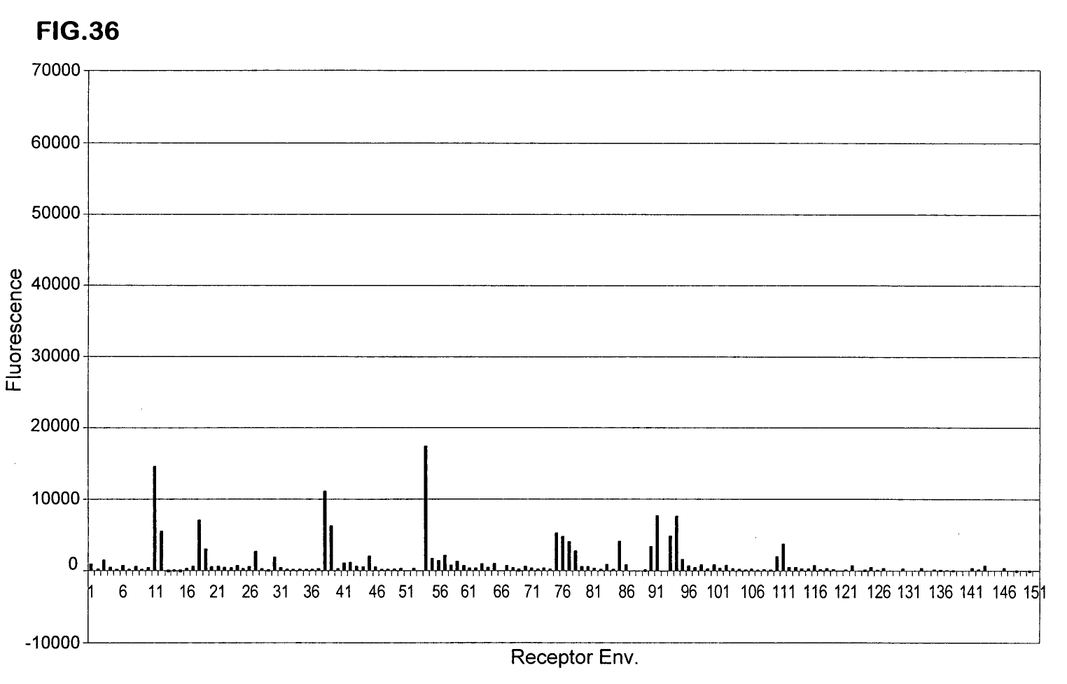

Binding of cholera toxin was also conducted with competition from GM1 OS (0.34 μM). FIG. 36 illustrates the fluorescence signals due to cholera toxin binding that were detected after this competition. Notably, many of the signals illustrated in FIG. 36 are significantly smaller than the corresponding signals recorded in FIG. 35. The small signals observed in FIG. 36 represent less cholera toxin bound to the array. GM1 OS significantly disrupted binding of cholera toxin to many of the receptor environments.

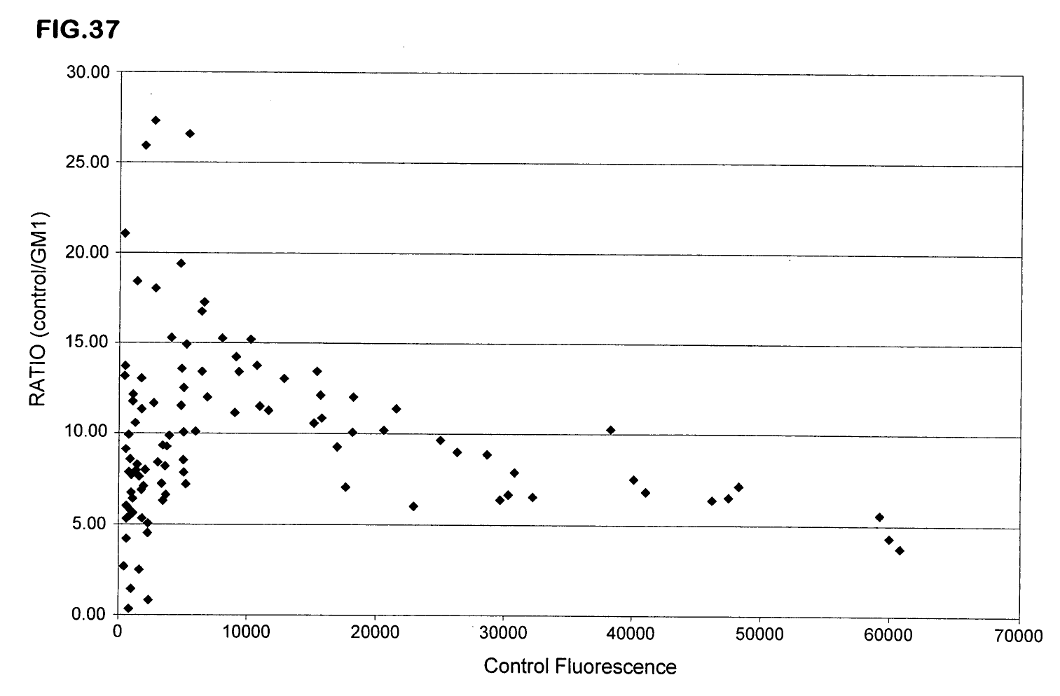

The disruption in cholera toxin binding caused by GM1 OS can be visualized as the ratio of the amount bound in the absence of GM1 OS to the amount bound in competition with GM1 OS. This ratio is illustrated in FIG. 37. The larger the ratio, the less cholera toxin remained bound to the artificial receptor after competition with GM1 OS. The ratio can be as large as about 30. The ratios are independent of the quantity bound in the control.

High Concentration of GM1 OS

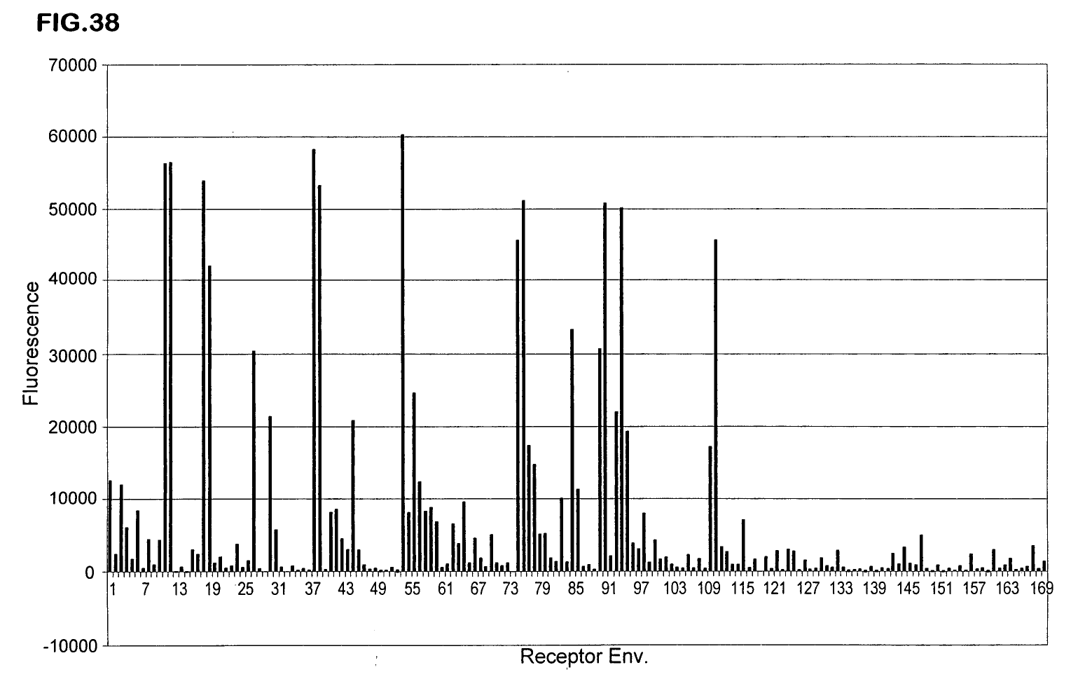

Binding of cholera toxin to the microarray of candidate artificial receptors followed by washing with buffer produced fluorescence signals illustrated in FIG. 38. As before, cholera toxin was reproducible and it bound strongly to certain receptor environments, weakly to others, and undetectably to some. FIG. 39 illustrates the fluorescence signals detected due to cholera toxin binding that were detected upon competition with GM1 OS at 5.1 μM. Again, GM1 OS significantly disrupted binding of cholera toxin to many of the receptor environments.

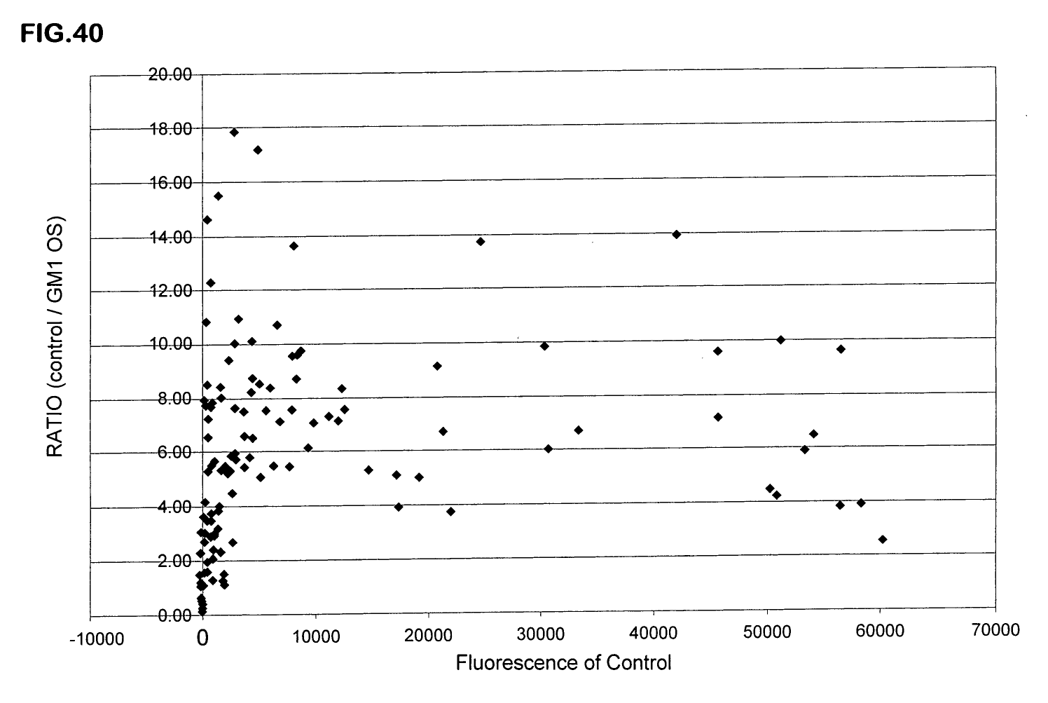

This disruption is presented as the ratio of the amount bound in the absence of GM1 OS to the amount bound after contacting with GM1 OS in FIG. 40. The ratios range up to about 18 and are independent of the quantity bound in the control.

Conclusions

This experiment demonstrated that binding of a test ligand to an artificial receptor of the present invention can be diminished (e.g., competed) by a candidate disruptor molecule. In this case the test ligand was the protein cholera toxin and the candidate disruptor was a compound known to bind to cholera toxin, GM1 OS. The degree to which binding of the test ligand was disrupted was independent of the degree to which the test ligand bound to the artificial receptor.

### Example 5

### GM1 Competes With Artificial Receptors for Binding to Cholera Toxin

Microarrays of candidate artificial receptors were made and evaluated for binding of cholera toxin. The arrays were also evaluated for disrupting that binding. Disrupting of binding employed a compound that binds to cholera toxin, the liposaccharide GM1. The results obtained demonstrate that a ligand of a protein specifically disrupts binding of the protein to the microarray.

Materials and Methods

Building blocks were synthesized and activated as described in Example 1. The building blocks employed in this example were TyrA1B1 [1-1], TyrA2B2, TyrA2B4, TyrA2B6, TyrA4B2, TyrA4B4, TyrA4B6, TyrA6B2, TyrA6B4, and TyrA6B6 in groups of 4 building blocks per artificial receptor. The abbreviation for the building block including a linker, a tyrosine framework, and recognition elements AxBy is TyrAxBy.

Microarrays for the evaluation of the 126 n=4 candidate receptor environments were prepared as described above for Example 4. The test ligand employed in these experiments was cholera toxin labeled with the Alexa™ fluorophore (Molecular Probes Inc., Eugene, Oreg.). Cholera toxin was employed at 5.3 nM in both the control and the competition experiments. The candidate disruptor employed in these experiments was GM1, a known ligand for cholera toxin, which competed at concentrations of 0.042, 0.42, and 8.4 μM. Microarray incubation and analysis was conducted as described for Example 4.

Table 3 identifies the building blocks in each receptor environment.

TABLE 3

| | Building Blocks |
|---|---|
| 1 | 22 24 26 42 |
| 2 | 22 24 26 44 |
| 3 | 22 24 26 46 |
| 4 | 22 24 26 61 |
| 5 | 22 24 26 64 |
| 6 | 22 24 26 66 |
| 7 | 22 24 42 44 |
| 8 | 22 24 42 46 |
| 9 | 22 24 42 62 |
| 10 | 22 24 42 46 |
| 11 | 22 24 42 66 |
| 12 | 22 24 44 46 |
| 13 | 22 24 44 62 |
| 14 | 22 24 44 64 |
| 15 | 22 24 44 66 |
| 16 | 22 24 46 62 |
| 17 | 22 24 46 64 |
| 18 | 22 24 46 66 |
| 19 | 22 24 62 64 |
| 20 | 22 24 62 66 |
| 21 | 22 24 64 66 |
| 22 | 22 26 42 44 |
| 23 | 22 26 42 46 |
| 24 | 22 26 42 62 |
| 25 | 22 26 42 64 |
| 26 | 22 26 42 66 |
| 27 | 22 26 44 46 |
| 28 | 22 26 44 62 |
| 29 | 22 26 44 64 |
| 30 | 22 26 44 66 |
| 31 | 22 26 46 62 |
| 32 | 22 26 46 64 |
| 33 | 22 26 46 66 |
| 34 | 22 26 62 64 |
| 35 | 22 26 62 66 |
| 36 | 22 26 64 66 |
| 37 | 22 42 44 46 |
| 38 | 22 42 44 62 |
| 39 | 22 42 44 64 |
| 40 | 22 42 44 66 |
| 41 | 22 42 46 62 |
| 42 | 22 42 46 64 |
| 43 | 22 42 46 66 |
| 44 | 22 42 62 64 |
| 45 | 22 42 62 66 |
| 46 | 22 42 64 66 |
| 47 | 22 44 46 62 |
| 48 | 22 44 46 64 |
| 49 | 22 44 46 66 |
| 50 | 22 44 62 64 |
| 51 | 22 44 62 66 |
| 52 | 22 44 64 66 |
| 53 | 22 46 62 64 |
| 54 | 22 46 62 66 |
| 55 | 22 46 64 66 |
| 56 | 22 62 64 66 |
| 57 | 24 26 42 44 |
| 58 | 24 26 42 46 |
| 59 | 24 26 42 62 |
| 60 | 24 26 42 64 |
| 61 | 24 26 42 66 |
| 62 | 24 26 44 46 |
| 63 | 24 26 44 62 |
| 64 | 24 26 44 64 |
| 65 | 24 26 44 66 |
| 66 | 24 26 46 62 |
| 67 | 24 26 46 64 |
| 68 | 24 26 46 66 |
| 69 | 24 26 62 64 |
| 70 | 24 26 62 66 |
| 71 | 24 26 64 66 |
| 72 | 24 42 44 46 |
| 73 | 24 42 44 62 |
| 74 | 24 42 44 64 |
| 75 | 24 42 44 66 |
| 76 | 24 42 46 62 |
| 77 | 24 42 46 64 |
| 78 | 24 42 46 66 |
| 79 | 24 42 62 64 |
| 80 | 24 42 62 66 |
| 81 | 24 42 64 66 |
| 82 | 24 44 46 62 |
| 83 | 24 44 46 64 |
| 84 | 24 44 46 66 |
| 85 | 24 44 62 64 |
| 86 | 24 44 62 66 |
| 87 | 24 44 64 66 |
| 88 | 24 46 62 64 |
| 89 | 24 46 62 66 |
| 90 | 24 46 64 66 |
| 91 | 24 62 64 66 |
| 92 | 26 42 44 46 |
| 93 | 26 42 44 62 |
| 94 | 26 42 44 64 |
| 95 | 26 42 44 66 |
| 96 | 26 42 46 62 |
| 97 | 26 42 46 64 |
| 98 | 26 42 46 66 |
| 99 | 26 42 62 64 |
| 100 | 26 42 62 66 |
| 101 | 26 42 64 66 |
| 102 | 26 44 46 62 |
| 103 | 26 44 46 64 |
| 104 | 26 44 46 66 |
| 105 | 26 44 62 64 |
| 106 | 26 44 62 66 |
| 107 | 26 44 64 66 |
| 108 | 26 46 62 64 |
| 109 | 26 46 62 66 |
| 110 | 26 46 64 66 |
| 111 | 26 62 64 66 |
| 112 | 42 44 46 62 |
| 113 | 42 44 46 64 |
| 114 | 42 44 46 66 |
| 115 | 42 44 62 64 |
| 116 | 42 44 62 66 |
| 117 | 42 44 64 66 |
| 118 | 42 46 62 64 |
| 119 | 42 46 62 66 |
| 120 | 42 46 64 66 |
| 121 | 42 62 64 66 |
| 122 | 44 46 62 64 |
| 123 | 44 46 62 66 |
| 124 | 44 46 64 66 |
| 125 | 44 62 64 66 |
| 126 | 46 62 64 66 |

Results

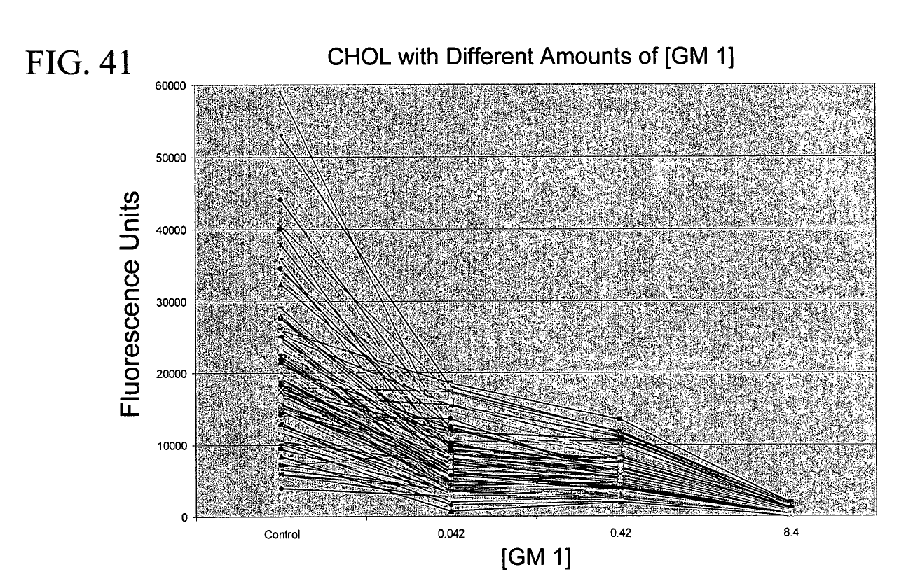

FIG. 41 illustrates the fluorescence signals produced by binding of cholera toxin to the microarray of candidate artificial receptors alone and in competition with each of the three concentrations of GM1. The magnitude of the fluorescence signal decreases steadily with increasing concentration of GM1. The amount of decrease is not quantitatively identical for all of the receptors, but each receptor experienced decreased binding of cholera toxin. These decreases indicate that GM1 competed with the artificial receptor for binding to the cholera toxin.

The decreases show a pattern of relative competition for the binding site on cholera toxin. This can be demonstrated through graphs of fluorescence signal obtained at a particular concentration of GM1 against fluorescence signal in the absence of GM1 (not shown). Certain of the receptors appear at similar relative positions on these plots as concentration of GM1 increases.

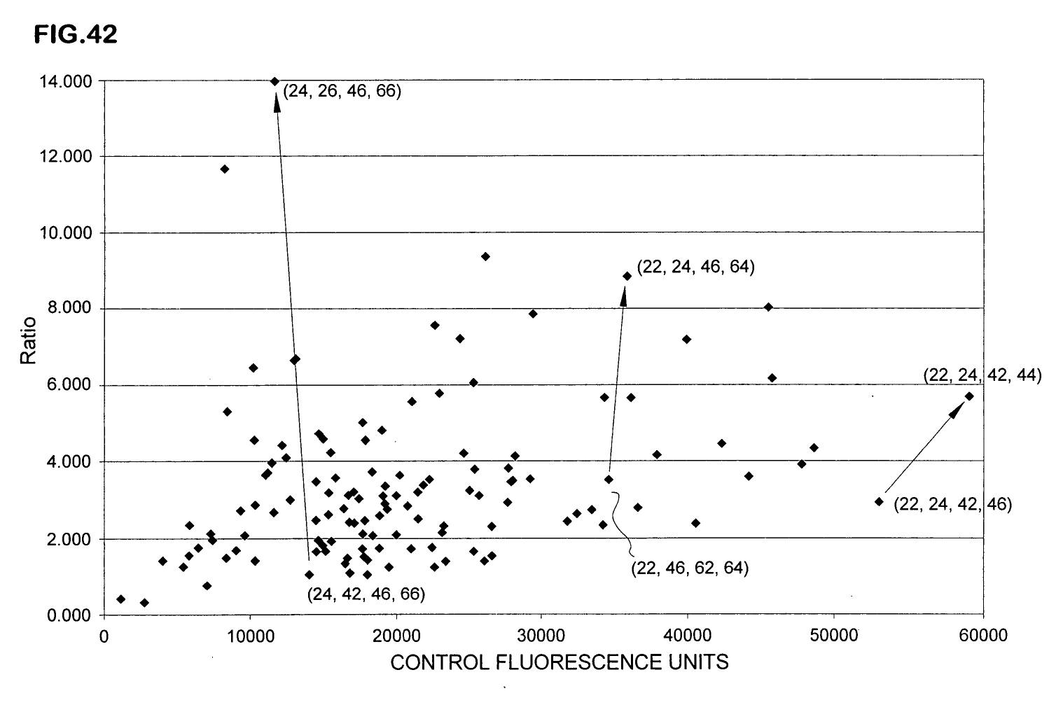

The disruption in cholera toxin binding caused by GM1 can be visualized as the ratio of the amount bound in the absence of GM1 OS to the amount bound upon competition with GM1. This ratio is illustrated in FIG. 42. The larger the ratio, the more cholera toxin remained bound to the artificial receptor upon competition with GM1. The ratio can be as large as about 14. The ratios are independent of the quantity bound in the control.

Interestingly, in several instances minor changes in structure to the artificial receptor caused significant changes in the ratio. For example, the artificial receptor including building blocks 24, 26, 46, and 66 differs from that including 24, 42, 46, and 66 by only substitution of a single building block. (xy indicates building block TyrAxBy.) The substitution of building block 42 for 26 increased binding in the presence of GM1 by about 14-fold.

By way of further example, the artificial receptor including building blocks 22, 24, 46, and 64 differs from that including 22, 46, 62, and 64 by only substitution of a single building block. The substitution of building block 24 for 62 increased binding in the presence of GM1 by about 3-fold.

Even substitution of a single recognition element affected binding. The artificial receptor including building blocks 22, 24, 42, and 44 differs from that including 22, 24, 42, and 46 by only substitution of a single recognition element. The substitution of building block 44 for 46 (a change of recognition element B6 to B4) increased binding in the presence of GM1 by about 3-fold.

Conclusions

This experiment demonstrated that binding of a test ligand to an artificial receptor of the present invention can be diminished (e.g., competed) by a candidate disrupter molecule. In this case the test ligand was the protein cholera toxin and the candidate disruptor was a compound known to bind to cholera toxin, GM1. Minor changes in structure of the building blocks making up the artificial receptor caused significant changes in the competition.

### Example 6

### GM1 Employed as a Building Block Alters Binding of Cholera Toxin to the Present Artificial Receptors

Microarrays of candidate artificial receptors were made, GM1 was bound to the arrays, and they were evaluated for binding of cholera toxin. The results obtained demonstrate that adding GM1 as a building block in an array of artificial receptors can increase binding to certain of the receptors.

Materials and Methods

Building blocks were synthesized and activated as described in Example 1. The building blocks employed in this example were those described in Example 4. Microarrays for the evaluation of the 171 n=2 candidate receptor environments were prepared as described above for Example 4. The test ligand employed in these experiments was cholera toxin labeled with the Alexa™ fluorophore (Molecular Probes Inc., Eugene, Oreg.). Cholera toxin was employed at 0.01 ug/ml (0.17 pM) or 0.1 ug/ml (1.7 pM) in both the control and the competition experiments. GM1 was employed as a test ligand for the artificial receptors and became a building block for receptors used to bind cholera toxin. The arrays were contacted with GM1 at either 100 μg/ml, 10 μg/ml, or 1 μg/ml as described above for cholera toxin and then rinsed with deionized water. The arrays were then contacted with cholera toxin under the conditions described above. Microarray analysis was conducted as described for Example 4. Table 2 identifies the building blocks in each receptor environment.

Results

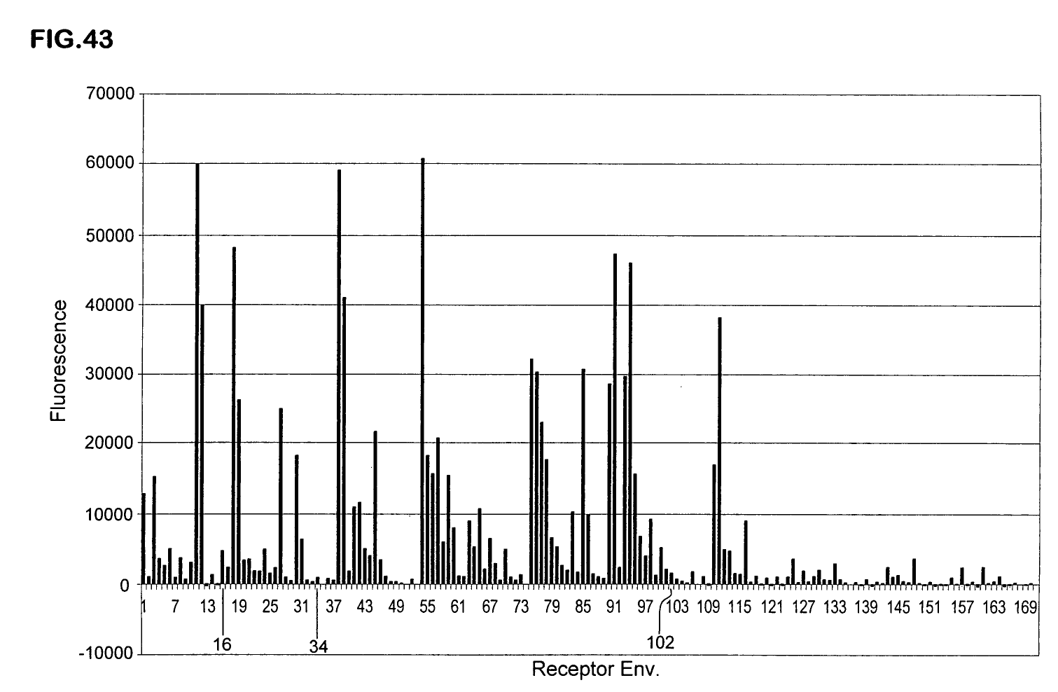

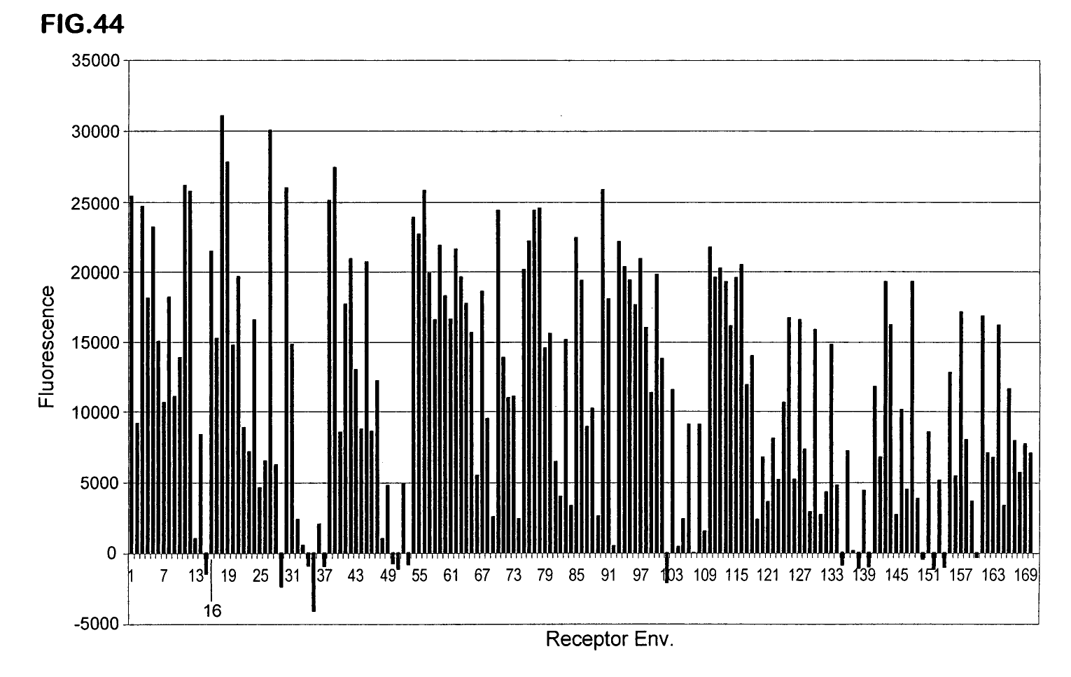

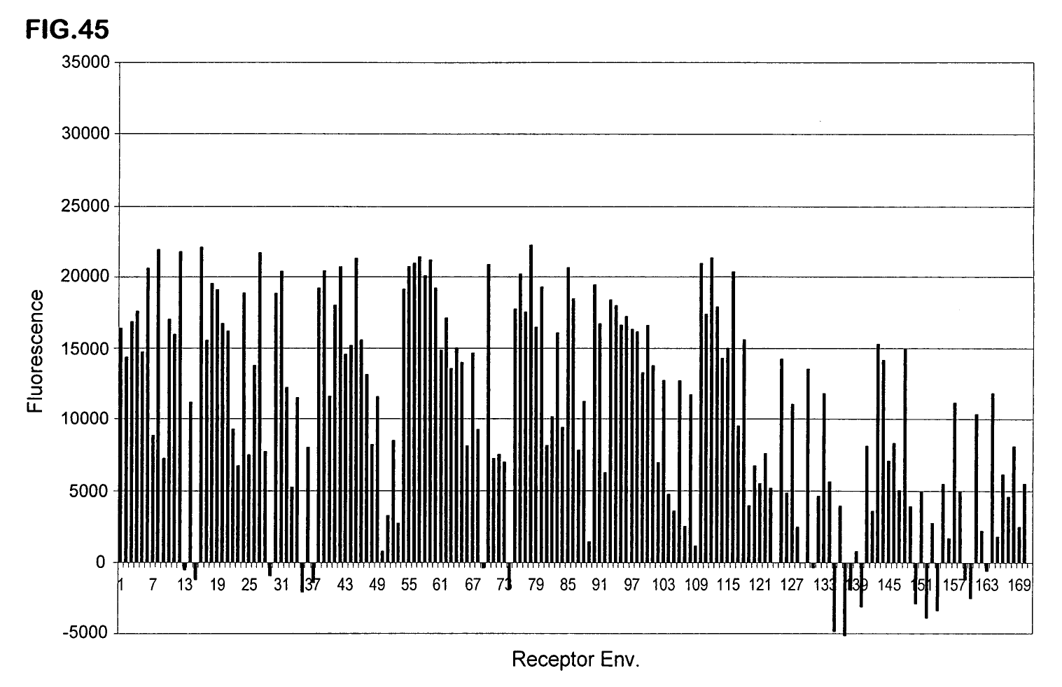

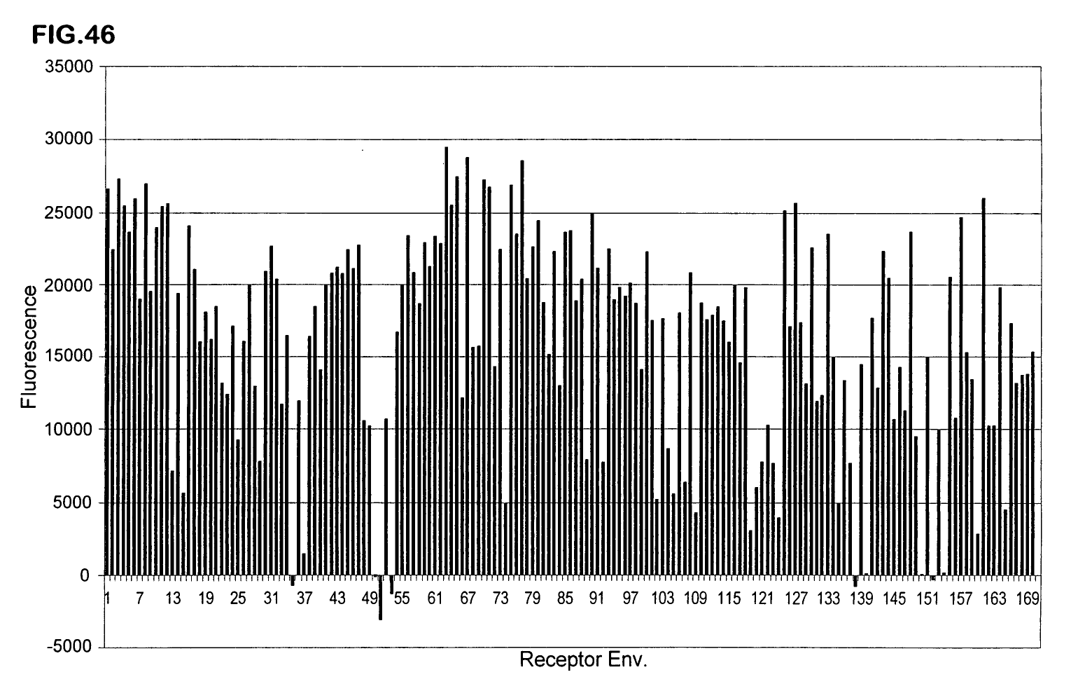

FIG. 43 illustrates the fluorescence signals produced by binding of cholera toxin to the microarray of candidate artificial receptors without pretreatment with GM 1. Binding of GM1 to the microarray of candidate artificial receptors followed by binding of cholera toxin produced fluorescence signals illustrated in FIGS. 44, 45, and 46 (100 μg/ml, 10 μg/ml, and 1 μg/ml GM1, respectively).

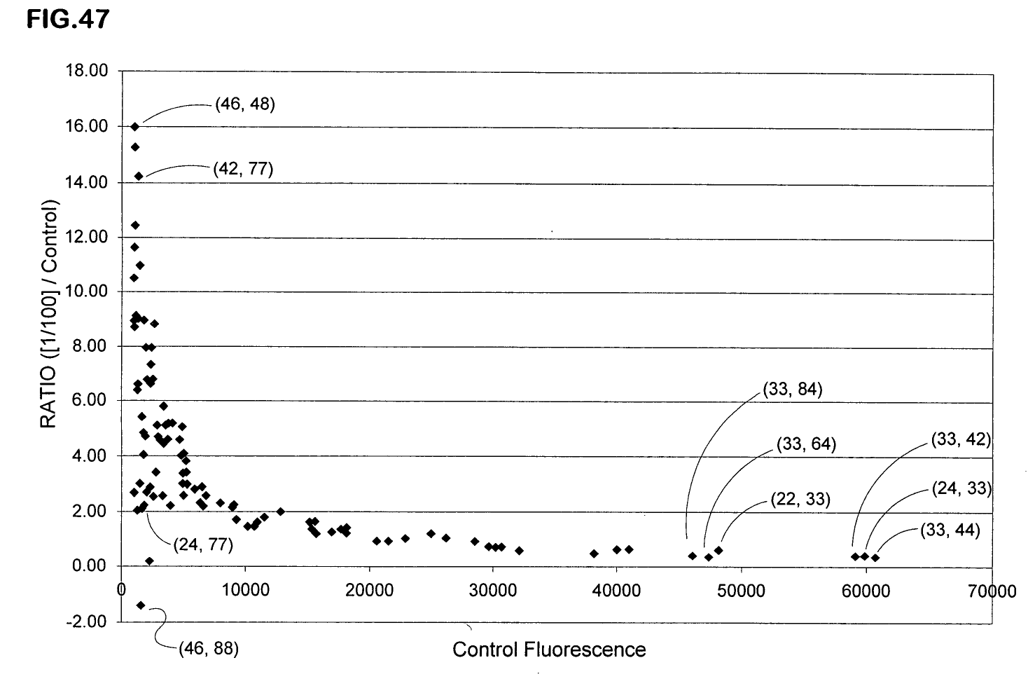

The enhancement of cholera toxin binding caused by pretreatment with GM1 can be visualized as the ratio of the amount bound in the presence of GM1 to the amount bound in the absence of GM1. This ratio is illustrated in FIG. 47 for 1 μg/ml GM1. The larger the ratio, the more cholera toxin bound to the artificial receptor after pretreatment with GM1. The ratio can be as large as about 16.

In several instances minor changes in structure to the artificial receptor caused significant changes in the ratio. For example, the artificial receptor including building blocks 46 and 48 differs from that including 46 and 88 by only substitution of a single recognition element on a single building block. (xy indicates building block TyrAxBy.) The substitution of building block 48 for 88 (a change of recognition element A8 to A4) increased the ratio representing increased binding the presence of GM1 building block from about 0.5 to about 16. Similarly, the artificial receptor including building blocks 42 and 77 differs from that including 24 and 77 by only substitution of a single building block. The substitution of building block 42 for 24 increased the ratio representing increased binding the presence of GM1 building block from about 2 to about 14.

Interestingly, several building blocks that exhibited high levels of binding of cholera toxin (signals of 45,000 to 65,000 fluorescence units) and that include the building block 33 were not strongly affected by the presence of GM1 as a building block.

Conclusions

This experiment demonstrated that binding of GM 1 to an artificial receptor of the present invention can significantly increase binding by cholera toxin. Minor changes in structure of the building blocks making up the artificial receptor caused significant changes in the degree to which GM1 enhanced binding of cholera toxin.

Discussion of Examples 4-6

We have previously demonstrated that an array of working artificial receptors bind to a protein target in a manner which is complementary to the specific environment presented by each region of the proteins surface topology. Thus the pattern of binding of a protein target to an array of working artificial receptors describes the proteins surface topology; including surface structures which participate in e.g., protein˜small molecule, protein˜peptide, protein-protein, protein˜carbohydrate, protein˜DNA, etc. interactions. It is thus possible to use the binding of a selected protein to a working artificial receptor array to characterize these protein˜small molecule, protein˜peptide, protein-protein, protein˜carbohydrate, protein˜DNA, etc. interactions. Moreover, it is possible to utilize the protein to array interactions to define “leads” for the disruption of these interactions.

Cholera Toxin B sub-unit binds to GM1 on the cell surface (structure of GM1). Studies to identify competitors to this binding event have shown that competitors to the cholera toxin: GM1 binding interaction (binding site) can utilize both a sugar and an alkyl/aromatic functionality (Pickens, et al., Chemistry and Biology, vol. 9, pp 215-224 (2002)). We have previously demonstrated that fluorescently labeled Cholera Toxin B sub-unit binds to arrays of working artificial receptors to give a defined binding pattern which (vida infra) reflects cholera toxin B's surface topology. For this study, we sought to demonstrate that the binding of the cholera toxin to at least some members of the array could be disrupted using cholera toxins natural ligand, GM1.

The results presented in the figures clearly demonstrate that these goals have been achieved. Specifically, competition between the GM1 OS pentasaccharide or GM1 and a working artificial receptor array for cholera binding clearly gave a binding pattern which was distinct from the cholera binding pattern control. Moreover, these results demonstrated the complementarity between several of the working artificial receptors which contained a naphthyl moiety when compared to working artificial receptors which only contained phenyl functionality. These results are in keeping with the active site competition studies in Pickens, et al. and indicate that the naphthyl and phenyl derivatives represent good mimics/probes for the cholera to GM1 interaction. The specificity of these interactions was particularly demonstrated by the observation that the change of a single building block out of 4 in a combination of 4 building blocks system changed a non-competitive to a significantly competitive environment. These results also indicated that selected working artificial receptors can be used to develop a high-throughput screen for the further evaluation of the cholera: GM1 interaction.

Additionally, we sought to demonstrate that an affinity support/membrane mimic could be prepared by pre-incubating an array of artificial receptors with GM1 which would then bind/capture cholera toxin in a binding pattern which could be used to select a working artificial receptor(s) for, for example, the high-throughput screen of lead compounds which will disrupt the “cholera: membrane˜GM1 mimic”. The GM1 pre-incubation studies clearly demonstrated that several of the working artificial receptors which were poor cholera binders significantly increased their cholera binding, presumably through an affinity interaction between the cholera toxin and both the immobilized GM1 pentasaccharide moiety and the working artificial receptor building block environment.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “adapted and configured” describes a system, apparatus, or other structure that is constructed or configured to perform a particular task or adopt a particular configuration. The phrase “adapted and configured” can be used interchangeably with other similar phrases such as arranged and configured, constructed and arranged, adapted, constructed, manufactured and arranged, and the like.

All publications and patent applications in this specification are indicative of the level of ordinary skill in the art to which this invention pertains.

The invention has been described with reference to various specific and preferred embodiments and techniques. However, it should be understood that many variations and modifications may be made while remaining within the spirit and scope of the invention.

What is claimed is:

1. A method of making a scaffold artificial receptor, the method comprising:
forming a plurality of reaction sites on a scaffold; and
coupling a building block to each of the plurality of reaction sites on the scaffold.

2. The method of claim 1, further comprising mixing a plurality of activated building blocks, and employing the mixture in coupling a building block to each of the plurality of reaction sites on the scaffold.

3. The method of claim 1, wherein the plurality of reaction sites is 2, 3, 4, 5, 6, or 7 reaction sites.

4. The method of claim 3, further comprising mixing a plurality of activated building blocks, and employing the mixture in coupling a building block to each of the plurality of reaction sites on the scaffold, wherein the plurality of activated building blocks is a heterogeneous mixture and the number of distinct building blocks is greater than the number of reaction sites.

5. The method of claim 1, wherein the scaffold comprises an organic molecule less than or approximately equal to 1 nanometer in diameter.

6. The method of claim 1, wherein the scaffold comprises an organic molecule greater than 1 nanometer in diameter.

7. A method of using a scaffold artificial receptor comprising:
contacting a first heterogeneous molecular array with a test ligand;
the array comprising:
a plurality of locations; and
a scaffold artificial receptor associated with each location, wherein each scaffold artificial receptor comprises a plurality of building blocks;
detecting binding of a test ligand in one or more locations; and
selecting one or more of the scaffold artificial receptor as the artificial receptor for the test ligand.

8. The method of claim 7, wherein the scaffold artificial receptor comprises 2, 3, 4, 5, 6, or 7 building blocks.

9. The method of claim 7, further comprising:
identifying the plurality of building blocks making up the artificial receptor;
coupling the identified plurality of building blocks to a scaffold molecule; and
evaluating the scaffold artificial receptor for binding of the test ligand.

10. The method of claim 9, wherein:
coupling comprises making a plurality of positional isomers of the building blocks on the scaffold;
evaluating comprises comparing the plurality of the scaffold positional isomer artificial receptors; and
selecting one or more of the scaffold positional isomer artificial receptors as lead or working artificial receptor.

11. A composition comprising:
a scaffold; and
a portion of the scaffold comprising a plurality of building blocks;
the building blocks being coupled to the scaffold.

12. The composition of claim 11, wherein the artificial receptor comprises 2, 3, 4, 5, 6, or 7 different building blocks.

13. The composition of claim 11, wherein the scaffold comprises a molecule less than or approximately equal to 1 nanometer in diameter.

14. The composition of claim 11, wherein the scaffold comprises a molecule greater than or approximately equal to 1 nanometer in diameter.

15. The composition of claim 11, the plurality of building blocks independently comprising framework, linker, first recognition element, and second recognition element.

16. The composition of claim 15, wherein the framework comprises an amino acid.

17. The composition of claim 16, wherein the amino acid comprises serine, threonine, or tyrosine.

18. The composition of claim 16, wherein the amino acid comprises tyrosine.

19. The composition of claim 15, wherein the linker has the formula (CH₂)ₙC(O)—, with n=1-16.

20. The composition of claim 15, wherein the first recognition element and second recognition element independently are of formulas B1, B2, B3, B4, B5, B6, B7, B8, B9, A1, A2, A3, A4, A5, A6, A7, A8, or A9.

21. The composition of claim 11, the plurality of building blocks independently having the formula: 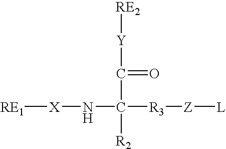
in which: X is absent or C═O; Y is absent, NH, or O; Z is O; R₂ is H or CH₃; R₃ is CH₂ or CH₂-phenyl; RE₁ is B1, B2, B3, B4, B5, B6, B7, B8, B9, A1, A2, A3, A4, A5, A6, A7, A8, or A9; RE₂ is A1, A2, A3, A4, A5, A6, A7, A8, A9, B1, B2, B3, B4, B5, B6, B7, B8, or B9; and L is (CH₂)ₙCOOH, with n=1-16.

22. An artificial receptor, the artificial receptor comprising a plurality of building blocks coupled to a scaffold.

23. A composition of matter comprising a scaffold artificial receptor; the scaffold artificial receptor having the formula:
scaffold-(building block)ₙ wherein n is 2, 3, 4, 5, 6, or 7 and wherein building block has the formula:
linker-framework-(first recognition element)(second recognition element).

24. The composition of matter of claim 23, wherein the framework comprises an amino acid.

25. The composition of matter of claim 24, wherein the amino acid comprises serine, threonine, or tyrosine.

26. The composition of matter of claim 24, wherein the amino acid comprises tyrosine.

27. The composition of matter of claim 23, wherein the linker has the formula (CH₂)ₙCO—, with n=1-16.

28. The composition of matter of claim 23, wherein the first recognition element and second recognition element independently are of formulas B1, B2, B3, B4, B5, B6, B7, B8, B9, A1, A2, A3, A4, A5, A6, A7, A8, or A9.

29. The composition of matter of claim 23, the plurality of building blocks independently having the formula: 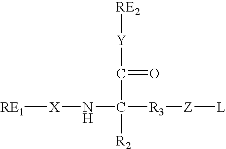
in which: X is absent or C═O; Y is absent, NH, or O; Z is O; R₂ is H or CH₃; R₃ is CH₂ or CH₂-phenyl; RE₁ is B1, B2, B3, B4, B5, B6, B7, B8, B9, A1, A2, A3, A4, A5, A6, A7, A8, or A9; RE₂ is A1, A2, A3, A4, A5, A6, A7, A8, A9, B1, B2, B3, B4, B5, B6, B7, B8, or B9; and L is (CH₂)ₙCOOH, with n=1-16.

30. The composition of matter of claim 23, wherein the building blocks are activated for coupling to a functional group.

31. The composition of matter of claim 23, wherein the building blocks are coupled to a scaffold.

32. The composition of matter of claim 23, wherein each building block is in a container.

33. The composition of matter of claim 23, further comprising a package containing the plurality of building blocks and instructions for their use.

34. The composition of matter of claim 33, wherein the building blocks are components of a heterogeneous molecular array.

35. The composition of matter of claim 23, comprising a mixture of building blocks.

36. The composition of any of claims 13-15 wherein the scaffold is an organic molecule.

37. The composition of any of claims 13-15 wherein the scaffold is an organometallic molecule.

38. The composition of any of claims 13-15 wherein the scaffold is an inorganic molecule.

39. The method of claim 7, wherein the location is a drop on a slide.

40. The method of claim 7, wherein the location is a pit on a CD.

41. The method of claim 7, wherein the location is a compartment on a multi-compartment support.

42. An array comprising:
a support having a plurality of locations; and
a quantity of solution in each location, wherein the solution comprises the composition of any one of claims 11-38.

43. The array of claim 42, wherein the quantity of solution at each location is between about 1 nL to about 1 μL.
